(19) United States
(12) Patent Application Publication
(10) Pub. No.: US 2025/0039820 A1
(43) Pub. Date: Jan. 30, 2025

(54) METHOD FOR USER EQUIPMENT (UE), UE, METHOD FOR ACCESS AND MOBILITY MANAGEMENT FUNCTION (AMF) AND AMF

(71) Applicant: NEC Corporation, Minato-ku, Tokyo (JP)

(72) Inventors: Kundan TIWARI, Tokyo (JP); Toshiyuki TAMURA, Tokyo (JP); Iskren IANEV, Tokyo (JP)

(73) Assignee: NEC Corporation, Minato-ku, Tokyo (JP)

(21) Appl. No.: 18/717,002

(22) PCT Filed: Nov. 28, 2022
(86) PCT No.: PCT/JP2022/043676

§ 371 Date: Jun. 6, 2024

(30) Foreign Application Priority Data
Dec. 22, 2021 (IN) 202111060027

(51) Int. Cl. H04W 60/04; H04W 48/18; H04W 84/04

(52) U.S. Cl. CPC H04W 60/04; H04W 48/18; H04W 84/042

(57) ABSTRACT

There is a new market requirement that a network slice needs to be deployed in area that does not overlap with the already deployed Tracking Areas and/or has a limited lifetime. As the latest 3GPP specification cannot fulfil the new market requirement, 3GPP specifications need to be enhanced.

A method of a communication apparatus includes receiving Single Network Slice Selection Assistance Information (S-NSSAI), first information indicating where the S-NSSAI is valid and second information indicating when the S-NSSAI is valid. The method includes sending the S-NSSAI, the first information and the second information.

### TECHNICAL FIELD

This present disclosure relates to a method of a communication apparatus, a method of a User Equipment (UE), a communication apparatus, a UE, a method for a first communication apparatus, a method for a communication terminal and a method for a first communication apparatus.

### BACKGROUND ART

According to NPL 2, during a registration procedure, a UE can obtain network slice(s) that are allowed to use from a 5GC.

### CITATION LIST

### Non Patent Literature

[NPL 1] 3GPP TR 21.905: “Vocabulary for 3GPP Specifications”. V17.0.0 (2020-07)
[NPL 2] 3GPP TS 23.501: “System architecture for the 5G System (5GS)”. V17.2.0 (2021-09)
[NPL 3] 3GPP TS 23.502: “Procedures for the 5G System (5GS)”. V17.2.0 (2021-09)
[NPL 4] 3GPP TS 23.003: “Numbering, addressing and identification”. V17.3.0 (2021-09)
[NPL 5] 3GPP TS 38.413: “NG Application Protocol (NGAP)”. V16.7.0 (2021-10)
[NPL 6] IETF RFC 5580: “Carrying Location Objects in RADIUS and Diameter”

### SUMMARY OF INVENTION

### Technical Problem

The descriptions of NPL 2 means that once the allowed network slice(s) is provided to the UE, that network slice(s) is homogenously available with all cells within an assigned registration area. Note that the registration area includes list of Tracking Area.

On the other hand, there is a new market requirement that a network slice needs to be deployed in area that does not overlap with the already deployed Tracking Areas and/or has a limited lifetime.

As the latest 3GPP specification cannot fulfil the above-mentioned new market requirement, 3GPP specifications need to be enhanced.

There is a problematic situation, unclear component or structure to provide flexibly a service for the network slice(s).

### Solution to Problem

In an aspect of the present disclosure, a method of a communication apparatus includes receiving Single Network Slice Selection Assistance Information (S-NSSAI), first information indicating where the S-NSSAI is valid and second information indicating when the S-NSSAI is valid, and sending the S-NSSAI, the first information and the second information.

In an aspect of the present disclosure, a method of a User Equipment (UE) includes receiving a first message. The first message includes Single Network Slice Selection Assistance Information (S-NSSAI), first information indicating where the S-NSSAI is valid and second information indicating when the S-NSSAI is valid. The method includes determining whether the S-NSSAI is valid based on the first information and the second information. The method includes sending a second message in a case where the S-NSSAI is valid. The second message includes the S-NSSAI.

In an aspect of the present disclosure, a method of a communication apparatus includes receiving Single Network Slice Selection Assistance Information (S-NSSAI), first information indicating where the S-NSSAI is valid and second information indicating when the S-NSSAI is valid, determining whether the S-NSSAI is valid based on the first information and the second information, and sending first system information in a case where the S-NSSAI is valid. The first system information includes information indicating the S-NSSAI is valid.

In an aspect of the present disclosure, a communication apparatus includes means for receiving Single Network Slice Selection Assistance Information (S-NSSAI), first information indicating where the S-NSSAI is valid and second information indicating when the S-NSSAI is valid, and means for sending the S-NSSAI, the first information and the second information.

In an aspect of the present disclosure, a User Equipment (UE) includes means for receiving a first message. The first message includes Single Network Slice Selection Assistance Information (S-NSSAI), first information indicating where the S-NSSAI is valid and second information indicating when the S-NSSAI is valid. The UE includes means for determining whether the S-NSSAI is valid based on the first information and the second information. The UE includes means for sending a second message in a case where the S-NSSAI is valid. The second message includes the S-NSSAI.

In an aspect of the present disclosure, a communication apparatus includes means for receiving Single Network Slice Selection Assistance Information (S-NSSAI), first information indicating where the S-NSSAI is valid and second information indicating when the S-NSSAI is valid, means for determining whether the S-NSSAI is valid based on the first information and the second information, and means for sending first system information in a case where the S-NSSAI is valid. The first system information includes information indicating the S-NSSAI is valid.

In an aspect of the present disclosure, a method for a first communication apparatus includes receiving, from a second communication apparatus, information related to Single Network Slice Selection Assistance Information (S-NSSAI), receiving, from the second communication apparatus, at least one of information related to validity time for the S-NSSAI and information related to validity area for the S-NSSAI, and sending, to a communication terminal, at least one of information indicating registration to a network slice related to the S-NSSAI is permitted and information indicating registration to the network slice is not permitted based on at least one of the information related to validity time for the S-NSSAI and information related to validity area for the S-NSSAI.

In an aspect of the present disclosure, a method for a communication terminal includes sending, to a first communication apparatus, a request message for a network slice, and receiving, from the first communication apparatus, at least one of information related to validity time for the network slice and validity area for the network slice.

In an aspect of the present disclosure, a method for a first communication apparatus includes receiving, from a second communication apparatus, information related to Single Network Slice Selection Assistance Information (S-NSSAI), receiving, from the second communication apparatus, at least one of information related to validity time for the S-NSSAI and information related to validity area for the S-NSSAI, and sending, to a communication terminal, at least one of information indicating registration to a network slice related to the S-NSSAI is permitted based on at least one of the information related to validity time for the S-NSSAI and information related to validity area for the S-NSSAI.

In an aspect of the present disclosure, a method for a communication terminal includes sending, to a first communication apparatus, a request message for a network slice, and receiving, from the first communication apparatus, information indicating registration to the network is permitted including at least one of information related to validity time for the network slice and validity area for the network slice.

In an aspect of the present disclosure, a method for a first communication apparatus includes receiving, from a second communication apparatus, at least one of at least one of information related to validity time for the network slice and validity area for the network slice, sending, to a first base station, a first message related to at least one of the information related to validity time for the network slice and validity area for the network slice, and receiving, from the first base station, a second message to confirm the first radio station receive the first message.

In an aspect of the present disclosure, a method for a first communication apparatus includes receiving, from a second communication apparatus, at least one of at least one of information related to validity time for the network slice and validity area for the network slice, receiving, from a first base station, a first message indicating the first base station manages a network slice in at least one of validity area and validity time, and sending, to the first base station, a second message related to at least one of the validity time for the network slice and the validity area for the network slice.

### BRIEF DESCRIPTION OF DRAWINGS

FIG. 1 is a signaling diagram of a First example of a First Aspect (Procedure provisioning a network slice(s) supporting localized service over a certain period of time).

FIG. 2 is a signaling diagram of a First example of the First Aspect (UE and Network behaviors after the configured NSSAI is provided to the UE).

FIG. 3 is a signaling diagram of a Second example of the First Aspect (Procedure provisioning a network slice(s) supporting localized service over a certain period of time).

FIG. 4 is a signaling diagram of a Second example of the First Aspect (UE and Network behaviors after the temporary allowed NSSAI is provided to the UE).

FIG. 5 is a signaling diagram of a Third example of the First Aspect (Network slice information provisioning).

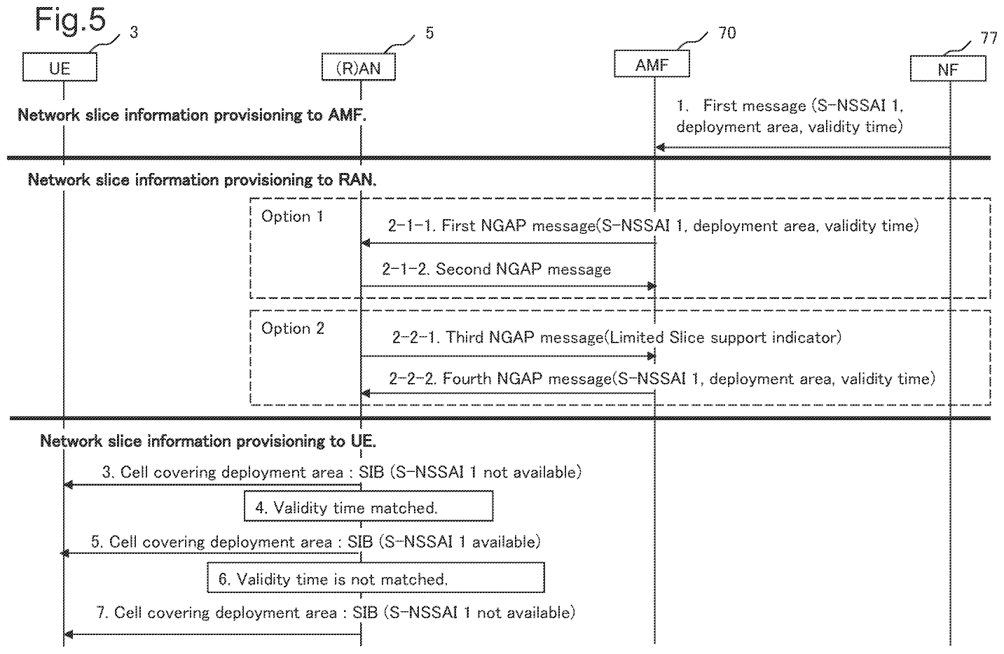

FIG. 6 is a diagram illustrating a system overview.

FIG. 7 is a block diagram illustrating a User equipment (UE).

FIG. 8 is a block diagram illustrating a (R)AN node.

FIG. 9 is a diagram illustrating System overview of a (R)AN node based on O-RAN architecture.

FIG. 10 is a block diagram illustrating a Radio Unit (RU).

FIG. 11 is a block diagram illustrating a Distributed Unit (DU).

FIG. 12 is a block diagram illustrating a Centralized Unit (CU).

FIG. 13 is a block diagram illustrating an Access and Mobility Management Function (AMF).

FIG. 14 is a block diagram illustrating a Unified Data Management (UDM).

FIG. 15 is a block diagram illustrating a Network Function (NF).

FIG. 16 illustrates a registration procedure.

### DESCRIPTION OF EMBODIMENTS

### Abbreviations

For the purposes of the present document, the abbreviations given in NPL 1 and the following apply. An abbreviation defined in the present document takes precedence over the definition of the same abbreviation, if any, in NPL 1.
4G-GUTI 4G Globally Unique Temporary UE Identity
5GC 5G Core Network
5GLAN 5G Local Area Network
5GS 5G System
5G-AN 5G Access Network
5G-AN PDB 5G Access Network Packet Delay Budget
5G-EIR 5G-Equipment Identity Register
5G-GUTI 5G Globally Unique Temporary Identifier
5G-BRG 5G Broadband Residential Gateway
5G-CRG 5G Cable Residential Gateway
5G GM 5G Grand Master
5G-RG 5G Residential Gateway
5G-S-TMSI 5G S-Temporary Mobile Subscription Identifier
5G VN 5G Virtual Network
5QI 5G QOS Identifier
AF Application Function
AMF Access and Mobility Management Function
AMF-G Geographically selected Access and Mobility Management Function
AMF-NG Non-Geographically selected Access and Mobility Management Function
AS Access Stratum
ATSSS Access Traffic Steering, Switching, Splitting
ATSSS-LL ATSSS Low-Layer
AUSF Authentication Server Function
AUTN Authentication token
BCCH Broadcast Control Channel
BMCABest Master Clock Algorithm
BSF Binding Support Function
CAG Closed Access Group
CAPIF Common API Framework for 3GPP northbound APIs
CHF Charging Function
CN PDB Core Network Packet Delay Budget
CP Control Planefff
DAPS Dual Active Protocol Stacks
DL Downlink
DN Data Network
DNAI DN Access Identifier
DNN Data Network Name
DRX Discontinuous Reception
DS-TT Device-side TSN translator
ePDG evolved Packet Data Gateway
EBI EPS Bearer Identity
EPS Evolved Packet System
EUI Extended Unique Identifier
FAR Forwarding Action Rule
FN-BRG Fixed Network Broadband RG
FN-CRG Fixed Network Cable RG
FN-RG Fixed Network RG
FQDN Fully Qualified Domain Name
GFBR Guaranteed Flow Bit Rate
GMLC Gateway Mobile Location Centre
GPSI Generic Public Subscription Identifier
GUAMI Globally Unique AMF Identifier
GUTI Globally Unique Temporary UE Identity
HPLMN Home Public Land Mobile Network
HR Home Routed (roaming)
IAB Integrated access and backhaul
IMEI/TAC IMEI Type Allocation Code
IPUPS Inter PLMN UP Security
I-SMF Intermediate SMF
I-UPF Intermediate UPF
LADN Local Area Data Network
LBO Local Break Out (roaming)
LMF Location Management Function
LoA Level of Automation
LPP LTE Positioning Protocol
LRF Location Retrieval Function
MCC Mobile country code
MCX Mission Critical Service
MDBV Maximum Data Burst Volume
MFBR Maximum Flow Bit Rate
MICO Mobile Initiated Connection Only
MITM Man In the Middle
MNC Mobile Network Code
MPS Multimedia Priority Service
MPTCP Multi-Path TCP Protocol
N3IWF Non-3GPP InterWorking Function
N3GPP Non-3GPP access
N5CW Non-5G-Capable over WLAN
NAI Network Access Identifier
NAS Non-Access-Stratum
NEF Network Exposure Function
NF Network Function
NGAP Next Generation Application Protocol
NID Network identifier
NPN Non-Public Network
NR New Radio
NRF Network Repository Function
NSI ID Network Slice Instance Identifier
NSSAA Network Slice-Specific Authentication and Authorization
NSSAAF Network Slice-Specific Authentication and Authorization Function
NSSAI Network Slice Selection Assistance Information
NSSF Network Slice Selection Function
NSSP Network Slice Selection Policy
NSSRG Network Slice Simultaneous Registration Group
NTP Network Time Protocol
NW-TT Network-side TSN translator
NWDAF Network Data Analytics Function
PCF Policy Control Function
PDB Packet Delay Budget
PDR Packet Detection Rule
PDU Protocol Data Unit
PEI Permanent Equipment Identifier
PER Packet Error Rate
PFD Packet Flow Description
PLMN Public Land Mobile Network
PNI-NPN Public Network Integrated Non-Public Network
PPD Paging Policy Differentiation
PPF Paging Proceed Flag
PPI Paging Policy Indicator
PSA PDU Session Anchor
PTP Precision Time Protocol
QFI QoS Flow Identifier
QoE Quality of Experience
RACS Radio Capabilities Signalling optimisation
(R)AN (Radio) Access Network
RAT Radio Access Technology
RG Residential Gateway
RIM Remote Interference Management
RQA Reflective QoS Attribute
RQI Reflective QoS Indication
RSN Redundancy Sequence Number
SA NR Standalone New Radio
SBA Service Based Architecture
SBI Service Based Interface
SCP Service Communication Proxy
SD Slice Differentiator
SEAF Security Anchor Functionality
SEPP Security Edge Protection Proxy
SMF Session Management Function
SMSF Short Message Service Function
SN Sequence Number
SN name Serving Network Name.
SNPN Stand-alone Non-Public Network
S-NSSAI Single Network Slice Selection Assistance Information
SSC Session and Service Continuity
SSCMSP Session and Service Continuity Mode Selection Policy
SST Slice/Service Type
SUCI Subscription Concealed Identifier
SUPI Subscription Permanent Identifier
SV Software Version
TMSI Temporary Mobile Subscriber Identity
TNAN Trusted Non-3GPP Access Network
TNAP Trusted Non-3GPP Access Point
TNGF Trusted Non-3GPP Gateway Function
TNL Transport Network Layer
TNLA Transport Network Layer Association
TSC Time Sensitive Communication
TSCAI TSC Assistance Information
TSN Time Sensitive Networking
TSN GM TSN Grand Master
TSP Traffic Steering Policy
TT TSN Translator
TWIF Trusted WLAN Interworking Function
UCMFUE radio Capability Management Function
UDM Unified Data Management
UDR Unified Data Repository
UDSF Unstructured Data Storage Function
UE User Equipment
UL Uplink
UL CL Uplink Classifier
UPF User Plane Function
URLLC Ultra Reliable Low Latency Communication
URRP-AMF UE Reachability Request Parameter for AMF
URSP UE Route Selection Policy
VID VLAN Identifier
VLAN Virtual Local Area Network
VPLMN Visited Public Land Mobile Network
W-5GAN Wireline 5G Access Network
W-5GBAN Wireline BBF Access Network
W-5GCAN Wireline 5G Cable Access Network
W-AGF Wireline Access Gateway Function

### Definitions

For the purposes of the present document, the terms and definitions given in NPL 1 and the following apply. A term defined in the present document takes precedence over the definition of the same term, if any, in NPL 1.

### General

Those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the Aspects of the present disclosure so as not to obscure the figures with details that will be readily apparent to those skilled in the art having the benefit of the description herein.

For the purpose of promoting an understanding of the principles of the disclosure, reference will now be made to the Aspect illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or entities or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an Aspect”, “in another Aspect” and similar language throughout this specification may, but not necessarily do, all refer to the same Aspect.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

As used herein, information is associated with data and knowledge, as data is meaningful information and represents the values attributed to parameters. Further knowledge signifies understanding of an abstract or concrete concept. Note that this example system is simplified to facilitate description of the disclosed subject matter and is not intended to limit the scope of this disclosure. Other devices, systems, and configurations may be used to implement the Aspects disclosed herein in addition to, or instead of, a system, and all such Aspects are contemplated as within the scope of the present disclosure.

Each of Aspects and elements included in each Aspects described below may be implemented independently or in combination with any other. These Aspects include novel characteristics different from one another. Accordingly, these Aspects contribute to achieving objects or solving problems different from one another and contribute to obtaining advantages different from one another.

An example object of this disclosure is to provide a method and apparatus that can solve the above problem.

A method of a communication apparatus according to example aspect of this disclosure includes receiving Single Network Slice Selection Assistance Information (S-NSSAI), first information indicating where the S-NSSAI is valid and second information indicating when the S-NSSAI is valid. The method includes sending the S-NSSAI, the first information and the second information.

A method of a User Equipment (UE) according to example aspect of this disclosure includes receiving a first message. The first message includes Single Network Slice Selection Assistance Information (S-NSSAI), first information indicating where the S-NSSAI is valid and second information indicating when the S-NSSAI is valid. The method includes determining whether the S-NSSAI is valid based on the first information and the second information. The method includes sending a second message in a case where the S-NSSAI is valid. The second message includes the S-NSSAI.

A method of a communication apparatus according to example aspect of this disclosure includes receiving Single Network Slice Selection Assistance Information (S-NSSAI), first information indicating where the S-NSSAI is valid and second information indicating when the S-NSSAI is valid. The method includes determining whether the S-NSSAI is valid based on the first information and the second information. The method includes sending first system information in a case where the S-NSSAI is valid. The first system information includes information indicating the S-NSSAI is valid.

A communication apparatus according to example aspect of this disclosure includes a memory, and at least one hardware processor coupled to the memory. The at least one hardware processor is configured to receive Single Network Slice Selection Assistance Information (S-NSSAI), first information indicating where the S-NSSAI is valid and second information indicating when the S-NSSAI is valid. The at least one hardware processor is configured to send the S-NSSAI, the first information and the second information.

A User Equipment (UE) according to example aspect of this disclosure includes a memory, and at least one hardware processor coupled to the memory. The at least one hardware processor is configured to receive a first message. The first message includes Single Network Slice Selection Assistance Information (S-NSSAI), first information indicating where the S-NSSAI is valid and second information indicating when the S-NSSAI is valid. The at least one hardware processor is configured to determine whether the S-NSSAI is valid based on the first information and the second information. The at least one hardware processor is configured to send a second message in a case where the S-NSSAI is valid. The second message includes the S-NSSAI.

A communication apparatus according to example aspect of this disclosure includes a memory, and at least one hardware processor coupled to the memory. The at least one hardware processor is configured to receive Single Network Slice Selection Assistance Information (S-NSSAI), first information indicating where the S-NSSAI is valid and second information indicating when the S-NSSAI is valid. The at least one hardware processor is configured to determine whether the S-NSSAI is valid based on the first information and the second information. The at least one hardware processor is configured to send first system information in a case where the S-NSSAI is valid. The first system information includes information indicating the S-NSSAI is valid

A method of a first communication apparatus according to example aspect of this disclosure includes receiving, from a second communication apparatus, information related to Single Network Slice Selection Assistance Information (S-NSSAI). The method includes receiving, from the second communication apparatus, at least one of information related to validity time for the S-NSSAI and information related to validity area for the S-NSSAI. The method includes sending, to a communication terminal, at least one of information indicating registration to a network slice related to the S-NSSAI is permitted and information indicating registration to the network slice is not permitted based on at least one of the information related to validity time for the S-NSSAI and information related to validity area for the S-NSSAI.

A method of a communication terminal according to example aspect of this disclosure includes sending, to a first communication apparatus, a request message for a network slice. The method includes receiving, from the first communication apparatus, at least one of information related to validity time for the network slice and validity area for the network slice.

A method of a first communication apparatus according to example aspect of this disclosure includes receiving, from a second communication apparatus, information related to Single Network Slice Selection Assistance Information (S-NSSAI). The method includes receiving, from the second communication apparatus, at least one of information related to validity time for the S-NSSAI and information related to validity area for the S-NSSAI. The method includes sending, to a communication terminal, at least one of information indicating registration to a network slice related to the S-NSSAI is permitted based on at least one of the information related to validity time for the S-NSSAI and information related to validity area for the S-NSSAI.

A method of a communication terminal according to example aspect of this disclosure includes sending, to a first communication apparatus, a request message for a network slice. The method includes receiving, from the first communication apparatus, information indicating registration to the network is permitted including at least one of information related to validity time for the network slice and validity area for the network slice.

A method of a first communication apparatus according to example aspect of this disclosure includes receiving, from a second communication apparatus, at least one of at least one of information related to validity time for the network slice and validity area for the network slice. The method includes sending, to a first base station, a first message related to at least one of the information related to validity time for the network slice and validity area for the network slice. The method includes receiving, from the first base station, a second message to confirm the first radio station receive the first message.

A method of a first communication apparatus according to example aspect of this disclosure includes receiving, from a second communication apparatus, at least one of at least one of information related to validity time for the network slice and validity area for the network slice. The method includes receiving, from a first base station, a first message indicating the first base station manages a network slice in at least one of validity area and validity time. The method includes sending, to the first base station, a second message related to at least one of the validity time for the network slice and the validity area for the network slice.

A method of a first communication apparatus according to example aspect of this disclosure includes receiving, from a second communication apparatus, at least one of at least one of information related to validity time for the network slice and validity area for the network slice. The method includes sending, to a first base station, a first message related to at least one of the information related to validity time for the network slice and validity area for the network slice. The method includes receiving, from the first base station, a second message to confirm the first radio station receive the first message. The method includes sending, to a communication terminal, at least one of information related to the validity area and information invalid time.

A method of a first communication apparatus according to example aspect of this disclosure includes receiving, from a second communication apparatus, at least one of at least one of information related to validity time for the network slice and validity area for the network slice. The method includes receiving, from a first base station, a first message indicating the first base station manages a network slice in at least one of validity area and validity time. The method includes sending, to the first base station, a second message related to at least one of the validity time for the network slice and the validity area for the network slice. The method includes sending, to a communication terminal, at least one of information related to the validity area and information invalid time.

A method of a first communication apparatus according to example aspect of this disclosure includes receiving, from a second communication apparatus, at least one of at least one of information related to validity time for the network slice and validity area for the network slice. The method includes sending, to a first base station, a first message related to at least one of the information related to validity time for the network slice and validity area for the network slice. The method includes receiving, from the first base station, a second message to confirm the first radio station receive the first message. The method includes sending, to a communication terminal, information related to the validity area and the validity time.

A method of a first communication apparatus according to example aspect of this disclosure includes receiving, from a second communication apparatus, at least one of at least one of information related to validity time for the network slice and validity area for the network slice. The method includes receiving, from a first base station, a first message indicating the first base station manages a network slice in at least one of validity area and validity time. The method includes sending, to the first base station, a second message related to at least one of the validity time for the network slice and the validity area for the network slice. The method includes sending, to a communication terminal, information related to the validity area and the validity time.

### <First Aspect>

In order to make a Home Public Land Mobile Network (HPLMN) operator possible to provide procedure to deploy a network slice dedicated to handle a temporary event over a small geographical area or for a limited period with minimum signaling required, it needs, in NPL 2, NPL 3 and other 3GPP specifications, a mechanism for the 5GS to support a deployment of a network slice handling temporary events over limited geographical location. Usually, the operator deploys the network slice homogenously over a tracking area or a registration area and over a longer period of time.

First Aspect discloses a mechanism that enables the HPLMN operator to deploy a network slice covering a service deployed in limited area for a short time. More specifically this discloses a procedure to support non-homogenous deployment of the network slice within a tracking area or in registration area or for a limited period of time to support a service which is required in limited geographical location over short period of time.

For example, First Aspect can solve the above problem such as the latest 3GPP specification cannot fulfil the above-mentioned new market requirement.

### <First Example of the First Aspect:>

First example of the First Aspect discloses a procedure where an AMF 70 sends a configured NSSAI including S-NSSAI with validity time and deployment area to a UE 3. The deployment area can be for example, List of cell ID(s), List of Frequency Band(s) (FB(s)), List of combination of cell ID(s) and FB(s), Geographical area(s) that is mapped to either a tracking area(s) or a cell(s) where the S-NSSAI is deployed to provide a service. The deployment area may be geographic area coded by GPS or any format, area defined by address (e.g. City, town, village, administrative division), or Building (e.g. ABC stadium, ABC station, ABC building. Outside this deployment area (e.g. tracking area(s) or cell(s)), a service related to the S-NSSAI is not deployed and cannot be accessed or provided to the UE 3. The deployment area may be a location area where the UE 3 can get service for the S-NSSAI.

The validity time may be a period of time over which the S-NSSAI is valid for the service. After this time period, the service is not provided to the UE 3. The validity time may be time which the S-NSSAI is valid for the service or invalid for the service (e.g. valid at 9:00 AM, invalid at 10:00 AM, valid at 3:00 PM). The validity time may be period or duration over which the S-NSSAI is valid for the service or invalid for the service. The validity time may indicates time period when the service is available for the S-NSSAI, i.e. the time period within which the UE 3 can register for the S-NSSAI to get the service related to the S-NSSAI.

When the UE 3 receives the configured NSSAI, the UE 3 stores the configured NSSAI i.e., the UE 3 stores the S-NSSAI along with the deployment area or the validity period or both if provided both. The validity period may be validity time or validity duration. When the UE 3 gets trigger to access the service related to the S-NSSAI, the UE 3 checks if a current cell of the UE 3 belongs to the deployment area for the S-NSSAI or current time is under the validity time for the S-NSSAI or both factors if both the deployment area and the validity time are provided. If an S-NSSAI access criteria is met, the UE 3 sends a Registration Request message containing the S-NSSAI in a requested NSSAI during a registration procedure. When the AMF 70 receives the Registration Request message, the AMF 70 checks if the UE 3 is accessing the S-NSSAI from the deployment area or within the validity period of the S-NSSAI or both factors if both are applicable. If an access criteria meets, the AMF 70 further processes the S-NSSAI and provides the S-NSSAI in an allowed NSSAI in the Registration Accept message or other existing NAS message if the registration procedure is successful. When the UE 3 receives the Registration Accept message, the UE 3 may establish a PDU session related to the S-NSSAI. In a case where the UE 3 moves out of the deployment area or the validity time for the S-NSSAI expires or the validity time passes, at least one of the UE 3 and a network locally remove the S-NSSAI from the allowed NSSAI or remove the S-NSSAI with explicit NAS signaling (i.e. by sending an existing NAS message). The deployment area may be expressed as deployed area or deployment zone. The validity time may be expressed as validity period or duration. The current time may be expressed as current date. For example, the validity time in this disclosure (e.g. Aspects included in this disclosure) may be expressed as follows:
0:00 1 Jan. 2022 to 23:59 31 Jan. 2022 in time zone JST (Japan Standard Time)
17:00 to 19:00 every day
Every Monday

For example, upon reception of the configured NSSAI (or S-NSSAI in the configured NSSAI) the UE 3 may start the validity time for the S-NSSAI for which the UE 3 has received the validity time with the time period equal to the received validity time. The S-NSSAI in the configured NSSAI may be expressed as configured S-NSSAI.

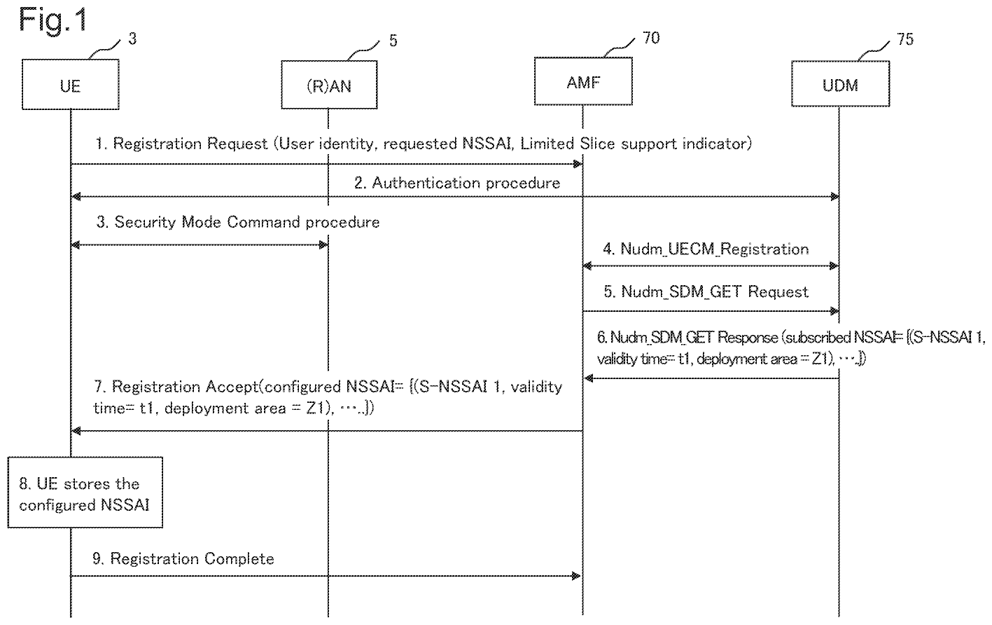

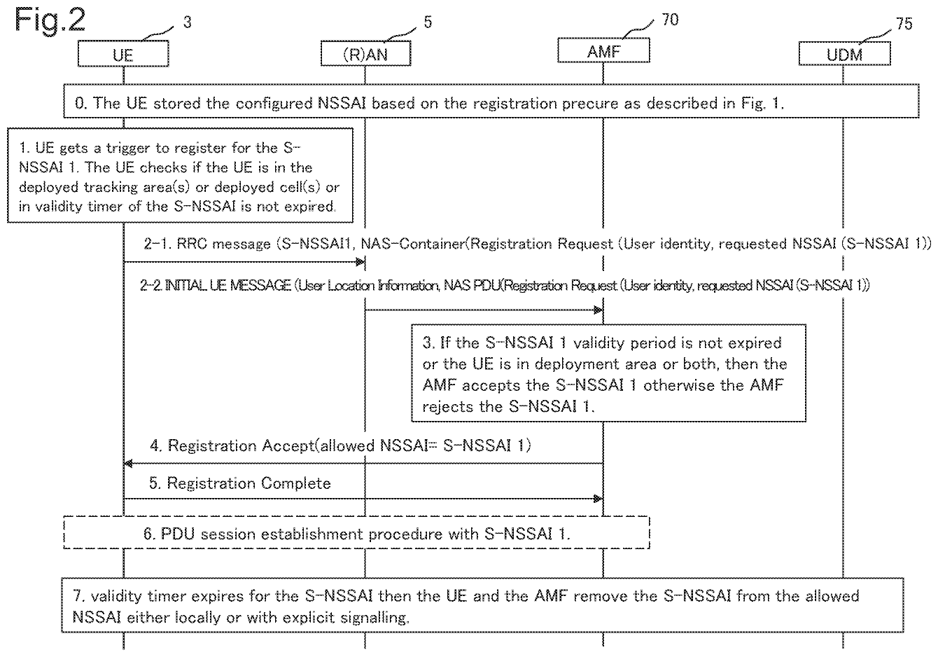

First example of the First Aspect is disclosed with FIG. 1 and FIG. 2. While FIG. 1 illustrates provisioning the configured NSSAI to the UE 3, the FIG. 2 illustrates the UE 3 and the network behaviors after the configured NSSAI is provided to the UE 3.

If S-NSSAI in the configured NSSAI is configured with the field “validity timer” or “deployment zone”, then the UE may send the S-NSSAI in the Requested NSSAI if the validity time is running (or is not expired) or if the UE is present in the deployment zone of the S-NSSAI.

### <Provisioning the Configured NSSAI to the UE>

1. The UE 3 sends a Registration Request message to the AMF 70 including limited slice support indicator. The limited slice support indicator indicates that the UE 3 supports S-NSSAI with at least one of deployment area and validity time attribution. For example, the limited slice support indicator may indicate that the UE 3 supports S-NSSAI with at least one of deployment area and validity time. The Registration Request message can be sent during an initial registration procedure, a mobility registration procedure or a periodic registration procedure. The Registration Request message may include User identity. The User identity may indicate identity of the UE 3. The Registration Request message may include a requested NSSAI.

2. An authentication procedure may take place. For example, the authentication procedure may take place according to current 3GPP standards.

3. A security mode command procedure may take place. For example, the security mode command procedure may take place according to current 3GPP standards.

4. The AMF 70 invokes an Nudm_UECM_Registration service operation to register the AMF 70 to a UDM 75.

5. The AMF 70 invokes an Nudm_SDM_GET service operation by sending an Nudm_SDM_GET Request message.

6. The UDM 75 sends, to the AMF 70, a subscribed NSSAI containing S-NSSAI 1 along with at least one of deployment area for the S-NSSAI 1 and validity time for the S-NSSAI 1. The subscribed NSSAI may be associated with the UE 3.

For example, the UDM 75 sends a subscribed NSSAI containing S-NSSAI 1 along with deployment area if the deployment area is applicable to the S-NSSAI for the UE 3.

For example, the UDM 75 sends a subscribed NSSAI containing S-NSSAI 1 along with validity time if the validity time is applicable to the S-NSSAI for the UE 3.

For example, the UDM 75 sends a subscribed NSSAI containing S-NSSAI 1 along with at least one of the deployment area and the validity time if the deployment area and the validity time are applicable to the S-NSSAI for the UE 3.

For example, the UDM 75 sends a subscribed NSSAI containing S-NSSAI 1 along with both of the deployment area and the validity time if the deployment area and the validity time are applicable to the S-NSSAI for the UE 3.

For example, the UDM 75 may store information to determine whether at least one of the deployment area and the validity time is applicable to S-NSSAI(s) for the UE 3.

For example, the UDM 75 may send an Nudm_SDM_GET Response message including the subscribed NSSAI.

For example, the UDM 75 may send the Nudm_SDM_GET Response message including the subscribed NSSAI in a case where the UDM 75 receives the Nudm_SDM_GET Request message.

The deployment area may form one of following examples or combination of following examples:
List of Tracking Area(s). The List of Tracking Area(s) may be a list of TAI(s). For example, the deployment area may indicate list of TA(s) or TAI(s) that S-NSSAI is valid or available.
List of cell ID(s). The cell ID can be NR Cell Global Identity (NCGI) as defined in NPL 4, NR Cell Identity (NCI) as defined in NPL 4, E-UTRAN Cell Global Identifier (ECGI) as defined in NPL 4, or Global Cable Identifier (GCI) as defined in NPL 4. For example, the deployment area may indicate list of cell(s) or cell ID(s) that S-NSSAI is valid or available.
List of Frequency Band(s) (FBs). For example, the deployment area may indicate list of FB(s) that S-NSSAI is valid or available.
List of combination(s) cell ID(s) and FB(s). For example, the deployment area may indicate list of combination(s) cell ID(s) and FB(s) that S-NSSAI is valid or available.
Geographical area(s) coded by Global Positioning System (GPS) format or any format. For example, the deployment area may indicate Geographical area(s) that S-NSSAI is valid or available.
Civic address (For example. City, Town, village, administrative division), Zip code, Building (For example, name of place such as Tokyo stadium, Tokyo Station) or Building (For example, Tokyo stadium, Tokyo Station) formed with GPS location or a location expressed with civic and geospatial location formats as defined in NPL 6. For example, the deployment area may indicate Civic address, Zip code Building etc. that S-NSSAI is valid or available.

The AMF 70 may store the subscribed NSSAI in a case where the AMF 70 receives the subscribed NSSAI from the UDM 75.

The subscribed NSSAI may include one or more S-NSSAIs and the deployment area for each of the one or more S-NSSAIs and the validity time for each of the one or more S-NSSAIs.

The UDM 75 may generate the subscribed NSSAI based on at least one of a local configuration in the UDM 75, operator's policy and S-NSSAI(s) that the UE 3 subscribes.

For example, in a case where the UDM 75 stores information indicating that the UE 3 subscribes to the S-NSSAI 1, the UDM 75 may generate the subscribed NSSAI regarding the S-NSSAI 1.

The deployment area may be expressed as first information indicating where the S-NSSAI 1 is valid. The validity time may be expressed as second information indicating when the S-NSSAI 1 is valid.

7. The AMF 70 sends the S-NSSAI 1 along with at least one of the deployment area and the validity time in the configured NSSAI in a Registration Accept message if the UE 3 indicate the limited slice support indicator in the Registration Request message in step 1. Otherwise, the AMF 70 does not provide the S-NSSAI 1 in the configured NSSAI to the UE 3.

For example, the AMF 70 may send the S-NSSAI 1 along with at least one of the deployment area and the validity time in the configured NSSAI in the Registration Accept message if the deployment area and the validity time are applicable to the S-NSSAI 1.

For example, the AMF 70 may send the S-NSSAI 1 along with the deployment area in the configured NSSAI in the Registration Accept message if the deployment area is applicable to the S-NSSAI 1.

For example, the AMF 70 may send the S-NSSAI 1 along with the validity time in the configured NSSAI in the Registration Accept message if the validity time is applicable to the S-NSSAI 1.

For example, the AMF 70 may store information to determine whether at least one of the deployment area and the validity time is applicable to S-NSSAI(s) for the UE 3.

For example, the AMF 70 may send the S-NSSAI 1 along with at least one of the deployment area and the validity time in the configured NSSAI in the Registration Accept message if the UE 3 does not indicate the limited slice support indicator in the Registration Request message in step 1.

The AMF 70 may covert the received deployment area into List of Tracking Area(s) (e.g. List of TAI(s)) or List of cell ID(s). The AMF 70 may convert the receive validity time to a validity time in another time format, for example, a time period with local time zone.

For example, the AMF 70 stores information for converting the received deployment area into List of Tracking Area(s) (e.g. List of TAI(s)) or List of cell ID(s).

For example, the AMF 70 stores information indicating that location or place indicated by the deployment area includes TA 1 or cell 1 identified by cell ID 1, and may covert the received deployment area into the List including TA 1 or cell ID 1.

For example, the AMF 70 stores information indicating that FB indicated by the deployment area is used in TA 1 or cell 1 identified by cell ID 1, and may covert the received deployment area into the List including TA 1 or cell ID 1.

The limited slice support indicator may indicate that the UE 3 supports reception of S-NSSAI(s) along with at least one of the deployment area and the validity time in the configured NSSAI.

Contents of the configured NSSAI may correspond to contents of the subscribed NSSAI.

For example, in a case where the subscribed NSSAI includes the S-NSSAI 1 and at least one of the deployment area for the S-NSSAI 1 and the validity time for the S-NSSAI 1, the configured NSSAI may include the S-NSSAI 1 and at least one of the deployment area for the S-NSSAI 1 and the validity time for the S-NSSAI 1.

For example, the AMF 70 may decide contents of the configured NSSAI. For example, the AMF 70 may send the configured NSSAI regarding S-NSSAI included in the requested NSSAI in step 1.

For example, it is assumed that the AMF 70 receives the requested NSSAI including S-NSSAI 1 in step 1, and the AMF 70 receives, in step 6, the subscribed NSSAI including S-NSSAI 1, the deployment area for the S-NSSAI 1, the validity time for the S-NSSAI 1, S-NSSAI 2, the deployment area for the S-NSSAI 2, and the validity time for the S-NSSAI 2. In this case, the AMF 70 may send the configured NSSAI including S-NSSAI 1, the deployment area for the S-NSSAI 1, and the validity time for the S-NSSAI 1.

The configured NSSAI may include one or more S-NSSAIs and the deployment area for each of the one or more S-NSSAIs and the validity time for each of the one or more S-NSSAIs.

8. Upon reception of the Registration Accept message, the UE 3 stores the configured NSSAI.

9. The UE 3 may send a Registration Complete message. For example, the UE 3 may send the Registration Complete message after step 7 or 8. For example, the UE 3 may send the Registration Complete message corresponds to the Registration Accept message or any messages received in the Step 7 or 8.

<UE and Network Behavior after the Configured NSSAI is Provided to the UE>

0. It is assumed that the UE 3 and 5GS performed the registration procedure as illustrated in FIG. 1 in First example of the First Aspect. It means that the UE 3 may store the S-NSSAI 1 in the configured NSSAI along with at least one of the deployment area and the validity time.

1. When the UE 3 gets trigger to access a service related to the S-NSSAI 1, the UE 3 checks if a current cell of the UE 3 or current location of the UE 3 belongs to the deployment area or current time is under the validity time for the S-NSSAI 1 or both factors if both deployment area and the validity time for the S-NSSAI 1 are provided. For example, the UE 3 gets trigger to access the service related to the S-NSSAI 1 in a case where an application related to the S-NSSAI 1 in the UE 3 is activated.

“A current cell of the UE 3 or current location of the UE 3 belongs to the deployment area” may be expressed as a first criteria. “Current time is under the validity time” may be expressed as a second criteria. At least one of the first criteria and the second criteria may be expressed as an S-NSSAI access criteria.

For example, in a case where the UE 3 stores the S-NSSAI 1 in the configured NSSAI along with both the deployment area and the validity time, the UE 3 may check whether at least one of the first criteria and the second criteria is met.

For example, in a case where the UE 3 stores the S-NSSAI 1 in the configured NSSAI along with the deployment area, the UE 3 may check whether the first criteria is met.

For example, in a case where the UE 3 stores the S-NSSAI 1 in the configured NSSAI along with the validity time, the UE 3 may check whether the second criteria is met.

For example, when the UE 3 checks whether the first criteria is met, the UE 3 may check if a current cell of the UE 3 belongs to or is same to a cell indicated by the deployment area. In this case, the UE may use cell ID(s) to check if a current cell of the UE 3 belongs to or is same to a cell indicated by the deployment area. For example, when the UE 3 checks whether the first criteria is met, the UE 3 may check if a current TA of the UE 3 belongs to or is same to a TA indicated by the deployment area. In this case, the UE may use TAI(s) to check if a current TA of the UE 3 belongs to or is same to a TA indicated by the deployment area.

For example, when the UE 3 checks whether the first criteria is met, the UE 3 may check if a current location of the UE 3 belongs to or is same to a location indicated by the deployment area.

For example, the UE 3 may obtain information indicating the current cell or the current TA from other node(s) such as (R)AN 5.

For example, the UE 3 may obtain the current location of the UE 3 by using GPS.

For example, the UE 3 may convert location information indicated by the deployment area into information indicating cell(s), and the UE 3 checks if a current cell of the UE 3 belongs to the cell(s) indicated by the converted information. The information indicating cell(s) may be cell ID(s). For example, the UE 3 may store information for converting into the information indicating cell(s). For example, the UE 3 may store a list including combination of cell ID(s) and at least one of TA(s), FB(s) and Geographical area(s) etc.

For example, when the UE 3 checks whether the second criteria is met, the UE 3 may check if a current time or current date is within time or time period indicated by the validity time.

2-1. If the S-NSSAI access criteria for S-NSSAI 1 in step 1 is met, the UE 3 sends an RRC message to a (R)AN 5. The RRC message includes an NAS-Container. The NAS-Container includes a Registration Request message containing the S-NSSAI1 in the requested NSSAI. The Registration Request message may include User identity. The User identity may indicate identity of the UE 3.

The (R)AN 5 may include a (R)AN node such as an NG-RAN node or a gNB.

For example, in a case where the UE 3 determines that at least one of the first criteria and the second criteria is met, the UE 3 may send an RRC message.

For example, in a case where the UE 3 determines that the first criteria is met, the UE 3 may send the RRC message.

For example, in a case where the UE 3 determines that the second criteria is met, the UE 3 may send the RRC message.

For example, in a case where the current cell of the UE 3 belongs to the deployment area, the current time is under the validity time of the S-NSSA 1, or both factors are met if both deployment area and the validity time of the S-NSSAI 1 are provided, the UE3 sends an RRC message to the (R)AN 5 including NAS-Container that includes Registration Request message containing the S-NSSAI 1 in the requested NSSAI.

For example, in a case where the current location of the UE3 belongs to the deployment area, the current time is under the validity time of the S-NSSA 1, or both factors are met if both deployment area and the validity time of the S-NSSAI 1 are provided, the UE3 sends an RRC message to the (R)AN 5 including NAS-Container that includes Registration Request message containing the S-NSSAI 1 in the requested NSSAI.

For example, it is assumed that the deployment area indicates area “Z1”, and the validity time indicates “January, 2022”. In a case where the UE 3 determines that a current cell of the UE 3 (e.g. cell 1) belongs to area “Z1” and the current date (e.g. “December, 2021”) is within “January, 2022”, the UE 3 sends the RRC message. For example, the UE 3 may store information indicating that area “Z1” includes cell 1, and may use this information to check the first criteria.

For example, the UE 3 may convert area “Z1” into information indicating cell(s), and may determine whether the current cell belongs to or is same to the cell(s) indicated by the converted information. In a case where the UE 3 determines that a current cell of the UE 3 belongs to or is same to the cell(s) indicated by the converted information and the current date (e.g. “December, 2021”) is within “January, 2022”, the UE 3 sends the RRC message.

In a case where the UE 3 determines that the current cell of the UE 3 does not belong to area “Z1” or that the current date (e.g. “February, 2022”) is not within “January 2022”, the UE 3 does not send the RRC message. In a case where the current date (e.g. “December, 2021”) is within “January 2022”, the UE 3 may determine that the validity time is not expired. In a case where the current date (e.g. “February, 2022”) is not within “January 2022”, the UE 3 may determine that the validity time is expired.

For example, “determining that the current date is within the validity time” may be expressed as “determining that the current date is under the validity time” or “determining that the current date is before the validity time”.

The deployment area may indicate where the S-NSSAI 1 is valid or available. In a case where the deployment area indicates area “Z1”, the deployment area may mean that the S-NSSAI 1 is valid or available within area “Z1”.

The validity time may indicate how long the S-NSSAI 1 is valid or available. In a case where the validity time indicates “January, 2022”, the validity time may mean that the S-NSSAI 1 is valid or available by the January 2022.

In a case where the deployment area indicates List of FB(s), the deployment area may indicate which FB(s) the S-NSSAI 1 is valid or available. In a case where the deployment area indicates “FB1”, the deployment area may mean that the S-NSSAI 1 is valid or available on “FB1”. For example, the UE 3 checks if the UE 3 tunes to “FB1”, and the UE 3 sends the RRC message in a case where the UE 3 determines that UE 3 tunes to “FB1” currently.

In a case where the deployment area indicates List of combination(s) cell ID(s) and FB(s), the deployment area may indicate combination of cell ID(s) and FB(s) that the S-NSSAI 1 is valid or available. In a case where the deployment area indicates combination of “cell ID1” and “FB1”, the deployment area may mean that the S-NSSAI 1 is valid or available on a cell which operates in “FB1” and is identified by “cell ID1”. For example, the UE 3 checks if the UE 3 locates on a cell identified by “cell ID1” and if the UE 3 tunes to “FB1”, and the UE 3 sends the RRC message in a case where the UE 3 determines that the UE 3 locates on the cell identified by “cell ID1” and that UE 3 tunes to “FB1” currently.

2-2. Upon reception of the RRC message from the UE 3 in step 2-1, the (R)AN 5 sends an Initial UE message to the AMF 70. The Initial UE message includes User location information and NAS PDU. The NAS PDU includes the Registration Request message containing the S-NSSAI1 in the requested NSSAI. The Registration Request message may include User identity. The User identity may indicate identity of the UE 3. The User location information may contain cell level information such as cell ID(s), E-UTRA CGI, NR CGI etc. The User location information may be used to provide location information of the UE 3.

3. When the AMF 70 receives the Initial UE message that includes the Registration Request message, the AMF 70 checks if the UE 3 is accessing the S-NSSAI 1 from the deployment area or within the validity time for the S-NSSAI 1 or both factors if both are applicable. When the AMF 70 checks if the UE 3 is accessing the S-NSSAI 1 from the deployment area, the AMF 70 may use the User location information. For example, the AMF 70 may use the User location information to check whether the UE 3 is inside of the deployment area or not. When the AMF 70 checks if the UE 3 is accessing the S-NSSAI 1 within the validity time, the AMF 70 may use a network time provided by a NTP server to compare the validity time for the S-NSSAI 1.

“The UE 3 is accessing the S-NSSAI 1 from the deployment area” may be expressed as a third criteria. “The UE 3 is accessing the S-NSSAI 1 within the validity time” may be expressed as a fourth criteria. At least one of the third criteria and the fourth criteria may be expressed as an access criteria.

For example, in a case where the AMF 70 stores the subscribed NSSAI including S-NSSAI 1 along with both the deployment area and the validity time, the AMF 70 checks if the UE 3 is accessing the S-NSSAI 1 from the deployment area within the validity time.

For example, in a case where the AMF 70 stores the subscribed NSSAI including S-NSSAI 1 along with both the deployment area and the validity time, the AMF 70 checks if the UE 3 is accessing the S-NSSAI 1 from the deployment area or if the UE 3 is accessing the S-NSSAI 1 within the validity time.

For example, in a case where the AMF 70 stores the subscribed NSSAI including S-NSSAI 1 along with the deployment area, the AMF 70 checks if the UE 3 is accessing the S-NSSAI 1 from the deployment area.

For example, in a case where the AMF 70 stores the subscribed NSSAI including S-NSSAI 1 along with the validity time, the AMF 70 checks if the UE 3 is accessing the S-NSSAI 1 within the validity time.

For example, it is assumed that the deployment area indicates “cell ID 1”, the validity time indicates “January, 2022”, the User location information indicates “cell ID 1” and the current date is “December, 2021”. In this case, the AMF 70 checks if the UE 3 is accessing the S-NSSAI 1 from cell 1 identified by “cell ID 1” and the current date is within “January, 2022”. In this case, the AMF 70 determines that the UE 3 is accessing the S-NSSAI 1 from the deployment area (i.e. cell 1 identified by “cell ID 1”) within the validity time.

For example, in a case where the deployment area indicates information other than the cell level information (e.g. the cell ID), the AMF 70 may convert information indicated by the deployment area into the cell level information. For example, the AMF 70 may store information for converting into the cell ID. For example, the AMF 70 may store a list including combination of cell ID(s) and at least one of TA(s), FB(s) and Geographical area(s) etc.

4. If the access criteria is met, the AMF 70 further processes the S-NSSAI 1 and provides the S-NSSAI 1 in the allowed NSSAI in the Registration Accept message or other existing NAS message to the UE 3.

For example, the AMF 70 further processes the S-NSSAI 1 and provides the S-NSSAI 1 in the allowed NSSAI if the access criteria is met and the registration procedure is successful in the AMF 70. If the AMF 70 checks if the UE 3 accesses the S-NSSAI 1 from the deployed area, is related to the validity period of the S-NSSAI1, or is related to both factors (deployed area or validity period of the S-NSSAI1), the AMF 70 processes the S-NSSAI 1 and provides it, to the UE 3, in the allowed NSSAI in the registration accept message or other NAS message.

For example, it is assumed that the deployment area indicates area “Z1” and the validity time indicates “January, 2022”. In a case where the AMF 70 determines that the UE 3 is accessing the S-NSSAI 1 from area “Z1” and the current date (e.g. “December, 2021”) is within “January 2022”, the AMF 70 processes the S-NSSAI 1 and provides the S-NSSAI 1 in the allowed NSSAI in the Registration Accept message or other existing NAS message to the UE 3.

In a case where the AMF 70 determines that the UE 3 is not accessing the S-NSSAI 1 from area “Z1”, or that the current date (e.g. “February, 2022”) is not within “January 2022”, the AMF 70 rejects the S-NSSAI 1. For example, when the AMF 70 rejects the S-NSSAI 1, the AMF 70 may send a Registration Reject message including a rejected NSSAI that includes the S-NSSAI 1 or the AMF 70 may send a Registration Accept message including a rejected NSSAI that includes the S-NSSAI 1.

In a case where the current date (e.g. “December, 2021”) is within “January 2022”, the AMF 70 may determine that the validity time is not expired. In a case where the current date (e.g. “February, 2022”) is not within “January 2022”, the AMF 70 may determine that the validity time is expired.

5. When the UE 3 receives the Registration Accept message, the UE 3 may send, to the AMF 70, a Registration Complete message.

6. The UE 3 may establish a PDU session related to the S-NSSAI 1. For example, the UE 3 may establish a PDU session related to the S-NSSAI 1 after receiving the Registration Accept message including the allowed NSSAI that includes the S-NSSAI 1 in step 4 or after sending the Registration Complete message in step 5. For example, the UE 3 may establish a PDU session related to the S-NSSAI 1 corresponds to receiving the Registration Accept message including the allowed NSSAI that includes the S-NSSAI 1 in step 4 or after sending the Registration Complete message in step 5.

7. In a case where the UE 3 moves out of the deployment area, the validity time for the S-NSSAI 1 expires, or the validity time passes, at least one of the UE 3 and the network (e.g. the AMF 70) locally removes the S-NSSAI 1 from the allowed NSSAI or removes the S-NSSAI 1 from the allowed NSSAI with explicit NAS signaling (i.e. by sending an existing NAS message).

For example, in a case where the UE 3 calculates the current location of the UE 3 and determines that the UE 3 moves out the deployment area based on the current location, the UE 3 may remove the S-NSSAI 1 from the allowed NSSAI.

For example, in a case where the UE 3 determines that the UE 3 moves out the deployment area based on the current location, the UE 3 may initiate a procedure that involves sending the existing NAS message in order to remove the S-NSSAI 1 from the allowed NSSAI.

For example, the UE 3 may send the current location of the UE 3 periodically to the AMF 70. The UE May 3 send the current location in a case where the UE 3 receives a request to send the current location. In this case, the AMF 70 may determine whether the UE 3 moves out the deployment area based on the current location. In a case where the AMF 70 determines that the UE 3 moves out the deployment area based on the current location, the AMF 70 may remove the S-NSSAI 1 from the allowed NSSAI.

For example, in a case where the AMF 70 determines that the UE 3 moves out the deployment area based on the current location, the AMF 70 may initiate a procedure that involves sending the existing NAS message in order to remove the S-NSSAI 1 from the allowed NSSAI. For example, the AMF may remove the S-NSSAI 1 from the allowed NSSAI by updating the allowed NSSAI, and send the updated allowed NSSAI to the UE 3.

If the UE 3 has established PDU session(s) that is associated with the S-NSSAI 1, the AMF 70 initiates a network requested PDU Session Release for Non-Roaming and Roaming with Local Breakout procedure as described in section 4.3.4.2 in NPL 3.

For example, in a case where the AMF 70 determines that the UE 3 has established PDU session(s) that is associated with the S-NSSAI 1, the AMF 70 may initiate the network requested PDU Session Release for Non-Roaming and Roaming with Local Breakout procedure.

For example, in a case where the AMF 70 determines that the UE 3 moves out of the deployment area and the UE 3 has established PDU session(s) that is associated with the S-NSSAI 1, the AMF 70 may initiate the network requested PDU Session Release for Non-Roaming and Roaming with Local Breakout procedure.

For example, in a case where the AMF 70 determines that the validity time for the S-NSSAI 1 expires and the UE 3 has established PDU session(s) that is associated with the S-NSSAI 1, the AMF 70 may initiate the network requested PDU Session Release for Non-Roaming and Roaming with Local Breakout procedure.

The AMF 70 may determine that the UE 3 has established PDU session(s) that is associated with the S-NSSAI 1 by using local information in the AMF 70 or by receiving information from another network node (e.g. an SMF or a UDM).

For example, a communication apparatus corresponding to the AMF 70 may receive Single Network Slice Selection Assistance Information (S-NSSAI), first information indicating where the S-NSSAI is valid and second information indicating when the S-NSSAI is valid. The communication apparatus may send the S-NSSAI, the first information and the second information.

For example, a User Equipment (UE) corresponding to the UE 3 may receive a first message. The first message may include Single Network Slice Selection Assistance Information (S-NSSAI), first information indicating where the S-NSSAI is valid and second information indicating when the S-NSSAI is valid. The UE may determine whether the S-NSSAI is valid based on the first information and the second information The UE may send a second message in a case where the S-NSSAI is valid. The second message may include the S-NSSAI.

For example, a first communication apparatus corresponding to the AMF 70 may receive, from a second communication apparatus corresponding to the UDM 75, information related to Single Network Slice Selection Assistance Information (S-NSSAI). The first communication apparatus may receive, from the second communication apparatus, at least one of information related to validity time for the S-NSSAI and information related to validity area for the S-NSSAI. The first communication apparatus may send, to a communication terminal, at least one of information indicating registration to a network slice related to the S-NSSAI is permitted and information indicating registration to the network slice is not permitted based on at least one of the information related to validity time for the S-NSSAI and information related to validity area for the S-NSSAI.

For example, a communication terminal corresponding to the UE 3 may send, to a first communication apparatus corresponding to the AMF 70, a request message for a network slice. The communication terminal may receive, from the first communication apparatus, at least one of information related to validity time for the network slice and validity area for the network slice.

According to the above, the above problem such as the latest 3GPP specification cannot fulfil the above-mentioned new market requirement can be solved.

### <First Variant of FIG. 1 in First Example of the First Aspect:>

In one example, anytime the AMF 70 may provide the configured NSSAI containing S-NSSAI with at least one of its validity period and its deployment area in a Configuration update command message or in any existing NAS message. For example, the AMF 70 may initiate a UE Configuration Update procedure for access and mobility management related parameter as described in section 4.2.4.2 in NPL 3 in order to provide the configured NSSAI.

### <First Variant of FIG. 2 in First Example of the First Aspect:>

In step 7, the AMF 70 may initiate the UE Configuration Update procedure for access and mobility management related parameters as described in section 4.2.4.2 in NPL 3 to remove the S-NSSAI 1 from the allowed NSSAI.

<Second variant of FIG. 2 in First example of the First Aspect:>

In step 7, the UE 3 may initiate a registration procedure as described in section 4.2.2.2 in NPL 3 to remove the S-NSSAI 1 from the allowed NSSAI.

### <Third Variant of FIG. 2 in First Example of the First Aspect:>

In step 7, the UE 3 may initiate a UE requested PDU Session Release for Non-Roaming and Roaming with Local Breakout procedure as described in section 4.3.4.2 in NPL 3 if the UE 3 has established PDU session(s) that is associated with the S-NSSAI 1. For example, in step 7, in a case where the UE 3 determines that the UE 3 has established PDU session(s) that is associated with the S-NSSAI 1 based on local information in the UE 3, the UE 3 may initiate UE requested PDU Session Release for Non-Roaming and Roaming with Local Breakout procedure in order to release the PDU session(s).

### <Fourth Variant of FIG. 2 in First Example of the First Aspect:>

In step 2-1, the (R)AN 5 may perform the validity check for use of S-NSSAI 1 in a case where at least one of the deployment area and the validity time for S-NSSAI 1 have been provisioned, for example by using First example of the Third Aspect described later.

When the (R)AN 5 receives the RRC message that includes S-NSSAI 1 in step 2-1, the (R)AN 5 checks if the UE 3 is accessing the S-NSSAI 1 from the deployment area or within the validity period of the S-NSSAI 1 or both factors if both are applicable. When the (R)AN 5 checks if the UE 3 is accessing the S-NSSAI 1 from the deployment area, the (R)AN 5 may use cell information (e.g. cell ID) to check whether the UE 3 is inside of the deployment area or not. When the (R)AN 5 checks if the UE 3 is accessing the S-NSSAI 1 within the validity period, the (R)AN 5 may use a network time provided by a NTP server to compare the validity time for S-NSSAI 1.

For example, in a case where the (R)AN 5 stores both the deployment area for the S-NSSAI 1 and the validity time for the S-NSSAI 1, the (R)AN 5 checks if the UE 3 is accessing the S-NSSAI 1 from the deployment area within the validity time.

For example, in a case where the (R)AN 5 stores both the deployment area for the S-NSSAI 1 and the validity time for the S-NSSAI 1, the (R)AN 5 checks if the UE 3 is accessing the S-NSSAI 1 from the deployment area or if the UE 3 is accessing the S-NSSAI 1 within the validity time.

For example, in a case where the (R)AN 5 stores the deployment area for the S-NSSAI 1, the (R)AN 5 checks if the UE 3 is accessing the S-NSSAI 1 from the deployment area.

For example, in a case where the (R)AN 5 stores the validity time for the S-NSSAI 1, the (R)AN 5 checks if the UE 3 is accessing the S-NSSAI 1 within the validity time.

For example, it is assumed that the deployment area indicates “cell ID 1”, the validity time indicates “January, 2022”, the (R)AN 5 knows that the UE 3 is in a cell 1 identified by cell ID 1 and the current date is “December, 2021”. In this case, the (R)AN 5 checks if the UE 3 is accessing the S-NSSAI 1 from cell 1 identified by “cell ID 1” and the current date is within “January, 2022”. In this case, the (R)AN 5 determines that the UE 3 is accessing the S-NSSAI 1 from the deployment area (i.e. cell 1 identified by “cell ID 1”) within the validity time.

For example, in a case where the (R)AN 5 determines that the UE 3 is accessing the S-NSSAI 1 from the deployment area within the validity time, the (R)AN 5 sends the Initial UE message in step 2-2.

For example, the (R)AN 5 may store information where the UE 3 locates or information indicating a cell that the UE 3 locates.

For example, in a case where the deployment area indicates information other than the cell level information (e.g. the cell ID), the (R)AN 5 may convert information indicated by the deployment area into the cell level information. For example, the (R)AN 5 may store information for converting into the cell ID. For example, the (R)AN 5 may store a list including combination of cell ID(s) and at least one of TA(s), FB(s) and Geographical area(s) etc.

For example, the (R)AN 5 may know area or location where the UE locates. For example, it is assumed that the deployment area indicates area “Z1” and the validity time indicates “January, 2022”. In a case where (R)AN 5 determines that the UE 3 is accessing the S-NSSAI 1 from area “Z1” and the current date (e.g. “December, 2021”) is within “January 2022”, the (R)AN 5 sends the Initial UE message in step 2-2.

In a case where (R)AN 5 determines that the UE 3 is not accessing the S-NSSAI 1 from area “Z1” or that the current date (e.g. “February, 2022”) is not within “January 2022”, the (R)AN 5 does not send the Initial UE message in step 2-2 or the (R)AN 5 may send an RRC reject message to the UE 3.

In a case where the current date (e.g. “December, 2021”) is within “January 2022”, the (R)AN 5 may determine that the validity time is not expired. In a case where the current date (e.g. “February, 2022”) is not within “January 2022”, the (R)AN 5 may determine that the validity time is expired.

### <Second Aspect>

In order to make a Home Public Land Mobile Network (HPLMN) operator possible to provide procedure to deploy a network slice dedicated to handle a temporary event over a small geographical area or for a limited period with minimum signaling required, it needs, in NPL 2, NPL 3 and other 3GPP specifications, a mechanism for the 5GS to support a deployment of a network slice handling temporary events over limited geographical location. Usually, the operator deploys the network slice homogenously over a tracking area or a registration area and over a longer period of time.

Second Aspect discloses a mechanism that enables the HPLMN operator to deploy a network slice covering a service deployed in limited area for a short time. More specifically this discloses a procedure to support non-homogenous deployment of the network slice within a tracking area or in registration area or for a limited period of time to support a service which is required in limited geographical location over short period of time by providing a temporary allowed NSSAI to a UE 3 during a registration procedure or by initiating a generic UE configuration update procedure.

For example, Second Aspect can solve the above problem such as the latest 3GPP specification cannot fulfil the above-mentioned new market requirement.

### <First Example of the Second Aspect:>

First example of the Second Aspect discloses a procedure where an AMF 70 sends a temporary allowed NSSAI including S-NSSAI with validity time and deployment area to a UE 3. The deployment area can be for example, List of cell ID(s), List of Frequency Band(s) (FB(s)), List of combination of cell ID(s) and FB(s), Geographical area(s) that is mapped to either a tracking area(s) or a cell(s) where the S-NSSAI is deployed to provide a service. The deployment area may be geographic area code by GPS, area defined by address (e.g. City, town, village, administrative division), or Building (e.g. ABC stadium, ABC station, ABC building. Those examples of deployment areas can be combined each other for use. Outside this deployment area (e.g. tracking area(s) or cell(s)), a service related to the S-NSSAI is not deployed and cannot be accessed or provided to the UE 3.

The validity time may be a period of time over which the S-NSSAI is valid for the service. After this time period the service is not provided to the UE 3. The validity time may be time which the S-NSSAI is valid for the service or invalid for the service (e.g. valid at 9:00 AM, invalid at 10:00 AM, valid at 3:00 PM). The validity time may be period or duration over which the S-NSSAI is valid for the service or invalid for the service.

When the UE 3 receives the temporary allowed NSSAI, the UE 3 stores the temporary allowed NSSAI i.e., the UE 3 stores the S-NSSAI along with the deployment area or the validity period or both if provided both. The validity period may be the period of time, validity time or validity duration. When the UE 3 gets trigger to access the service related to the S-NSSAI, the UE 3 checks if a current cell of the UE 3 belongs to the deployment area or current time is under the validity time for the S-NSSAI or both factors if both deployment area and the validity time for the S-NSSAI are provided. If an S-NSSAI access criteria is met, the UE 3 may establish a PDU session related to the S-NSSAI. If the current cell of the UE 3 or current location of the UE 3 belongs to the deployment area, the current time is under the validity time of the S-NSSA, or both factors are met if both deployment area and the validity time of the S-NSSAI are provided, the UE3 may establish the PDU session related to the S-NSSAI.

The UE 3 may or may not include temporary allowed S-NSSAI in a requested NSSAI of a Registration Request message. The temporary allowed S-NSSAI may mean S-NSSAI included in the temporary allowed NSSAI.

In a case where the UE 3 moves out of the deployment area, the validity time for the S-NSSAI expires, or the validity time passes, the UE 3 and a network locally deactivate the PDU session or deactivate the PDU session with explicit NAS signaling (i.e., by sending an existing NAS message).

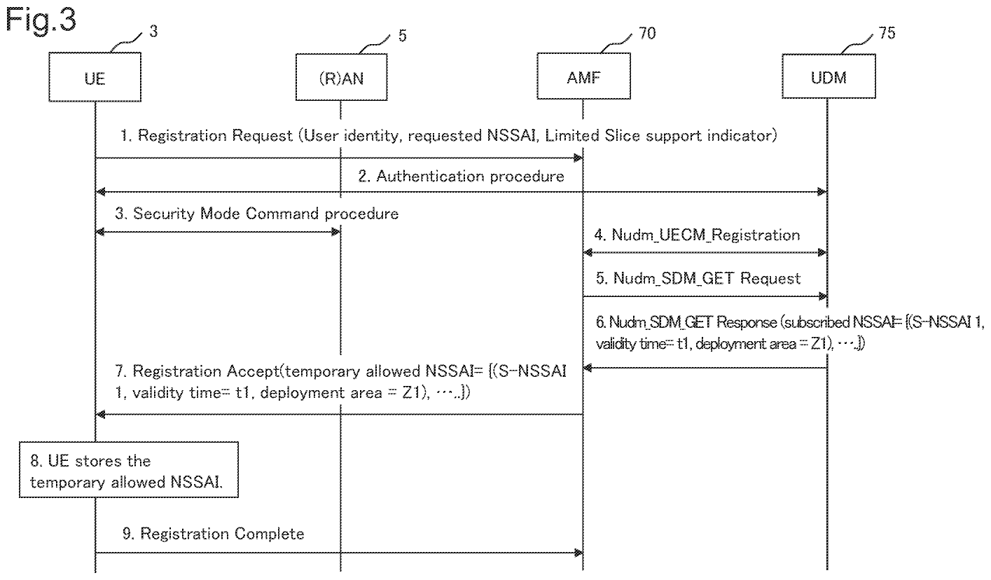

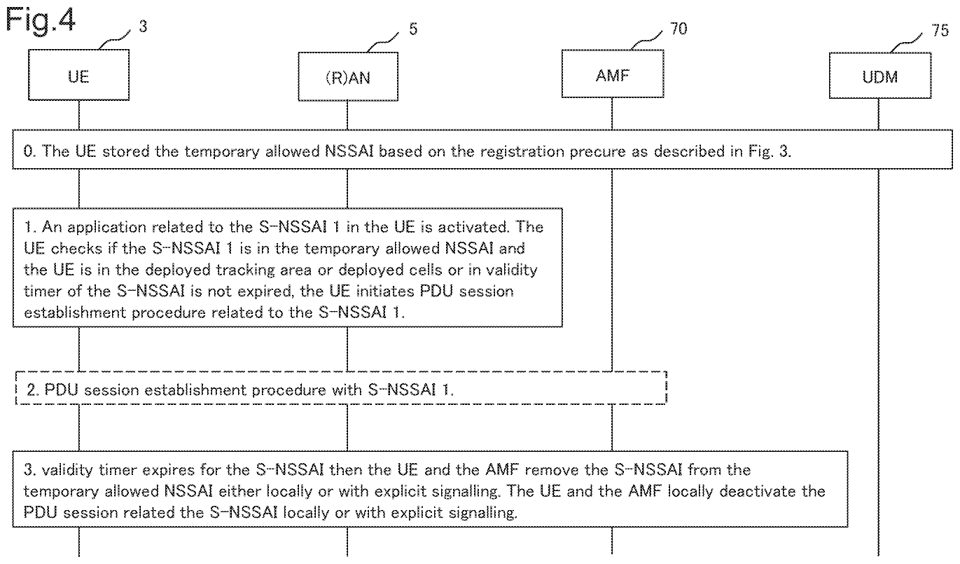

First example of the Second Aspect is disclosed with FIG. 3 and FIG. 4. While FIG. 3 illustrates the provisioning the temporary allowed NSSAI to the UE 3, the FIG. 4 illustrates the UE 3 and network behaviors after the temporary allowed NSSAI is provided to the UE 3.

### <Provisioning the Temporary Allowed NSSAI to the UE>

1. The UE 3 sends a Registration Request message to the AMF 70 including limited slice support indicator and optionally S-NSSAI 1 in a requested NSSAI. The limited slice support indicator indicates that the UE 3 supports S-NSSAI with at least one of deployment area and validity time attribution. For example, the limited slice support indicator may indicate that the UE 3 supports S-NSSAI with at least one of the deployment area and the validity time. The Registration Request message can be sent during an initial registration procedure, a mobility registration procedure or a periodic registration procedure. The Registration Request message may include User identity. The User identity may indicate identity of the UE 3.

Steps 2 to 6 are the same as steps 2 to 6 in the FIG. 1.

7. The AMF 70 sends S-NSSAI 1 along with at least one of the deployment area and the validity time or both if both are applicable to the S-NSSAI 1 to the UE 3 in the temporary allowed NSSAI in a Registration Accept message if the UE 3 indicate the limited slice support indicator in the Registration Request message in step 1. Otherwise, the AMF 70 does not provide the S-NSSAI 1 in the temporary allowed NSSAI to the UE 3.

For example, the AMF 70 may send the S-NSSAI 1 along with at least one of the deployment area and the validity time in the temporary allowed NSSAI in the Registration Accept message if the deployment area and the validity time are applicable to the S-NSSAI 1.

For example, the AMF 70 may send the S-NSSAI 1 along with the deployment area in the temporary allowed NSSAI in the Registration Accept message if the deployment area is applicable to the S-NSSAI 1.

For example, the AMF 70 may send the S-NSSAI 1 along with the validity time in the temporary allowed NSSAI in the Registration Accept message if the validity time is applicable to the S-NSSAI 1.

For example, the AMF 70 may store information to determine whether at least one of the deployment area and the validity time is applicable to S-NSSAI(s) for the UE 3.

For example, the AMF 70 may send the S-NSSAI 1 along with at least one of the deployment area and the validity time in the temporary allowed NSSAI in the Registration Accept message if the UE 3 does not indicate the limited slice support indicator in the Registration Request message in step 1.

If the UE 3 does not provide the limited slice support indicator but provides S-NSSAI 1 in the requested NSSAI in the Registration Request message in step 1, the AMF 70 provides the S-NSSAI 1 in a rejected NSSAI in the Registration Accept message.

The AMF 70 may covert the received deployment area into List of Tracking Area(s) (e.g. List of TAI(s)) or List of cell ID(s). The AMF 70 may convert the receive validity time to a validity time in another time format, for example, a time period with local time zone.

For example, the AMF 70 stores information for converting the received deployment area into List of Tracking Area(s) (e.g. List of TAI(s)) or List of cell ID(s).

For example, the AMF 70 stores information indicating that location or place indicated by the deployment area includes TA 1 or cell 1 identified by cell ID 1, and may covert the received deployment area into the List including TA 1 or cell ID 1.

For example, the AMF 70 stores information indicating that FB indicated by the deployment area is used in TA 1 or cell 1 identified by cell ID 1, and may covert the received deployment area into the List including TA 1 or cell ID 1.

The limited slice support indicator may indicate that the UE 3 supports reception of S-NSSAI(s) along with at least one of the deployment area and the validity time in the temporary allowed NSSAI.

Contents of the temporary allowed NSSAI may correspond to contents of the subscribed NSSAI.

For example, in a case where the subscribed NSSAI includes the S-NSSAI 1 and at least one of the deployment area for the S-NSSAI 1 and the validity time for the S-NSSAI 1, the temporary allowed NSSAI may include the S-NSSAI 1 and at least one of the deployment area for the S-NSSAI 1 and the validity time for the S-NSSAI 1.

For example, the AMF 70 may decide contents of the temporary allowed NSSAI. For example, the AMF 70 may send the temporary allowed NSSAI regarding S-NSSAI included in the requested NSSAI in step 1. For example, it is assumed that the AMF 70 receives the requested NSSAI including S-NSSAI 1 in step 1, and the AMF 70 receives, in step 6, the subscribed NSSAI including S-NSSAI 1, the deployment area for the S-NSSAI 1, the validity time for the S-NSSAI 1, S-NSSAI 2, the deployment area for the S-NSSAI 2, and the validity time for the S-NSSAI 2. In this case, the AMF 70 may send the temporary allowed NSSAI including S-NSSAI 1, the deployment area for the S-NSSAI 1, and the validity time for the S-NSSAI 1.

The temporary allowed NSSAI may include one or more S-NSSAIs and the deployment area for each of the one or more S-NSSAIs and the validity time for each of the one or more S-NSSAIs.

8. Upon reception of the Registration Accept message, the UE 3 stores the temporary allowed NSSAI.

9. The UE 3 may send a Registration Complete message. For example, the UE 3 may send the Registration Complete message after step 7 or 8.

<UE and Network Behavior after the Temporary Allowed NSSAI is Provided to the UE>

0. It is assumed that the UE 3 and 5GS performed the registration procedure as illustrated in FIG. 3 in First example of the Second Aspect. It means that the UE 3 may store the S-NSSAI 1 in the temporary allowed NSSAI along with at least one of the deployment area and the validity time.

1. When the UE 3 gets trigger to access a service related to the S-NSSAI 1, the UE 3 checks if a current cell of the UE 3 belongs to the deployment area or current time is under the validity time for the S-NSSAI 1 or both factors if both deployment area and the validity time for the S-NSSAI are provided. For example, when the UE 3 gets trigger to access a service related to the S-NSSAI 1, the UE 3 checks if a current location of the UE 3 belongs to the deployment area or current time is under the validity time for the S-NSSAI 1 or both factors if both deployment area and the validity time for the S-NSSAI are provided. For example, the UE3 gets trigger to access the service related to the S-NSSAI 1 in a case where the an application related to the S-NSSAI 1 in the UE 3 is activated.

“A current cell of the UE 3 or current location of the UE3 belongs to the deployment area” may be expressed as a first criteria. “Current time is under the validity time” may be expressed as a second criteria. At least one of the first criteria and the second criteria may be expressed as an S-NSSAI access criteria.

For example, in a case where the UE 3 stores the S-NSSAI 1 in the temporary allowed NSSAI along with both the deployment area and the validity time, the UE 3 may check at least one of the first criteria and the second criteria.

For example, in a case where the UE 3 stores the S-NSSAI 1 in the temporary allowed NSSAI along with the deployment area, the UE 3 may check the first criteria.

For example, in a case where the UE 3 stores the S-NSSAI 1 in the temporary allowed NSSAI along with the validity time, the UE 3 may check the second criteria.

For example, when the UE 3 checks whether the first criteria is met, the UE 3 may check if a current cell of the UE 3 belongs to or is same to a cell indicated by the deployment area. In this case, the UE may use cell ID(s) to check if a current cell of the UE 3 belongs to or is same to a cell indicated by the deployment area. For example, when the UE 3 checks whether the first criteria is met, the UE 3 may check if a current TA of the UE 3 belongs to or is same to a TA indicated by the deployment area. In this case, the UE may use TAI(s) to check if a current TA of the UE 3 belongs to or is same to a TA indicated by the deployment area.

For example, when the UE 3 checks whether the first criteria is met, the UE 3 may check if a current location of the UE 3 belongs to or is same to a location indicated by the deployment area.

For example, the UE 3 may obtain information indicating the current cell or the current TA from other node(s) such as (R)AN 5.

For example, the UE 3 may obtain the current location of the UE 3 by using GPS.

For example, the UE 3 may convert location information indicated by the deployment area into information indicating cell(s), and the UE 3 checks if a current cell of the UE 3 belongs to the cell(s) indicated by the converted information. The information indicating cell(s) may be cell ID(s). For example, the UE 3 may store information for converting into the information indicating the cell(s). For example, the UE 3 may store a list including combination of cell ID(s) and at least one of TA(s), FB(s) and Geographical area(s) etc.

For example, when the UE 3 checks whether the second criteria is met, the UE 3 may check if a current time or current date is within time or time period indicated by the validity time.

2. If the S-NSSAI access criteria for S-NSSAI 1 in step 1 is met, the UE 3 sends a PDU Session Establishment Request message containing the S-NSSAI1 to initiate the UE Requested PDU Session Establishment as described in section 4.3.2.2 NPL 3. If the UE3 checks if the UE 3 belongs to the deployed area, current time is the validity time of the S-NSSAI1, or is related to both factors (deployed area or validity period of the S-NSSAI1), the UE3 sends PDU Session Establishment Request message containing the S-NSSAI1 to initiate the UE Requested PDU Session Establishment as described in section 4.3.2.2 NPL 3.

For example, in a case where the UE 3 determines that at least one of the first criteria and the second criteria is met, the UE 3 may send the PDU Session Establishment Request message.

For example, in a case where the UE 3 determines that the first criteria is met, the UE 3 may send the PDU Session Establishment Request message.

For example, in a case where the UE 3 determines that the second criteria is met, the UE 3 may send the PDU Session Establishment Request message.

For example, it is assumed that the deployment area indicates area “Z1”, and the validity time indicates “January, 2022”. In a case where the UE 3 determines that a current cell of the UE 3 (e.g. cell 1) or current location of the UE 3 belongs to area “Z1” and the current date (e.g. “December, 2021”) is within “January, 2022”, the UE 3 sends the PDU Session Establishment Request message. For example, the UE 3 may store information indicating that area “Z1” includes cell 1 or current location of the UE 3 belongs to area “Z1”, and may use this information to check the first criteria.

For example, the UE 3 may convert area “Z1” into information indicating cell(s) or location(s), and may determine whether the current cell or location belongs to or is same to the cell(s) or the location(s) indicated by the converted information. In a case where the UE 3 determines that a current cell or location of the UE 3 belongs to or is same to the cell(s) or the location(s) indicated by the converted information and the current date (e.g. “December, 2021”) is within “January, 2022”, the UE 3 sends the PDU Session Establishment Request message.

In a case where the UE 3 determines that the current cell of the UE 3 or current location of the UE 3 does not belong to area “Z1” or that the current date (e.g. “February, 2022”) is not within “January 2022”, the UE 3 does not send the PDU Session Establishment Request message. In a case where the current date (e.g. “December, 2021”) is within “January 2022”, the UE 3 may determine that the validity time is not expired. In a case where the current date (e.g. “February, 2022”) is not within “January 2022”, the UE 3 may determine that the validity time is expired.

For example, “determining that the current date is within the validity time” may be expressed as “determining that the current date is under the validity time” or “determining that the current date is before the validity time”.

The deployment area may indicate where the S-NSSAI 1 is valid or available. In a case where the deployment area indicates area “Z1”, the deployment area may mean that the S-NSSAI 1 is valid or available within area “Z1”.

The validity time may indicate how long the S-NSSAI 1 is valid or available. In a case where the validity time indicates “January, 2022”, the validity time may mean that the S-NSSAI 1 is valid or available by the January 2022.

In a case where the deployment area indicates List of FB(s), the deployment area may indicate which FB(s) the S-NSSAI 1 is valid or available. In a case where the deployment area indicates “FB1”, the deployment area may mean that the S-NSSAI 1 is valid or available on “FB1”. For example, the UE 3 checks if the UE 3 tunes to “FB1”, and the UE 3 sends the PDU Session Establishment Request message in a case where the UE 3 determines that UE 3 tunes to “FB1” currently.

In a case where the deployment area indicates List of combination(s) cell ID(s) and FB(s), the deployment area may indicate combination of cell ID(s) and FB(s) that the S-NSSAI 1 is valid or available. In a case where the deployment area indicates combination of “cell ID1” and “FB1”, the deployment area may mean that the S-NSSAI 1 is valid or available on a cell which operates in “FB1” and is identified by “cell ID1”. For example, the UE 3 checks if the UE 3 locates on a cell identified by “cell ID1” and if the UE 3 tunes to “FB1”, and the UE 3 sends the PDU Session Establishment Request message in a case where the UE 3 determines that the UE 3 locates on the cell identified by “cell ID1” and that UE 3 tunes to “FB1” currently.

3. In a case where the UE 3 moves out of the deployment area or the validity time for the S-NSSAI 1 expires or passes, at least one of the UE 3 and the network (e.g. the AMF 70) locally removes the S-NSSAI 1 from the temporary allowed NSSAI or remove the S-NSSAI 1 from the temporary allowed NSSAI with explicit NAS signaling (i.e. by sending an existing NAS message).

If the UE 3 has established PDU session(s) that is associated with the S-NSSAI 1, the AMF 70 initiates a network requested PDU Session Release for Non-Roaming and Roaming with Local Breakout procedure as described in section 4.3.4.2 in NPL 3.

For example, in a case where the UE 3 calculates the current location of the UE 3 and determines that the UE 3 moves out the deployment area based on the current location, the UE 3 may remove the S-NSSAI 1 from the temporary allowed NSSAI.

For example, in a case where the UE 3 determines that the UE 3 moves out the deployment area based on the current location, the UE 3 may initiate a procedure that involves sending the existing NAS message in order to remove the S-NSSAI 1 from the temporary allowed NSSAI.

For example, the UE 3 may send the current location of the UE 3 periodically to the AMF 70. The UE May 3 send the current location in a case where the UE 3 receives a request to send the current location. In this case, the AMF 70 may determine whether the UE 3 moves out the deployment area based on the current location. In a case where the AMF 70 determines that the UE 3 moves out the deployment area based on the current location, the AMF 70 may remove the S-NSSAI 1 from the temporary allowed NSSAI.

For example, in a case where the AMF 70 determines that the UE 3 moves out the deployment area based on the current location, the AMF 70 may initiate a procedure that involves sending the existing NAS message in order to remove the S-NSSAI 1 from the temporary allowed NSSAI. For example, the AMF may remove the S-NSSAI 1 from the temporary allowed NSSAI by updating the temporary allowed NSSAI, and send the updated temporary allowed NSSAI to the UE 3.

For example, in a case where the AMF 70 determines that the UE 3 has established PDU session(s) that is associated with the S-NSSAI 1, the AMF 70 may initiate the network requested PDU Session Release for Non-Roaming and Roaming with Local Breakout procedure.

For example, in a case where the AMF 70 determines that the UE 3 moves out of the deployment area and the UE 3 has established PDU session(s) that is associated with the S-NSSAI 1, the AMF 70 may initiate the network requested PDU Session Release for Non-Roaming and Roaming with Local Breakout procedure.

For example, in a case where the AMF 70 determines that the validity time for the S-NSSAI 1 expires and the UE 3 has established PDU session(s) that is associated with the S-NSSAI 1, the AMF 70 initiates the network requested PDU Session Release for Non-Roaming and Roaming with Local Breakout procedure.

The AMF 70 may determine that the UE 3 has established PDU session(s) that is associated with the S-NSSAI 1 by using local information in the AMF 70 or by receiving information from another network node (e.g. an SMF or a UDM).

For example, a communication apparatus corresponding to the AMF 70 may receive Single Network Slice Selection Assistance Information (S-NSSAI), first information indicating where the S-NSSAI is valid and second information indicating when the S-NSSAI is valid. The communication apparatus may send the S-NSSAI, the first information and the second information.

For example, a User Equipment (UE) corresponding to the UE 3 may receive a first message. The first message may include Single Network Slice Selection Assistance Information (S-NSSAI), first information indicating where the S-NSSAI is valid and second information indicating when the S-NSSAI is valid. The UE may determine whether the S-NSSAI is valid based on the first information and the second information. The UE may send a second message in a case where the S-NSSAI is valid. The second message may include the S-NSSAI.

For example, a first communication apparatus corresponding to the AMF 70 may receive, from a second communication apparatus corresponding to the UDM 75, information related to Single Network Slice Selection Assistance Information (S-NSSAI). The first communication apparatus may receive, from the second communication apparatus, at least one of information related to validity time for the S-NSSAI and information related to validity area for the S-NSSAI. The first communication apparatus may send, to a communication terminal, at least one of information indicating registration to a network slice related to the S-NSSAI is permitted based on at least one of the information related to validity time for the S-NSSAI and information related to validity area for the S-NSSAI.

For example, a communication terminal corresponding to the UE 3 send, to a first communication apparatus corresponding to the AMF 70, a request message for a network slice. The communication terminal may receive, from the first communication apparatus, information indicating registration to the network is permitted including at least one of information related to validity time for the network slice and validity area for the network slice.

According to the above, the above problem such as the latest 3GPP specification cannot fulfil the above-mentioned new market requirement can be solved.

### <First Variant of FIG. 3 in First Example of the Second Aspect:>

In one example, anytime the AMF 70 may provide the temporary allowed NSSAI containing S-NSSAI with at least one of its validity period and its deployment area in a Configuration update command message or in any existing NAS message. For example, the AMF 70 may initiate a UE Configuration Update procedure for access and mobility management related parameter as described in section 4.2.4.2 in NPL 3 in order to provide the temporary allowed NSSAI.

### <First Variant of FIG. 4 in First Example of the Second Aspect:>

In step 3, the AMF 70 may initiate the UE Configuration Update procedure for access and mobility management related parameters as described in section 4.2.4.2 in NPL 3 to remove the S-NSSAI 1 from the temporary allowed NSSAI.

### <Second Variant of FIG. 4 in First Example of the Second Aspect:>

In step 3, the UE 3 may initiate a registration procedure as described in section 4.2.2.2 in NPL 3 to remove the S-NSSAI 1 from the temporary allowed NSSAI.

### <Third Variant of FIG. 4 in First Example of the Second Aspect:>

In step 3, the UE 3 may initiate a UE requested PDU Session Release for Non-Roaming and Roaming with Local Breakout procedure as described in section 4.3.4.2 in NPL 3 if the UE 3 has established PDU session(s) that is associated with the S-NSSAI 1. For example, in step 7, in a case where the UE 3 determines that the UE 3 has established PDU session(s) that is associated with the S-NSSAI 1 based on local information in the UE 3, the UE 3 may initiate UE requested PDU Session Release for Non-Roaming and Roaming with Local Breakout procedure in order to release the PDU session(s).

### <Third Aspect>

Third aspect discloses a procedure to manage a network slice which is available within limited geographical area and may be over limited period of time. More specifically, Third Aspect discloses how a network function configures a network slice in an AMF 70 and a (R)AN 5 when a network slice provides a service which is localized or available over limited period or both. The (R)AN 5 may include a (R)AN node such as an NG-RAN node or a gNB.

For example, Third Aspect can solve the above problem such as the latest 3GPP specification cannot fulfil the above-mentioned new market requirement.

### <First Example of the Third Aspect>

First example of the Third Aspect discloses Network slice information provisioning to the AMF 70, the (R)AN 5 and a UE 3 in a case where network slice(s) is conditionally available in a certain geographical area or with limited period of time.

### <Network Slice Information Provisioning to AMF:>

First example of the Third Aspect discloses that a network function (e.g. a UDM 75 or other NFs) which manages network slice(s) to provide a service in a certain geographical area or with limited period of time, sends an existing message or a new message to the AMF 70 that contains S-NSSAI to be configured, deployment area for the S-NSSAI or validity period for the S-NSSAI or both the deployment area and the validity period.

### <Network Slice Information Provisioning to (R)AN:>

The AMF 70 sends an existing NGAP message or a new NGAP message to the (R)AN 5 containing the S-NSSAI, the deployment area or the validity time or both the deployment area and the validity time.

### <Network Slice Information Provisioning to UE:>

Upon receiving the NGAP message (e.g. a first NGAP message or a fourth NGAP message described below) containing the S-NSSAI, the deployment area or the validity time or both the deployment area and the validity time, the (R)AN 5 converts the received deployment area to corresponding cell(s) and stores S-NSSAI availability information per cell with validity time. The (R)AN 5 broadcasts information related to a support of the S-NSSAI(s) based on the stored S-NSSAI availability information. The S-NSSAI availability information may indicate whether the S-NSSAI is available or not.

If the validity period is provided, the (R)AN 5 broadcasts the information related to the support of the S-NSSAI in the cell(s) mapped from the deployment area. If the validity period is provided, the (R)AN 5 broadcasts the information related to the support of the S-NSSAI at the location(s) mapped from the deployment area. If the validity period is provided, the (R)AN 5 broadcasts the information related to the support of the S-NSSAI during the validity period of the S-NSSAI.

The detailed each three procedures of the Third aspects are described below.

1. A network function (NF) 77 (e.g. the UDM 75 or other NF(s)) which manages a network slice to provide a service in a certain geographical area or with limited period of time, sends a first message to the AMF 70 that contains S-NSSAI 1 to be configured, deployment area for the S-NSSAI 1 or the validity period for the S-NSSAI 1 or both the deployment area and the validity period. The S-NSSAI 1 may be associated with at least one of the deployment area and the validity period. The deployment area can be for example, List of cell ID(s), List of Frequency Band(s) (FB(s)), List of combination of cell ID(s) and FB(s), Geographical area(s) that is mapped to either a tracking area(s) a cell(s) where the S-NSSAI 1 is deployed to provide a service.

Upon reception of the first message, the AMF 70 maps the deployment area into tracking area(s), and identifies the (R)AN 5 that manages the tracking area(s).

For example, the AMF 70 stores location information indicating a location of the tracking area(s), and the AMF 70 may map the deployment area into the tracking area(s) based on the location information and a location indicated by the deployment area.

For example, in a case where the AMF 70 stores information indicating that tracking area 1 includes cell 1 which is identified cell ID 1 and the received deployment area indicates cell ID 1, the AMF 70 may map the deployment area into the tracking area 1.

For example, in a case where the AMF 70 stores information indicating that tracking area 1 operates in FB 1 and the received deployment area indicates FB 1, the AMF 70 may map the deployment area into the tracking area 1.

For example, in a case where the AMF 70 stores location “Z1” as a location information of the tracking area 1 and the received deployment area indicates the location “Z1”, the AMF 70 may map the deployment area into the tracking area 1.

For example, in a case where the received deployment area indicates the tracking area 1, the AMF 70 may map the deployment area into information related to the tracking area 1 stored in the AMF 70.

For example, the AMF 70 stores information indicating the tracking area that the (R)AN 5 manages, and the AMF 70 may identify the (R)AN 5 that manages the tracking area based on the information.

The first message may include one or more S-NSSAIs and the deployment area for each of the one or more S-NSSAIs and the validity time for each of the one or more S-NSSAIs.

The NF 77 may decide contents of the first message based on at least one of a local configuration in the UDM 75, operator's policy and S-NSSAI(s) that the UE 3 subscribes.

For example, in a case where the NF 77 stores information indicating that the UE 3 subscribes to the S-NSSAI 1, the UDM 75 may generate the subscribed NSSAI regarding the S-NSSAI 1.

The NF 77 may send the first message periodically. The NF 77 may send the first message in a case where the NF 77 receives trigger to send the first message. The NF 77 may send the first message in a case where the NF 77 determines that relationship between S-NSSAI(s) and at least one of the deployment area and the validity time is changed.

2. There are two ways that the AMF 70 sends network slice information to the (R)AN 5, such as Option1 and Option 2. The network slice information may include the S-NSSAI 1, and at least one of the deployment area and the validity period. The network slice information may include the S-NSSAI 1, and at least one of the deployment area for the S-NSSAI 1 and the validity period for the S-NSSAI 1. The network slice information may include one or more S-NSSAIs and the deployment area for each of the one or more S-NSSAIs and the validity time for each of the one or more S-NSSAIs.

### <Option 1:>

2-1-1. The AMF 70 sends a first NGAP message (e.g. an existing NGAP message or a new NGAP message) to the (R)AN 5 containing the S-NSSAI 1, the deployment area or the validity time or both the deployment area and the validity time.

The first NGAP message may include the S-NSSAI 1 along with at least one of the deployment area for the S-NSSAI 1 and the validity time for the S-NSSAI 1.

The first NGAP message may include one or more S-NSSAIs and the deployment area for each of the one or more S-NSSAIs and the validity time for each of the one or more S-NSSAIs.

Contents of the first NGAP message may correspond to contents of the first message. For example, in a case where the first message includes the S-NSSAI 1 and at least one of the deployment area for the S-NSSAI 1 and the validity time for the S-NSSAI 1, the first NGAP message may include the S-NSSAI 1 and at least one of the deployment area for the S-NSSAI 1 and the validity time for the S-NSSAI 1.

For example, the AMF 70 may decide contents of the first NGAP message. For example, the AMF 70 may include, in first NGAP message, S-NSSAI(s) that the AMF 70 can handle.

In one example, the first NGAP message may be an AMF CONFIGURATION UPDATE message.

In another example, the AMF 70 sends the first NGAP message to the (R)AN 5 in a case where the AMF 70 receives the first message in step 1. In another example, the AMF 70 sends the first NGAP message to the (R)AN 5 in a case where the AMF 70 is triggered to send the first NGAP message based on a local configuration of the AMF 70 or based on operator's policy. In another example, the AMF 70 sends the first NGAP message to the (R)AN 5 periodically.

In another example, the AMF 70 does not send, to the (R)AN 5, associated information of the S-NSSAI 1 such as the deployment area or the validity time or both the deployment area and the validity time in the first NGAP message if the AMF 70 knows in advance that the (R)AN 5 is not capable to handle the associated information through a NGAP interface management procedure(s). For example, the AMF 70 may know that the (R)AN 5 is not capable to handle the associated information by exchanging capability information regarding the (R)AN 5 between the AMF 70 and the (R)AN 5 through the NGAP interface management procedure(s).

2-1-2. The (R)AN 5 receives the first NGAP message. The (R)AN 5 stores the S-NSSAI 1 and at least one of the deployment area for the S-NSSAI 1 and the validity time for the S-NSSAI 1, and maps them to cell(s) that the (R)AN 5 manages.

Then, the (R)AN 5 sends a second NGAP message (e.g. an existing NGAP message or a new NGAP message) to the AMF 70 to confirm that the (R)AN 5 has successfully received the network slice information.

In one example, the second NGAP message may be an AMF CONFIGURATION ACKNOWLEDGE message.

For example, the (R)AN 5 stores location information indicating a location of the cell(s) that the (R)AN 5 manages, and the (R)AN 5 may map the S-NSSAI 1 and at least one of the deployment area and the validity time into the cell(s) based on the location information and a location indicated by the deployment area.

For example, in a case where the (R)AN 5 stores cell ID 1 identifying cell 1 that the (R)AN 5 manages and the received deployment area indicates cell ID 1, the (R)AN 5 may map the S-NSSAI 1 and at least one of the deployment area and the validity time into cell 1.

For example, in a case where the (R)AN 5 manages cell 1 and the (R)AN 5 stores information indicating that cell 1 operating in FB 1 and the received deployment area indicates FB 1, the (R)AN 5 may map the S-NSSAI 1 and at least one of the deployment area and the validity time into cell 1.

For example, in a case where the (R)AN 5 stores location “Z1” as a location information of cell 1 that the (R)AN 5 manages and the received deployment area indicates the location “Z1”, the (R)AN 5 may map the S-NSSAI 1 and at least one of the deployment area and the validity time into cell 1.

### <Option 2:>

2-2-1. The (R)AN 5 sends a third NGAP message to AMF 70 including a Limited Slice support indicator as a part of the NGAP interface management procedures. The limited Slice support indicator may indicate that the (R)AN 5 supports S-NSSAI with at least one of deployment area and validity time attribution. For example, the limited slice support indicator may indicate that the (R)AN 5 supports S-NSSAI with at least one of deployment area and validity time. The limited Slice support indicator may indicate that the (R)AN 5 supports to receive S-NSSAI with at least one of deployment area and validity time as mentioned in step 2-2-2.

In one example, the third NGAP message may be an NG SETUP REQUEST message or a RAN CONFIGURATION UPDATE message.

2-2-2. The AMF 70 sends a fourth NGAP message (e.g. an existing NGAP message or a new NGAP message) to (R)AN 5 containing S-NSSAI 1, the deployment area for the S-NSSAI 1 or the validity time for the S-NSSAI 1 or both the deployment area and the validity time.

The fourth NGAP message may include the S-NSSAI 1 along with at least one of the deployment area for the S-NSSAI 1 and the validity time for the S-NSSAI 1.

The fourth NGAP message may include one or more S-NSSAIs and the deployment area for each of the one or more S-NSSAIs and the validity time for each of the one or more S-NSSAIs.

Contents of the fourth NGAP message may correspond to contents of the first message. For example, in a case where the first message includes the S-NSSAI 1 and at least one of the deployment area for the S-NSSAI 1 and the validity time for the S-NSSAI 1, the fourth NGAP message may include the S-NSSAI 1 and at least one of the deployment area for the S-NSSAI 1 and the validity time for the S-NSSAI 1.

For example, the AMF 70 may decide contents of the fourth NGAP message. For example, the AMF 70 may include, in fourth NGAP message, S-NSSAI(s) that the AMF 70 can handle.

For example, the AMF 70 may send the fourth NGAP message in a case where the AMF 70 receives the first message in step 1 or the third NGAP message in step 2-2-1.

Upon reception of the fourth NGAP message, the (R)AN 5 stores the S-NSSAI 1 and at least one of the deployment area and the validity time, and maps them to cell(s) that the (R)AN 5 manages. For example, the (R)AN 5 may maps the S-NSSAI 1 and at least one of the deployment area and the validity time to the cell(s) in a same manner as process(es) in step 2-1-2.

In one example, the fourth NGAP message may be an NG SETUP RESPONSE message or a RAN CONFIGURATION UPDATE ACKNOWLEDGE message.

In another example, the AMF 70 does not send the fourth NGAP message to the (R)AN 5 if the (R)AN 5 does not indicate the Limited Slice support indicator in the third NGAP message.

In another example, the AMF 70 may send the fourth NGAP message to the (R)AN 5 if the (R)AN 5 does not indicate the Limited Slice support indicator in the third NGAP message.

3. A cell that is connected to the (R)AN 5 broadcasts support of the S-NSSAI 1 if a condition matched. In this example, the cell does not broadcast support of the S-NSSAI1 since validity time does not match although the cell covers the deployment area.

For example, it is assumed that the current time is “November, 2021”, the deployment area for the S-NSSAI 1 indicates cell ID 1 which identifies cell 1, the validity time for the S-NSSAI 1 indicates “from December 2021 to January 2022”, and the (R)AN 5 (e.g. a (R)AN node, or NG-RAN node, or a gNB) manages cell 1.

I.e., the deployment area indicates that the S-NSSAI 1 is valid or available in the cell 1, and the validity time indicates that the S-NSSAI 1 is valid or available during a time period from December 2021 to January 2022.

In this example, the (R)AN 5 determines that the cell 1 belongs to or is same to the cell indicated by the deployment area. In other words, the (R)AN 5 determines that the cell 1 covers the deployment area. The (R)AN 5 determines that the current time (e.g. November 2021) is not within the validity time. Then the (R)AN 5 does not broadcast, in the cell 1, system information including S-NSSAI 1. Or the (R)AN 5 broadcasts, in the cell 1, system information including information indicating that S-NSSAI 1 is not available.

For example, in a case where the UE 3 receives the system information including information indicating that S-NSSAI 1 is not available, the UE 3 does not include the S-NSSAI 1 in a requested NSSAI of a Registration Request message when the UE 3 initiates a registration procedure.

For example, in a case where the UE 3 receives the system information including information indicating that S-NSSAI 1 is not available, the UE 3 does not initiate a PDU session establishment procedure with the S-NSSAI 1.

4. As time goes by, the validity time becomes effective (or valid). For example, the current time is “Dec. 1, 2021”.

5. The cell broadcasts support of the S-NSSAI 1 since both validity time and the deployment area matched.

For example, it is assumed that the current time is “Dec. 1, 2021”, the deployment area for the S-NSSAI 1 indicates cell ID 1 which identifies cell 1, the validity time for the S-NSSAI 1 indicates “from December 2021 to January 2022”, and the (R)AN 5 (e.g. a (R)AN node, or NG-RAN node, or a gNB) manages cell 1. In this example, the (R)AN 5 determines that the cell 1 belongs to or is same to the cell indicated by the deployment area. The (R)AN 5 determines that the current time (e.g. Dec. 1, 2021) is within the validity time (or the (R)AN 5 determines that the validity time is not expired). Then the (R)AN 5 broadcasts, in the cell 1, system information including S-NSSAI 1. Or the (R)AN 5 broadcasts, in the cell 1, system information including information indicating that S-NSSAI 1 is available.

For example, in a case where the UE 3 receives the system information including information indicating that S-NSSAI 1 is available, the UE 3 includes the S-NSSAI 1 in a requested NSSAI of a Registration Request message when the UE 3 initiates a registration procedure.

For example, in a case where the UE 3 receives the system information including information indicating that S-NSSAI 1 is available, the UE 3 initiates a PDU session establishment procedure with the S-NSSAI 1.

6. As time goes by, the validity time becomes not effective (Invalid). For example, the current time is “February, 2022”.

7. The cell does not broadcast support of the S-NSSAI1 since validity time does not matched although the cell covers the deployment area.

For example, it is assumed that the current time is “February, 2022”, the deployment area for the S-NSSAI 1 indicates cell ID 1 which identifies cell 1, the validity time for the S-NSSAI 1 indicates “from December 2021 to January 2022”, and the (R)AN 5 (e.g. a (R)AN node, or NG-RAN node, or a gNB) manages cell 1. In this example, the (R)AN 5 determines that the cell 1 belongs to or is same to the cell indicated by the deployment area. The (R)AN 5 determines that the current time (e.g. February 2022) is not within the validity time (or the (R)AN 5 determines that the validity time is expired). Then the (R)AN 5 does not broadcast, in the cell 1, system information including S-NSSAI 1. Or the (R)AN 5 broadcasts, in the cell 1, system information including information indicating that S-NSSAI 1 is not available.

For example, in a case where the UE 3 receives the system information including information indicating that S-NSSAI 1 is not available, the UE 3 does not include the S-NSSAI 1 in a requested NSSAI of a Registration Request message when the UE 3 initiates a registration procedure.

For example, in a case where the UE 3 receives the system information including information indicating that S-NSSAI 1 is not available, the UE 3 does not initiate a PDU session establishment procedure with the S-NSSAI 1.

For example, a communication apparatus corresponding to the (R)AN 5 may receive Single Network Slice Selection Assistance Information (S-NSSAI), first information indicating where the S-NSSAI is valid and second information indicating when the S-NSSAI is valid. The communication apparatus may determine whether the S-NSSAI is valid based on the first information and the second information. The communication apparatus may send first system information in a case where the S-NSSAI is valid. The first system information may include information indicating the S-NSSAI is valid.

For example, a first communication apparatus corresponding to the AMF 70 may receive, from a second communication apparatus corresponding to the NF 77, at least one of at least one of information related to validity time for the network slice and validity area for the network slice. The first communication apparatus may send, to a first base station may correspond to the (R)AN 5, a first message related to at least one of the information related to validity time for the network slice and validity area for the network slice. The first communication apparatus may receive, from the first base station, a second message to confirm the first radio station receive the first message. The first communication apparatus may send, to a communication terminal may correspond to the UE 3, at least one of information related to the validity area and information invalid time. The first communication apparatus may send, to a communication terminal may correspond to the UE 3, information related to the validity area and the validity time.

For example, a first communication apparatus corresponding to the AMF 70 may receive, from a second communication apparatus corresponding to the NF 77, at least one of at least one of information related to validity time for the network slice and validity area for the network slice. The first communication apparatus may receive, from a first base station corresponding to the (R)AN 5, a first message indicating the first base station manages a network slice in at least one of validity area and validity time. The first communication apparatus may send, to the first base station, a second message related to at least one of the validity time for the network slice and the validity area for the network slice. The first communication apparatus may send, to a communication terminal corresponding to the UE 3, at least one of information related to the validity area and information invalid time. The first communication apparatus may send, to a communication terminal corresponding to the UE 3, information related to the validity area and the validity time.

According to the above, the above problem such as the latest 3GPP specification cannot fulfil the above-mentioned new market requirement can be solved.

### <System Overview>

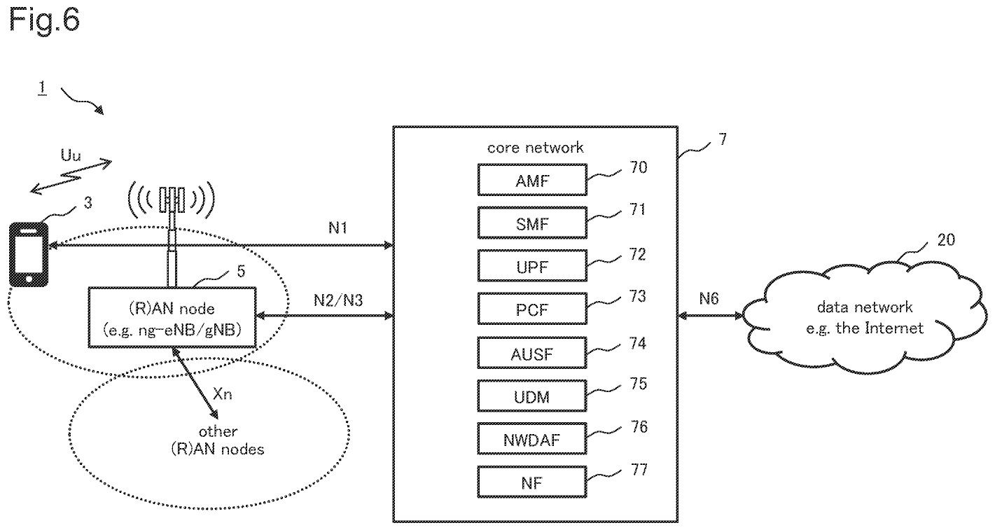

FIG. 6 schematically illustrates a telecommunication system 1 for a mobile (cellular or wireless) to which the above aspects are applicable.

The telecommunication system 1 represents a system overview in which an end to end communication is possible. For example, UE 3 (or user equipment, ‘mobile device’ 3) communicates with other UEs 3 or service servers in the data network 20 via respective (R)AN nodes 5 and a core network 7.

The (R)AN node 5 supports any radio accesses including a 5G radio access technology (RAT), an E-UTRA radio access technology, a beyond 5G RAT, a 6G RAT and non-3GPP RAT including wireless local area network (WLAN) technology as defined by the Institute of Electrical and Electronics Engineers (IEEE).

The (R)AN node 5 may split into a Radio Unit (RU), Distributed Unit (DU) and Centralized Unit (CU). In some aspects, each of the units may be connected to each other and structure the (R)AN node 5 by adopting an architecture as defined by the Open RAN (O-RAN) Alliance, where the units above are referred to as O-RU, O-DU and O-CU respectively.

The (R)AN node 5 may be split into control plane function and user plane function. Further, multiple user plane functions can be allocated to support a communication. In some aspects, user traffic may be distributed to multiple user plane functions and user traffic over each user plane functions are aggregated in both the UE 3 and the (R)AN node 5. This split architecture may be called as ‘dual connectivity’ or ‘Multi connectivity’.

The (R)AN node 5 can also support a communication using the satellite access. In some aspects, the (R)AN node 5 may support a satellite access and a terrestrial access.

In addition, the (R)AN node 5 can also be referred as an access node for a non-wireless access. The non-wireless access includes a fixed line access as defined by the Broadband Forum (BBF) and an optical access as defined by the Innovative Optical and Wireless Network (IOWN).

The core network 7 may include logical nodes (or ‘functions’) for supporting a communication in the telecommunication system 1. For example, the core network 7 may be 5G Core Network (5GC) that includes, amongst other functions, control plane functions and user plane functions. Each function in logical nodes can be considered as a network function. The network function may be provided to another node by adapting the Service Based Architecture (SBA).

A Network Function can be deployed as distributed, redundant, stateless, and scalable that provides the services from several locations and several execution instances in each location by adapting the network virtualization technology as defined by the European Telecommunications Standards Institute, Network Functions Virtualization (ETSI NFV).

The core network 7 may support the Non-Public Network (NPN). The NPN may be a Stand-alone Non-Public Network (SNPN) or a Public Network Integrated NPN (PNI-NPN).

As is well known, a UE 3 may enter and leave the areas (i.e. radio cells) served by the (R)AN node 5 as the UE 3 is moving around in the geographical area covered by the telecommunication system 1. In order to keep track of the UE 3 and to facilitate movement between the different (R)AN nodes 5, the core network 7 comprises at least one access and mobility management function (AMF) 70. The AMF 70 is in communication with the (R)AN node 5 coupled to the core network 7. In some core networks, a mobility management entity (MME) or a mobility management node for beyond 5G or a mobility management node for 6G may be used instead of the AMF 70.

The core network 7 also includes, amongst others, a Session Management Function (SMF) 71, a User Plane Function (UPF) 72, a Policy Control Function (PCF) 73, a Network Exposure Function (NEF) 74, a Unified Data Management (UDM) 75, a Network Data Analytics Function (NWDAF) 76, and a Network Function (NF) 77. When the UE 3 is roaming to a visited Public Land Mobile Network (VPLMN), a home Public Land Mobile Network (HPLMN) of the UE 3 provides the UDM 75 and at least some of the functionalities of the SMF 71, UPF 72, and PCF 73 for the roaming-out UE 3.

The UE 3 and a respective serving (R)AN node 5 are connected via an appropriate air interface (for example the so-called “Uu” interface and/or the like). Neighboring (R)AN node 5 are connected to each other via an appropriate (R)AN node 5 to (R)AN node interface (such as the so-called “Xn” interface and/or the like). Each (R)AN node 5 is also connected to nodes in the core network 7 (such as the so-called core network nodes) via an appropriate interface (such as the so-called “N2”/“N3” interface(s) and/or the like). From the core network 7, connection to a data network 20 is also provided. The data network 20 can be an internet, a public network, an external network, a private network or an internal network of the PLMN. In case that the data network 20 is provided by a PLMN operator or Mobile Virtual Network Operator (MVNO), the IP Multimedia Subsystem (IMS) service may be provided by that data network 20. The UE 3 can be connected to the data network 20 using IPv4, IPv6, IPv4v6, Ethernet or unstructured data type.

The “Uu” interface may include a Control plane of Uu interface and User plane of Uu interface.

The User plane of Uu interface is responsible to convey user traffic between the UE 3 and a serving (R)AN node 5. The User plane of Uu interface may have a layered structure with SDAP, PDCP, RLC and MAC sublayer over the physical connection.

The Control plane of Uu interface is responsible to establish, modify and release a connection between the UE 3 and a serving (R)AN node 5. The Control plane of Uu interface may have a layered structure with RRC, PDCP, RLC and MAC sublayers over the physical connection.

For example, the following messages are communicated over the RRC layer to support AS signaling.
RRC Setup Request message: This message is sent from the UE 3 to the (R)AN node 5. In addition to the parameters that are disclosed by Aspects in this disclosure, following parameters may be included together in the RRC Setup Request message.
establishmentCause and ue-Identity. The ue-Identity may have a value of ng-5G-S-TMSI-Part1 or random Value.
RRC Setup message: This message is sent from the (R)AN node 5 to the UE 3. In addition to the parameters that are disclosed by Aspects in this disclosure, following parameters may be included together in the RRC Setup message.
masterCellGroup and radioBearerConfig
RRC setup complete message: This message is sent from the UE 3 to the (R)AN node 5. In addition to the parameters that are disclosed by Aspects in this disclosure, following parameters may be included together in the RRC setup complete message.
guami-Type, iab-NodeIndication, idleMeasAvailable, mobility State, ng-5G-S-TMSI-Part2, registeredAMF, selectedPLMN-Identity

The UE 3 and the AMF 70 are connected via an appropriate interface (for example the so-called N1 interface and/or the like). The N1 interface is responsible to provide a communication between the UE 3 and the AMF 70 to support NAS signaling. The N1 interface may be established over a 3GPP access and over a non-3GPP access. For example, the following messages are communicated over the N1 interface.
registration request message: This message is sent from the UE 3 to the AMF 70. In addition to the parameters that are disclosed by Aspects in this disclosure, following parameters may be included together in the registration request message.
5GS registration type, ngKSI, 5GS mobile identity, Non-current native NAS key set identifier, 5GMM capability, UE security capability, Requested NSSAI, Last visited registered TAI, SI UE network capability, Uplink data status, PDU session status, MICO indication, UE status, Additional GUTI, Allowed PDU session status, UE's usage setting, Requested DRX parameters, EPS NAS message container, LADN indication, Payload container type, Payload container, Network slicing indication, 5GS update type, Mobile station classmark 2, Supported codecs, NAS message container, EPS bearer context status, Requested extended DRX parameters, T3324 value, UE radio capability ID, Requested mapped NSSAI, Additional information requested, Requested WUS assistance information, N5GC indication and Requested NB-N1 mode DRX parameters.
registration accept message: This message is sent from the AMF 70 to the UE 3. In addition to the parameters that are disclosed by Aspects in this disclosure, following parameters may be included together in the registration accept message.
5GS registration result, 5G-GUTI, Equivalent PLMNs, TAI list, Allowed NSSAI, Rejected NSSAI, Configured NSSAI, 5GS network feature support, PDU session status, PDU session reactivation result, PDU session reactivation result error cause, LADN information, MICO indication, Network slicing indication, Service area list, T3512 value, Non-3GPP de-registration timer value, T3502 value, Emergency number list, Extended emergency number list, SOR transparent container, EAP message, NSSAI inclusion mode, Operator-defined access category definitions, Negotiated DRX parameters, Non-3GPP NW policies, EPS bearer context status, Negotiated extended DRX parameters, T3447 value, T3448 value, T3324 value, UE radio capability ID, UE radio capability ID deletion indication, Pending NSSAI, Ciphering key data, CAG information list, Truncated 5G-S-TMSI configuration, Negotiated WUS assistance information, Negotiated NB-N1 mode DRX parameters and Extended rejected NSSAI.
Registration Complete message: This message is sent from the UE 3 to the AMF 70. In addition to the parameters that are disclosed by Aspects in this disclosure, following parameters may be included together in the Registration Complete message.
SOR transparent container.
Authentication Request message: This message is sent from the AMF 70 to the UE 3. In addition to the parameters that are disclosed by Aspects in this disclosure, following parameters may be included together in the Authentication Request message.
ngKSI, ABBA, Authentication parameter RAND (5G authentication challenge), Authentication parameter AUTN (5G authentication challenge) and EAP message.
Authentication Response message: This message is sent from the UE 3 to the AMF 70. In addition to the parameters that are disclosed by Aspects in this disclosure, following parameters may be populated together in the Authentication Response message. Authentication response message identity, Authentication response parameter and EAP message.
Authentication Result message: This message is sent from the AMF 70 to the UE 3. In addition to the parameters that are disclosed by Aspects in this disclosure, following parameters may be populated together in the Authentication Result message.
ngKSI, EAP message and ABBA.
Authentication Failure message: This message is sent from the UE 3 to the AMF 70. In addition to the parameters that are disclosed by Aspects in this disclosure, following parameters may be populated together in the Authentication Failure message.
Authentication failure message identity, 5GMM cause and Authentication failure parameter.
Authentication Reject message: This message is sent from the AMF 70 to the UE 3. In addition to the parameters that are disclosed by Aspects in this disclosure, following parameters may be populated together in the Authentication Reject message.
EAP message.
Service Request message: This message is sent from the UE 3 to the AMF 70. In addition to the parameters that are disclosed by Aspects in this disclosure, following parameters may be populated together in the Service Request message.
ngKSI, Service type, 5G-S-TMSI, Uplink data status, PDU session status, Allowed PDU session status, NAS message container.
Service Accept message: This message is sent from the AMF 70 to the UE 3. In addition to the parameters that are disclosed by Aspects in this disclosure, following parameters may be populated together in the Service Accept message.
PDU session status, PDU session reactivation result, PDU session reactivation result error cause, EAP message and T3448 value.
Service Reject message: This message is sent from the AMF 70 to the UE 3. In addition to the parameters that are disclosed by Aspects in this disclosure, following parameters may be populated together in the Service Reject message.
5GMM cause, PDU session status, T3346 value, EAP message, T3448 value and CAG information list.
Configuration Update Command message: This message is sent from the AMF 70 to the UE 3. In addition to the parameters that are disclosed by Aspects in this disclosure, following parameters may be populated together in the Configuration Update Command message.
Configuration update indication, 5G-GUTI, TAI list, Allowed NSSAI, Service area list, Full name for network, Short name for network, Local time zone, Universal time and local time zone, Network daylight saving time, LADN information, MICO indication, Network slicing indication, Configured NSSAI, Rejected NSSAI, Operator-defined access category definitions, SMS indication, T3447 value, CAG information list, UE radio capability ID, UE radio capability ID deletion indication, 5GS registration result, Truncated 5G-S-TMSI configuration, Additional configuration indication and Extended rejected NSSAI.
Configuration Update Complete message: This message is sent from the UE 3 to the AMF 70. In addition to the parameters that are disclosed by Aspects in this disclosure, following parameters may be populated together in the Configuration Update Complete message.
Configuration update complete message identity.

### <User Equipment (UE)>

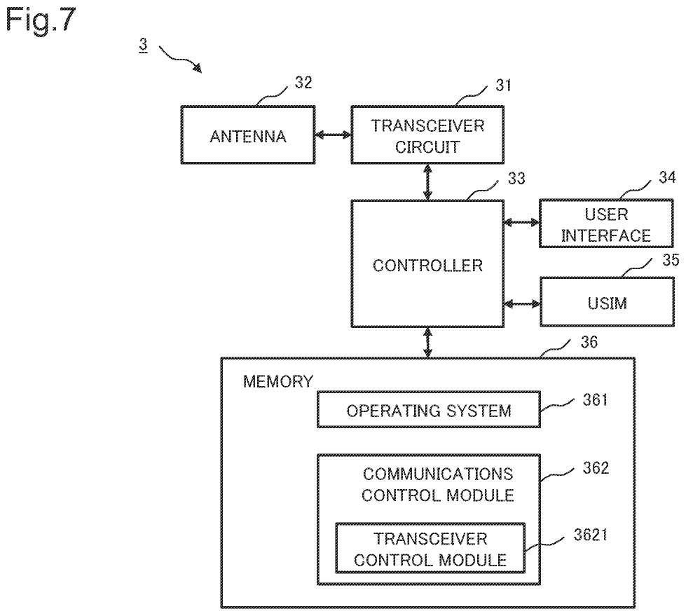

FIG. 7 is a block diagram illustrating the main components of the UE 3 (mobile device 3). As shown, the UE 3 includes a transceiver circuit 31 which is operable to transmit signals to and to receive signals from the connected node(s) via one or more antennas 32. Further, the UE 3 may include a user interface 34 for inputting information from outside or outputting information to outside. Although not necessarily shown in the Figure, the UE 3 may have all the usual functionality of a conventional mobile device and this may be provided by any one or any combination of hardware, software and firmware, as appropriate. Software may be pre-installed in the memory and/or may be downloaded via the telecommunication network or from a removable data storage device (RMD), for example. A controller 33 controls the operation of the UE 3 in accordance with software stored in a memory 36. The software includes, among other things, an operating system 361 and a communications control module 362 having at least a transceiver control module 3621. The communications control module 362 (using its transceiver control module 3621) is responsible for handling (generating/sending/receiving) signalling and uplink/downlink data packets between the UE 3 and other nodes, such as the (R)AN node 5 and the AMF 70. Such signalling may include, for example, appropriately formatted signalling messages (e.g. a registration request message and associated response messages) relating to access and mobility management procedures (for the UE 3). The controller 33 interworks with one or more Universal Subscriber Identity Module (USIM) 35. If there are multiple USIMs 35 equipped, the controller 33 may activate only one USIM 35 or may activate multiple USIMs 35 at the same time.

The UE 3 may, for example, support the Non-Public Network (NPN), The NPN may be a Stand-alone Non-Public Network (SNPN) or a Public Network Integrated NPN (PNI-NPN).

The UE 3 may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans: blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

The UE 3 may, for example, be an item of transport equipment (for example transport equipment such as: rolling stocks; motor vehicles; motor cycles; bicycles; trains; buses; carts; rickshaws; ships and other watercraft; aircraft; rockets; satellites; drones; balloons etc.).

The UE 3 may, for example, be an item of information and communication equipment (for example information and communication equipment such as: electronic computer and related equipment; communication and related equipment; electronic components etc.).

The UE 3 may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

The UE 3 may, for example, be an electrical application system or equipment (for example an electrical application system or equipment such as: an x-ray system; a particle accelerator; radio isotope equipment; sonic equipment; electromagnetic application equipment; electronic power application equipment etc.).

The UE 3 may, for example, be an electronic lamp, a luminaire, a measuring instrument, an analyzer, a tester, or a surveying or sensing instrument (for example a surveying or sensing instrument such as: a smoke alarm: a human alarm sensor: a motion sensor: a wireless tag etc.), a watch or clock, a laboratory instrument, optical apparatus, medical equipment and/or system, a weapon, an item of cutlery, a hand tool, or the like.

The UE 3 may, for example, be a wireless-equipped personal digital assistant or related equipment (such as a wireless card or module designed for attachment to or for insertion into another electronic device (for example a personal computer, electrical measuring machine)).

The UE 3 may be a device or a part of a system that provides applications, services, and solutions described below, as to “internet of things (IoT)”, using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices or Narrow Band-IoT UE (NB-IoT UE). It will be appreciated that a UE 3 may support one or more IoT or MTC applications.

The UE 3 may be a smart phone or a wearable device (e.g. smart glasses, a smart watch, a smart ring, or a hearable device).

The UE 3 may be a car, or a connected car, or an autonomous car, or a vehicle device, or a motorcycle or V2X (Vehicle to Everything) communication module (e.g. Vehicle to Vehicle communication module, Vehicle to Infrastructure communication module, Vehicle to People communication module and Vehicle to Network communication module).

### <(R)AN Node>

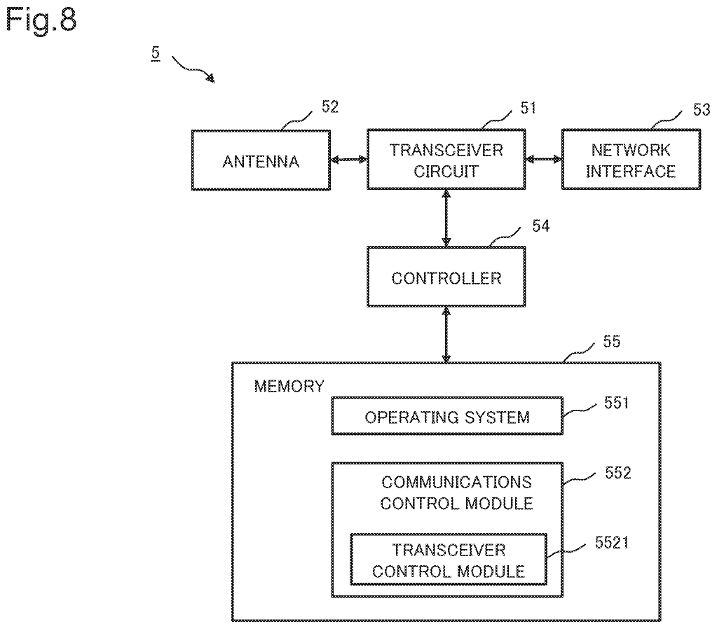

FIG. 8 is a block diagram illustrating the main components of an exemplary (R)AN node 5, for example a base station (′eNB′ in LTE, ‘gNB’ in 5G, a base station for 5G beyond, a base station for 6G). As shown, the (R)AN node 5 includes a transceiver circuit 51 which is operable to transmit signals to and to receive signals from connected UE(s) 3 via one or more antennas 52 and to transmit signals to and to receive signals from other network nodes (either directly or indirectly) via a network interface 53. A controller 54 controls the operation of the (R)AN node 5 in accordance with software stored in a memory 55. Software may be pre-installed in the memory and/or may be downloaded via the telecommunication network or from a removable data storage device (RMD), for example. The software includes, among other things, an operating system 551 and a communications control module 552 having at least a transceiver control module 5521.

The communications control module 552 (using its transceiver control sub-module) is responsible for handling (generating/sending/receiving) signalling between the (R)AN node 5 and other nodes, such as the UE 3, another (R)AN node 5, the AMF 70 and the UPF 72 (e.g. directly or indirectly). The signalling may include, for example, appropriately formatted signalling messages relating to a radio connection and a connection with the core network 7 (for a particular UE 3), and in particular, relating to connection establishment and maintenance (e.g. RRC connection establishment and other RRC messages), NG Application Protocol (NGAP) messages (i.e. messages by N2 reference point) and Xn application protocol (XnAP) messages (i.e. messages by Xn reference point), etc. Such signalling may also include, for example, broadcast information (e.g. Master Information and System information) in a sending case.

The controller 54 is also configured (by software or hardware) to handle related tasks such as, when implemented, UE mobility estimate and/or moving trajectory estimation.

The (R)AN node 5 may support the Non-Public Network (NPN), The NPN may be a Stand-alone Non-Public Network (SNPN) or a Public Network Integrated NPN (PNI-NPN).

### <System Overview of (R)AN Node 5 Based on O-RAN Architecture>

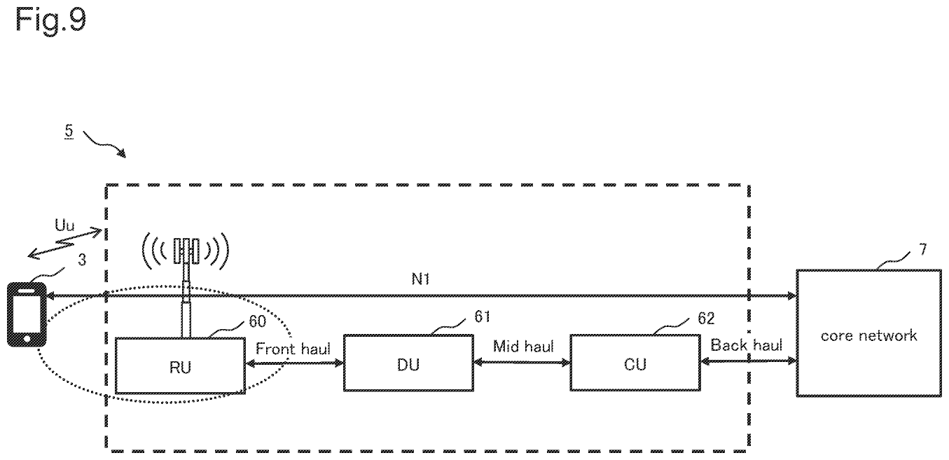

FIG. 9 schematically illustrates a (R)AN node 5 based on O-RAN architecture to which the (R)AN node 5 aspects are applicable.

The (R)AN node 5 based on O-RAN architecture represents a system overview in which the (R)AN node is split into a Radio Unit (RU) 60, Distributed Unit (DU) 61 and Centralized Unit (CU) 62. In some aspects, each unit may be combined. For example, the RU 60 can be integrated/combined with the DU 61 as an integrated/combined unit, the DU 61 can be integrated/combined with the CU 62 as another integrated/combined unit. Any functionality in the description for a unit (e.g. one of RU 60, DU 61 and CU 62) can be implemented in the integrated/combined unit above. Further, CU 62 can separate into two functional units such as CU Control plane (CP) and CU User plane (UP). The CU CP has a control plane functionality in the (R)AN node 5. The CU UP has a user plane functionality in the (R)AN node 5. Each CU CP is connected to the CU UP via an appropriate interface (such as the so-called “E1” interface and/or the like).

The UE 3 and a respective serving RU 60 are connected via an appropriate air interface (for example the so-called “Uu” interface and/or the like). Each RU 60 is connected to the DU 61 via an appropriate interface (such as the so-called “Front haul”, “Open Front haul”, “F1” interface and/or the like). Each DU 61 is connected to the CU 62 via an appropriate interface (such as the so-called “Mid haul”, “Open Mid haul”, “E2” interface and/or the like). Each CU 62 is also connected to nodes in the core network 7 (such as the so-called core network nodes) via an appropriate interface (such as the so-called “Back haul”, “Open Back haul”, “N2”/“N3” interface(s) and/or the like). In addition, a user plane part of the DU 61 can also be connected to the core network nodes 7 via an appropriate interface (such as the so-called “N3” interface(s) and/or the like).

Depending on functionality split among the RU 60, DU 61 and CU 62, each unit provides some of the functionality that is provided by the (R)AN node 5. For example, the RU 60 may provide functionalities to communicate with a UE 3 over air interface, the DU 61 may provide functionalities to support MAC layer and RLC layer, the CU 62 may provide functionalities to support PDCP layer, SDAP layer and RRC layer.

### <Radio Unit (RU)>

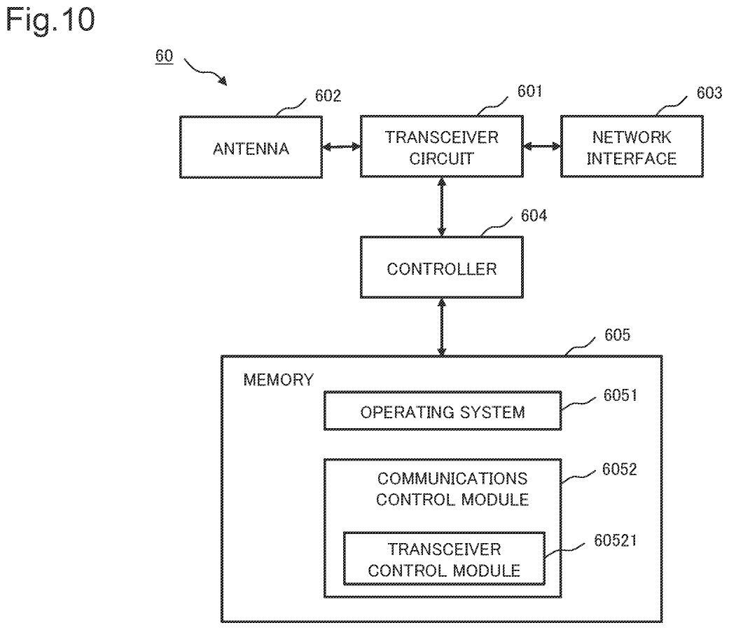

FIG. 10 is a block diagram illustrating the main components of an exemplary RU 60, for example a RU part of base station (′eNB′ in LTE, ‘gNB’ in 5G, a base station for 5G beyond, a base station for 6G). As shown, the RU 60 includes a transceiver circuit 601 which is operable to transmit signals to and to receive signals from connected UE(s) 3 via one or more antennas 602 and to transmit signals to and to receive signals from other network nodes or network unit (either directly or indirectly) via a network interface 603. A controller 604 controls the operation of the RU 60 in accordance with software stored in a memory 605. Software may be pre-installed in the memory and/or may be downloaded via the telecommunication network or from a removable data storage device (RMD), for example. The software includes, among other things, an operating system 6051 and a communications control module 6052 having at least a transceiver control module 60521.

The communications control module 6052 (using its transceiver control sub-module) is responsible for handling (generating/sending/receiving) signalling between the RU 60 and other nodes or units, such as the UE 3, another RU 60 and DU 61 (e.g. directly or indirectly). The signalling may include, for example, appropriately formatted signalling messages relating to a radio connection and a connection with the RU 60 (for a particular UE 3), and in particular, relating to MAC layer and RLC layer.

The controller 604 is also configured (by software or hardware) to handle related tasks such as, when implemented, UE mobility estimate and/or moving trajectory estimation.

The RU 60 may support the Non-Public Network (NPN), The NPN may be a Stand-alone Non-Public Network (SNPN) or a Public Network Integrated NPN (PNI-NPN).

As described above, the RU 60 can be integrated/combined with the DU 61 as an integrated/combined unit. Any functionality in the description for the RU 60 can be implemented in the integrated/combined unit above.

### <Distributed Unit (DU)>

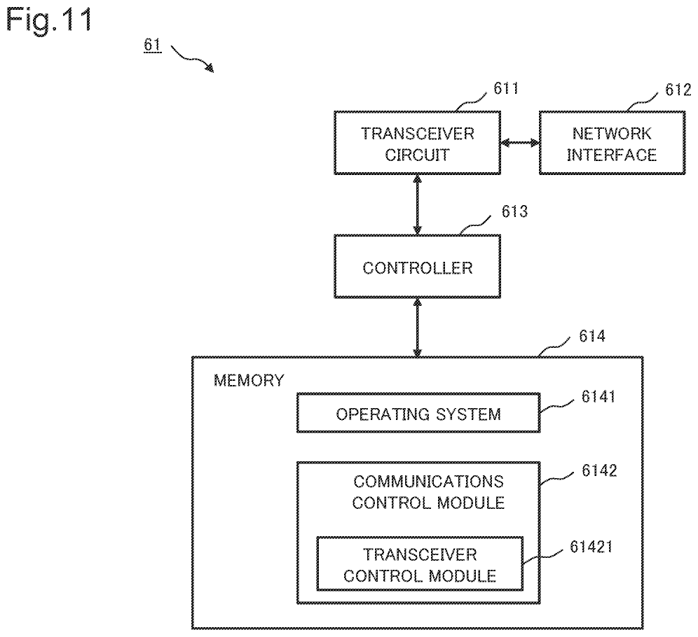

FIG. 11 is a block diagram illustrating the main components of an exemplary DU 61, for example a DU part of a base station (′eNB′ in LTE, ‘gNB’ in 5G, a base station for 5G beyond, a base station for 6G). As shown, the apparatus includes a transceiver circuit 611 which is operable to transmit signals to and to receive signals from other nodes or units (including the RU 60) via a network interface 612. A controller 613 controls the operation of the DU 61 in accordance with software stored in a memory 614. Software may be pre-installed in the memory 614 and/or may be downloaded via the telecommunication network or from a removable data storage device (RMD), for example. The software includes, among other things, an operating system 6141 and a communications control module 6142 having at least a transceiver control module 61421. The communications control module 6142 (using its transceiver control module 61421 is responsible for handling (generating/sending/receiving) signalling between the DU 61 and other nodes or units, such as the RU 60 and other nodes and units.

The DU 61 may support the Non-Public Network (NPN), The NPN may be a Stand-alone Non-Public Network (SNPN) or a Public Network Integrated NPN (PNI-NPN).

As described above, the RU 60 can be integrated/combined with the DU 61 or CU 62 as an integrated/combined unit. Any functionality in the description for DU 61 can be implemented in one of the integrated/combined unit above.

### <Centralized Unit (CU)>

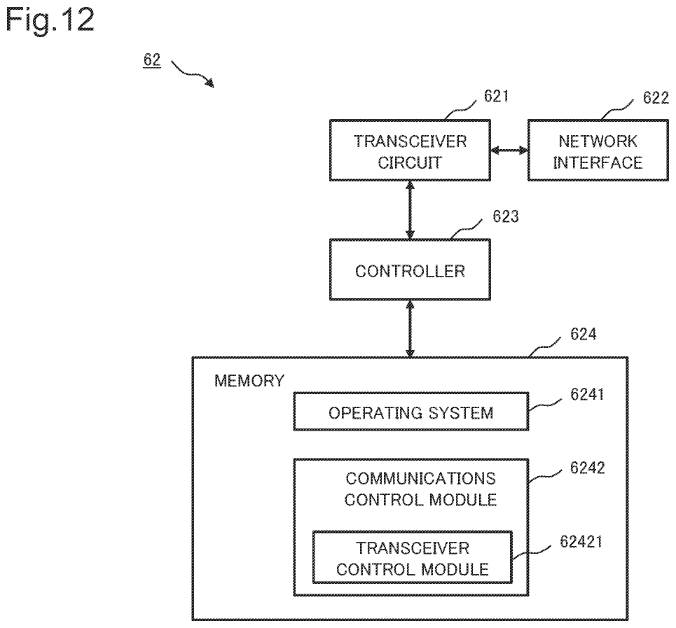

FIG. 12 is a block diagram illustrating the main components of an exemplary CU 62, for example a CU part of base station (′eNB′ in LTE, ‘gNB’ in 5G, a base station for 5G beyond, a base station for 6G). As shown, the apparatus includes a transceiver circuit 621 which is operable to transmit signals to and to receive signals from other nodes or units (including the DU 61) via a network interface 622. A controller 623 controls the operation of the CU 62 in accordance with software stored in a memory 624. Software may be pre-installed in the memory 624 and/or may be downloaded via the telecommunication network or from a removable data storage device (RMD), for example. The software includes, among other things, an operating system 6241 and a communications control module 6242 having at least a transceiver control module 62421. The communications control module 6242 (using its transceiver control module 62421 is responsible for handling (generating/sending/receiving) signalling between the CU 62 and other nodes or units, such as the DU 61 and other nodes and units.

The CU 62 may support the Non-Public Network (NPN), The NPN may be a Stand-alone Non-Public Network (SNPN) or a Public Network Integrated NPN (PNI-NPN).

As described above, the CU 62 can be integrated/combined with the DU 61 as an integrated/combined unit. Any functionality in the description for the CU 62 can be implemented in the integrated/combined unit above.

### <AMF>

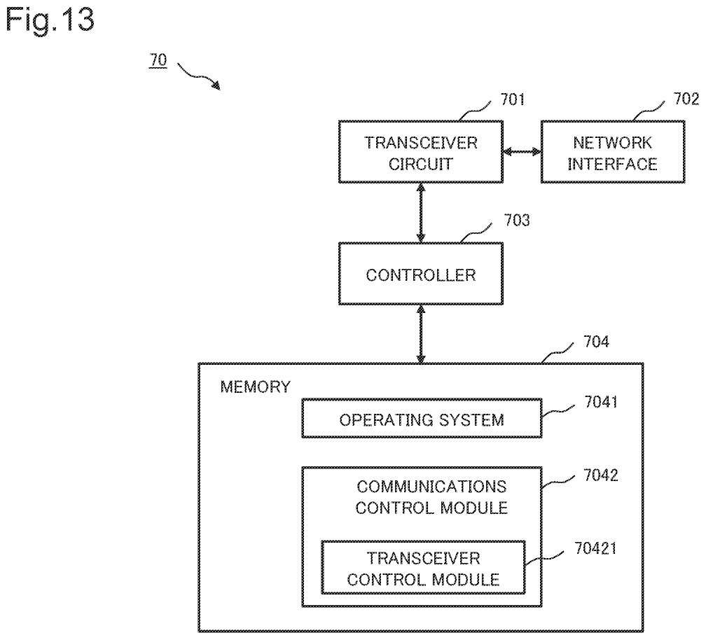

FIG. 13 is a block diagram illustrating the main components of the AMF 70. As shown, the apparatus includes a transceiver circuit 701 which is operable to transmit signals to and to receive signals from other nodes (including the UE 3) via a network interface 702. A controller 703 controls the operation of the AMF 70 in accordance with software stored in a memory 704. Software may be pre-installed in the memory 704 and/or may be downloaded via the telecommunication network or from a removable data storage device (RMD), for example. The software includes, among other things, an operating system 7041 and a communications control module 7042 having at least a transceiver control module 70421. The communications control module 7042 (using its transceiver control module 70421 is responsible for handling (generating/sending/receiving) signalling between the AMF 70 and other nodes, such as the UE 3 (e.g. via the (R)AN node 5) and other core network nodes (including core network nodes in the HPLMN of the UE 3 when the UE 3 is roaming-in. Such signalling may include, for example, appropriately formatted signalling messages (e.g. a registration request message and associated response messages) relating to access and mobility management procedures (for the UE 3).

The AMF 70 may support the Non-Public Network (NPN), The NPN may be a Stand-alone Non-Public Network (SNPN) or a Public Network Integrated NPN (PNI-NPN).

### <UDM>

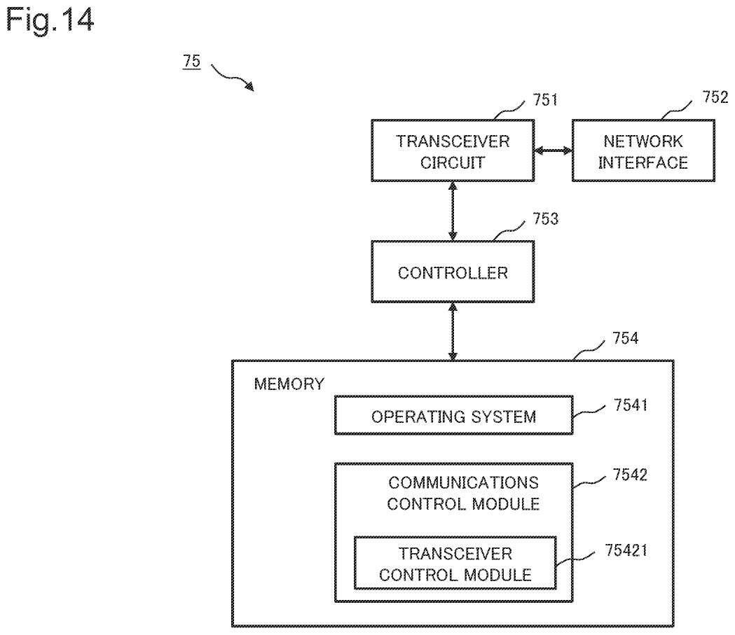

FIG. 14 is a block diagram illustrating the main components of the UDM 75. As shown, the apparatus includes a transceiver circuit 751 which is operable to transmit signals to and to receive signals from other nodes (including the AMF 70) via a network interface 752. A controller 753 controls the operation of the UDM 75 in accordance with software stored in a memory 754. Software may be pre-installed in the memory 754 and/or may be downloaded via the telecommunication network or from a removable data storage device (RMD), for example. The software includes, among other things, an operating system 7541 and a communications control module 7542 having at least a transceiver control module 75421. The communications control module 7542 (using its transceiver control module 75421 is responsible for handling (generating/sending/receiving) signalling between the UDM 75 and other nodes, such as the AMF 70 and other core network nodes (including core network nodes in the VPLMN of the UE 3 when the UE 3 is roaming-out. Such signalling may include, for example, appropriately formatted signalling messages (e.g. a HTTP restful methods based on the service based interfaces) relating to mobility management procedures (for the UE 3).

The UDM 75 may support the Non-Public Network (NPN), The NPN may be a Stand-alone Non-Public Network (SNPN) or a Public Network Integrated NPN (PNI-NPN).

### <NF>

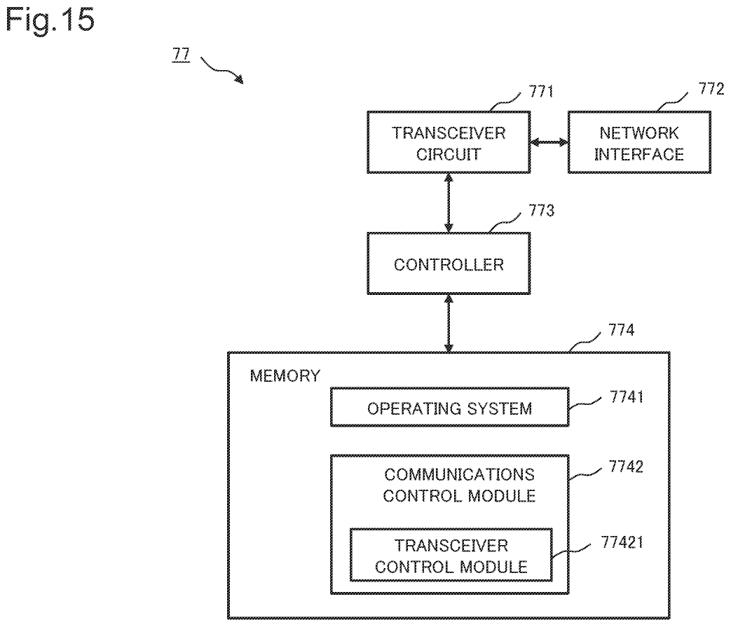

FIG. 15 is a block diagram illustrating the main components of the NF 77. As shown, the apparatus includes a transceiver circuit 771 which is operable to transmit signals to and to receive signals from other nodes (including the AMF 70) via a network interface 772. A controller 773 controls the operation of the NF 77 in accordance with software stored in a memory 774. Software may be pre-installed in the memory 774 and/or may be downloaded via the telecommunication network or from a removable data storage device (RMD), for example. The software includes, among other things, an operating system 7741 and a communications control module 7742 having at least a transceiver control module 77421. The communications control module 7742 (using its transceiver control module 77421 is responsible for handling (generating/sending/receiving) signalling between the NF 77 and other nodes, such as the AMF 70 and other core network nodes (including core network nodes in the VPLMN of the UE 3 when the UE 3 is roaming-out. Such signalling may include, for example, appropriately formatted signalling messages (e.g. a HTTP restful methods based on the service based interfaces) relating to mobility management procedures (for the UE 3).

The NF 77 may support the Non-Public Network (NPN), The NPN may be a Stand-alone Non-Public Network (SNPN) or a Public Network Integrated NPN (PNI-NPN). The NF 77 may be one of NFs defined in section 4.2.2 in NPL 2

The whole or part of the example Aspects disclosed above can be described as, but not limited to, the following.

### 4.2.2.2.2 General Registration

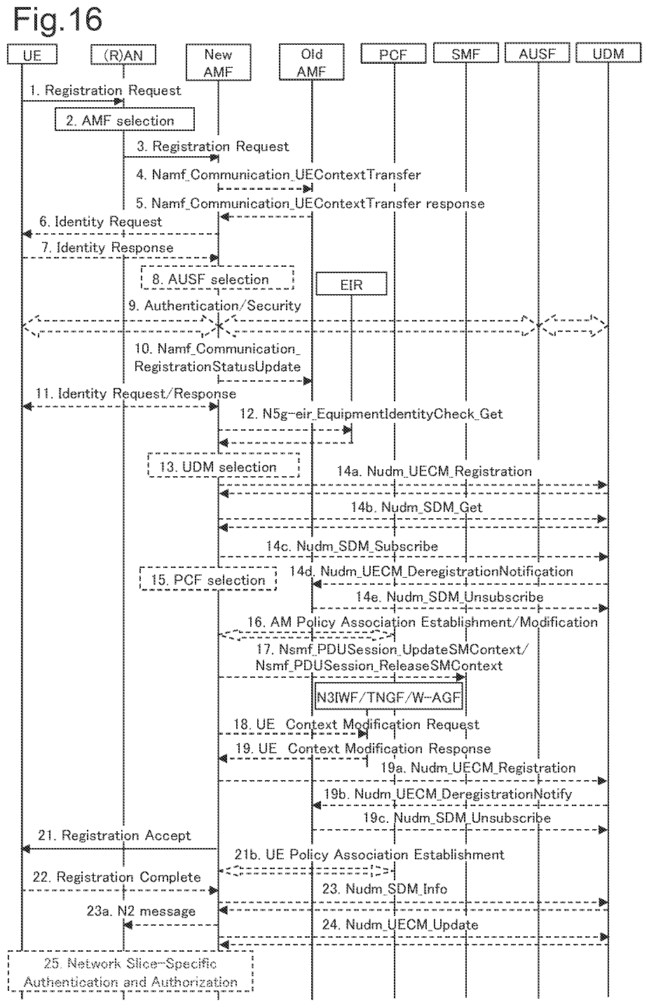

FIG. 4.2.2.2.2-1: Registration procedure (See FIG. 16.)

1. UE to (R)AN: AN message (AN parameters, Registration Request (Registration type, SUCI or 5G-GUTI or PEI, [last visited TAI (if available)], Security parameters, [Requested NSSAI], [Mapping Of Requested NSSAI], [Default Configured NSSAI Indication], [UE Radio Capability Update], [UE MM Core Network Capability], [PDU Session status], [List Of PDU Sessions To Be Activated], [Follow-on request], [MICO mode preference], [Requested Active Time], [Requested DRX parameters for E-UTRA and NR], [Requested DRX parameters for NB-IoT], [extended idle mode DRX parameters], [LADN DNN(s) or Indicator Of Requesting LADN Information], [NAS message container], [Support for restriction of use of Enhanced Coverage], [Preferred Network Behaviour], [UE paging probability information], [UE Policy Container (the list of PSIs, indication of UE support for ANDSP and the operating system identifier)] and [UE Radio Capability ID], [Release Request indication], [Paging Restriction Information], PEI, [NSSRG handling support indication], [PLMN with Disaster Condition] the limited slice support indicator)).

NOTE 1: The UE Policy Container and its usage is defined in TS 23.503 [20].

In the case of NG-RAN, the AN parameters include e.g. 5G-S-TMSI or GUAMI, the Selected PLMN ID (or PLMN ID and NID, see clause 5.30 of TS 23.501 [2]) and NSSAI information, the AN parameters also include Establishment cause. The Establishment cause provides the reason for requesting the establishment of an RRC connection. Whether and how the UE includes the NSSAI information as part of the AN parameters is dependent on the value of the Access Stratum Connection Establishment NSSAI Inclusion Mode parameter, as specified in clause 5.15.9 of TS 23.501 [2].

The limited slice support indicator indicates that the UE 3 supports S-NSSAI with at least one of deployment area and validity time attribution. For example, the limited slice support indicator may indicate that the UE 3 supports S-NSSAI with at least one of deployment area and validity time.

The AN parameters shall also include an IAB-Indication if the UE is an IAB-node accessing 5GS.

The Registration type indicates if the UE wants to perform an Initial Registration (i.e. the UE is in RM-DEREGISTERED state), a Mobility Registration Update (i.e. the UE is in RM-REGISTERED state and initiates a Registration procedure due to mobility or due to the UE needs to update its capabilities or protocol parameters, or to request a change of the set of network slices it is allowed to use), a Periodic Registration Update (i.e. the UE is in RM-REGISTERED state and initiates a Registration procedure due to the Periodic Registration Update timer expiry, see clause 4.2.2.2.1), an Emergency Registration (i.e. the UE is in limited service state), or a Disaster Roaming Registration.

When the UE is using E-UTRA, the UE indicates its support of CIoT 5GS Optimisations, which is relevant for the AMF selection, in the RRC connection establishment signalling associated with the Registration Request.

When the UE is performing an Initial Registration or a Disaster Roaming Registration the UE shall indicate its UE identity in the Registration Request message as follows, listed in decreasing order of preference in the case of registration with a PLMN:
i) a 5G-GUTI mapped from an EPS GUTI, if the UE has a valid EPS GUTI.
ii) a native 5G-GUTI assigned by the PLMN to which the UE is attempting to register, if available;
iii) a native 5G-GUTI assigned by an equivalent PLMN to the PLMN to which the UE is attempting to register, if available;
iv) a native 5G-GUTI assigned by any other PLMN, if available.

NOTE 2: This can also be a 5G-GUTIs assigned via another access type.
v) Otherwise, the UE shall include its SUCI in the Registration Request as defined in TS 33.501 [15].

If the UE is registering with an SNPN, when the UE is performing an Initial Registration the UE shall indicate its UE identity in the Registration Request message as follows, listed in decreasing order of preference:
i) a native 5G-GUTI assigned by the same SNPN to which the UE is attempting to register, if available;
ii) a native 5G-GUTI assigned by any other SNPN along with the NID of the SNPN that assigned the 5G-GUTI, if available;
iii) Otherwise, the UE shall include its SUCI in the Registration Request as defined in TS 33.501 [15].

When the UE performing an Initial Registration has both a valid EPS GUTI and a native 5G-GUTI, the UE shall also indicate the native 5G-GUTI as Additional GUTI. If more than one native 5G-GUTIs are available, the UE shall select the 5G-GUTI in decreasing order of preference among items (ii)-(iv) in the list above.

The NAS message container shall be included if the UE is sending a Registration Request message as an Initial NAS message and the UE has a valid 5G NAS security context and the UE needs to send non-cleartext IEs, see clause 4.4.6 in TS 24.501 [25]. If the UE does not need to send non-cleartext IEs, the UE shall send a Registration Request message without including the NAS message container.

If the UE does not have a valid 5G NAS security context, the UE shall send the Registration Request message without including the NAS message container. The UE shall include the entire Registration Request message (i.e. containing cleartext IEs and non-cleartext IEs) in the NAS message container that is sent as part of the Security Mode Complete message in step 9b.

When the UE is performing an Initial Registration (i.e., the UE is in RM-DEREGISTERED state) with a native 5G-GUTI then the UE shall indicate the related GUAMI information in the AN parameters. When the UE is performing an Initial Registration with its SUCI, the UE shall not indicate any GUAMI information in the AN parameters.

When the UE is performing an Initial Registration or a Mobility Registration and if CIoT 5GS Optimisations are supported the UE shall indicate its Preferred Network Behaviour (see clause 5.31.2 of TS 23.501 [2]). If SI mode is supported the UE's EPC Preferred Network Behaviour is included in the SI UE network capabilities in the Registration Request message, see clause 8.2.6.1 of TS 24.501 [25].

For an Emergency Registration, the SUCI shall be included if the UE does not have a valid 5G-GUTI available: the PEI shall be included when the UE has no SUPI and no valid 5G-GUTI. In other cases, the 5G-GUTI is included and it indicates the last serving AMF.

The UE may provide the UE's usage setting based on its configuration as defined in clause 5.16.3.7 of TS 23.501 [2]. The UE provides Requested NSSAI (as described in clause 5.15.5.2.1 of TS 23.501 [2] and, if the UE supports the subscription-based restrictions to simultaneous registration of network slices, also taking into account the NSSRG Information constraints as described in clause 5.15.12 of TS 23.501 [2] and, in the case of Initial Registration or Mobility Registration Update, the UE includes the Mapping Of Requested NSSAI (if available), which is the mapping of each S-NSSAI of the Requested NSSAI to the HPLMN S-NSSAIS, to ensure that the network is able to verify whether the S-NSSAI(s) in the Requested NSSAI are permitted based on the Subscribed S-NSSAIs. In the case of inter PLMN mobility, if the serving PLMN S-NSSAI(s) corresponding to the established PDU Session(s) are not present in the UE, the associated HPLMN S-NSSAI(s) associated with the established PDU Session(s) shall be provided in the Mapping Of Requested NSSAI as described in clause 5.15.5.2.1 TS 23.501 [2].

The UE includes the Default Configured NSSAI Indication if the UE is using a Default Configured NSSAI, as defined in TS 23.501 [2].

The UE may include UE paging probability information if it supports the assignment of WUS Assistance Information from the AMF (see TS 23.501 [2]).

In the case of Mobility Registration Update, the UE includes in the List Of PDU Sessions To Be Activated the PDU Sessions for which there are pending uplink data. When the UE includes the List Of PDU Sessions To Be Activated, the UE shall indicate PDU Sessions only associated with the access the Registration Request is related to. As defined in TS 24.501 the UE shall include always-on PDU Sessions which are accepted by the network in the List Of PDU Sessions To Be Activated even if there are no pending uplink data for those PDU Sessions.

NOTE 3: A PDU Session corresponding to a LADN is not included in the List Of PDU Sessions To Be Activated when the UE is outside the area of availability of the LADN.

The UE MM Core Network Capability is provided by the UE and handled by AMF as defined in clause 5.4.4a of TS 23.501 [2]. The UE includes in the UE MM Core Network Capability an indication if it supports Request Type flag “handover” for PDN connectivity request during the attach procedure as defined in clause 5.17.2.3.1 of TS 23.501 [2]. If the UE supports ‘Strictly Periodic Registration Timer Indication’, the UE indicates its capability of ‘Strictly Periodic Registration Timer Indication’ in the UE MM Core Network Capability. If the UE supports CAG, the UE indicates its capability of “CAG supported” in the UE MM Core Network Capability. If the UE operating two or more USIMs, supports and intends to use one or more Multi-USIM feature(s), the UE indicates one or more Multi-USIM specific features described in clause 5.38 of TS 23.501 [2] in the UE MM Core Network Capability.

The UE may provide either the LADN DNN(s) or an Indication Of Requesting LADN Information as described in clause 5.6.5 of TS 23.501 [2].

If available, the last visited TAI shall be included in order to help the AMF produce Registration Area for the UE.

The Security parameters are used for Authentication and integrity protection, see TS 33.501 [15]. Requested NSSAI indicates the Network Slice Selection Assistance Information (as defined in clause 5.15 of TS 23.501 [2]). The PDU Session status indicates the previously established PDU Sessions in the UE. When the UE is connected to the two AMFs belonging to different PLMN via 3GPP access and non-3GPP access then the PDU Session status indicates the established PDU Session of the current PLMN in the UE.

The Follow-on request is included when the UE has pending uplink signalling and the UE doesn't include List Of PDU Sessions To Be Activated, or the Registration type indicates the UE wants to perform an Emergency Registration. In Initial Registration and Mobility Registration Update, UE provides the UE Requested DRX parameters, as defined in clause 5.4.5 of TS 23.501 [2]. The UE may provide the extended idle mode DRX parameters as defined in clause 5.31.7.2 of TS 23.501 [2] to request extended idle mode DRX.

The UE provides UE Radio Capability Update indication as described in TS 23.501 [2].

The UE includes the MICO mode preference and optionally a Requested Active Time value if the UE wants to use MICO Mode with Active Time.

The UE may indicate its Service Gap Control Capability in the UE MM Core Network Capability, see clause 5.31.16 of TS 23.501 [2].

For a UE with a running Service Gap timer in the UE, the UE shall not set Follow-on Request indication or Uplink data status in the Registration Request message (see clause 5.31.16 of TS 23.501 [2]), except for network access for regulatory prioritized services like Emergency services or exception reporting.

If UE supports RACS and has been assigned UE Radio Capability ID(s), the UE shall indicate a UE Radio Capability ID as defined in clause 5.4.4.1a of TS 23.501 [2] as non-cleartext IE. The PEI may be retrieved in initial registration from the UE as described in clause 4.2.2.2.1.

If a UE supports the subscription-based restrictions to simultaneous registration of network slices feature, it includes the NSSRG handling support indication according to clause 5.15.12 of TS 23.501 [2]. The AMF stores whether the UE supports this feature in the UE context.

When a UE in MUSIM mode wants to enter CM-IDLE state immediately e.g. after having performed mobility or periodic registration, it includes the Release Request indication and optionally provides Paging Restriction Information.

When the UE is performing a Disaster Roaming Registration, the UE may indicate the PLMN with Disaster Condition if UE does not have valid 5G-GUTI indicating the PLMN with Disaster Condition and the PLMN with Disaster Condition is not the HPLMN of the UE or the PLMN with Disaster Condition is the HPLMN of the UE but the UE does not provide its SUCI.

2. If a 5G-S-TMSI or GUAMI is not included or the 5G-S-TMSI or GUAMI does not indicate a valid AMF the (R)AN, based on (R)AT and Requested NSSAI, if available, selects an AMF

The (R)AN selects an AMF as described in clause 6.3.5 of TS 23.501 [2]. If UE is in CM-CONNECTED state, the (R)AN can forward the Registration Request message to the AMF based on the N2 connection of the UE.

If the (R)AN cannot select an appropriate AMF, it forwards the Registration Request to an AMF which has been configured, in (R)AN, to perform AMF selection.

3. (R)AN to new AMF: N2 message (N2 parameters, Registration Request (as described in step 1) and [LTE-M Indication].

When NG-RAN is used, the N2 parameters include the Selected PLMN ID (or PLMN ID and NID, see clause 5.30 of TS 23.501 [2]), Location Information and Cell Identity related to the cell in which the UE is camping, UE Context Request which indicates that a UE context including security information needs to be setup at the NG-RAN.

When NG-RAN is used, the N2 parameters shall also include the Establishment cause and IAB-Indication if the indication is received in AN parameters in step 1.

Mapping Of Requested NSSAI is provided only if available.

If the Registration type indicated by the UE is Periodic Registration Update, then steps 4 to 19 may be omitted.

When the Establishment cause is associated with priority services (e.g. MPS, MCS), the AMF includes a Message Priority header to indicate priority information. Other NFs relay the priority information by including the Message Priority header in service-based interfaces, as specified in TS 29.500 [17].

The RAT Type the UE is using is determined (see clause 4.2.2.2.1) and based on it the AMF determines whether the UE is performing Inter-RAT mobility to or from NB-IoT. If the AMF receives the LTE M indication, then it considers that the RAT Type is LTE-M and stores the LTE-M Indication in UE Context.

If a UE includes a Preferred Network Behaviour, this defines the Network Behaviour the UE supports and is expecting to be available in the network as defined in clause 5.31.2 of TS 23.501 [2].

If the UE has included the Preferred Network Behaviour, and what the UE indicated it supports in Preferred Network Behaviour is incompatible with the network support, the AMF shall reject the Registration Request with an appropriate cause value (e.g. one that avoids retries on this PLMN).

If there is a Service Gap timer running in the UE Context in AMF for the UE, and Follow-on Request indication or Uplink data status is included in the Registration Request message, the AMF shall ignore the Follow-on Request indication and Uplink data status and not perform any of the actions related to the status.

If the UE has included a UE Radio Capability ID in step 1 and the AMF supports RACS, the AMF stores the Radio Capability ID in UE context.

For NR satellite access, if the AMF can determine based on the Selected PLMN ID and ULI (including Cell ID) received from the gNB that the UE is attempting to register to a PLMN that is not allowed to operate at the present UE location, then the AMF should reject the Registration Request indicating a suitable Cause value and, if known in AMF, the country of the UE location. Otherwise, e.g. if the AMF is not aware of the UE location with sufficient accuracy to make a final decision, the AMF proceeds with the Registration procedure and may initiate UE location procedure as specified in clause 6.10.1 of TS 23.273 and be prepared to deregister the UE if the information received from LMF proves that the UE is registered to a PLMN that is not allowed to operate in the UE location.

NOTE 4: The location information cannot be guaranteed to be sufficiently accurate for the AMF to determine in all cases the country where UE is located.

NOTE 5: Some countries use multiple MCCs and some MCCs, such as 901, can be allowed in multiple countries and therefore the UE can register in a PLMN with MCC different from the one returned to the UE.

Upon receiving a Registration Reject with the country in which the UE is located, the UE shall attempt to register to a PLMN that is allowed to operate at the UE location as specified in TS 23.122 [22].

For a Disaster Roaming Registration, based on the ULI (including Cell ID) received from the NG-RAN, the PLMN with Disaster Condition derived from the UE's 5G-GUTI, derived from the UE's SUCI or indicated by the UE and the local configuration, the AMF determines if Disaster Roaming service can be provided. If the current location is not subject to Disaster Roaming service or the Disaster Roaming service is not provided to the PLMN with Disaster Condition derived from the UE's 5G-GUTI, derived from the UE's SUCI or indicated by UE, then the AMF should reject the Registration Request indicating a suitable Cause value.

4. [Conditional] new AMF to old AMF: Namf_Communication_UEContextTransfer (complete Registration Request) or new AMF to UDSF: Nudsf_Unstructured Data Management_Query( ).

The new AMF determines the old AMF using the UE's 5G-GUTI. If the new AMF received an NID in the Registration request, it determines that the 5G-GUTI was assigned by an SNPN and determines the old AMF using the 5G-GUTI and NID of the SNPN.

(With UDSF Deployment): If the UE's 5G-GUTI was included in the Registration Request and the serving AMF has changed since last Registration procedure, new AMF and old AMF are in the same AMF Set and UDSF is deployed, the new AMF retrieves the stored UE's SUPI and UE context directly from the UDSF using Nudsf_UnstructuredDataManagement_Query service operation or they can share stored UE context via implementation specific means if UDSF is not deployed. This includes also event subscription information by each NF consumer for the given UE. In this case, the new AMF uses integrity protected complete Registration request NAS message to perform and verify integrity protection.

(Without UDSF Deployment): If the UE's 5G-GUTI was included in the Registration Request and the serving AMF has changed since last Registration procedure, the new AMF may invoke the Namf_Communication_UEContextTransfer service operation on the old AMF including the complete Registration Request NAS message, which may be integrity protected, as well as the Access Type, to request the UE's SUPI and UE Context. See clause 5.2.2.2.2 for details of this service operation. In this case, the old AMF uses either 5G-GUTI and the integrity protected complete Registration request NAS message, or the SUPI and an indication that the UE is validated from the new AMF, to verify integrity protection if the context transfer service operation invocation corresponds to the UE requested. The old AMF also transfers the event subscriptions information by each NF consumer, for the UE, to the new AMF. If the old AMF has not yet reported a non-zero MO Exception Data Counter to the (H-)SMF, the Context Response also includes the MO Exception Data Counter.

If the old AMF has PDU Sessions for another access type (different from the Access Type indicated in this step) and if the old AMF determines that there is no possibility for relocating the N2 interface to the new AMF, the old AMF returns UE's SUPI and indicates that the Registration Request has been validated for integrity protection, but does not include the rest of the UE context.

For inter PLMN mobility, UE Context information includes HPLMN S-NSSAIs corresponding to the Allowed NSSAI for each Access Type, without Allowed NSSAI of old PLMN.

NOTE 6: The new AMF Sets the indication that the UE is validated according to step 9a, if the new AMF has performed successful UE authentication after previous integrity check failure in the old AMF.

NOTE 7: The NF consumers do not need to subscribe for the events once again with the new AMF after the UE is successfully registered with the new AMF.

If the new AMF has already received UE contexts from the old AMF during handover procedure, then step 4, 5 and 10 shall be skipped.

For an Emergency Registration, if the UE identifies itself with a 5G-GUTI that is not known to the AMF, steps 4 and 5 are skipped and the AMF immediately requests the SUPI from the UE. If the UE identifies itself with PEI, the SUPI request shall be skipped. Allowing Emergency Registration without a user identity is dependent on local regulations.

5. [Conditional] old AMF to new AMF: Response to Namf_Communication_UEContextTransfer (SUPI, UE Context in AMF (as per Table 5.2.2.2.2-1)) or UDSF to new AMF: Nudsf_Unstructured Data Management_Query ( ) The old AMF may start an implementation specific (guard) timer for the UE context.

If the UDSF was queried in step 4, the UDSF responds to the new AMF for the Nudsf_Unstructured Data Management_Query invocation with the related contexts including established PDU Sessions, the old AMF includes SMF information DNN, S-NSSAI(s) and PDU Session ID, active NGAP UE-TNLA bindings to N3IWF/TNGF/W-AGF, the old AMF includes information about the NGAP UE-TNLA bindings. If the Old AMF was queried in step 4, Old AMF responds to the new AMF for the Namf_Communication_UEContextTransfer invocation by including the UE's SUPI and UE Context.

If old AMF holds information about established PDU Session(s) and it is not an Initial Registration, the old AMF includes SMF information, DNN(s), S-NSSAI(s) and PDU Session ID(s).

If old AMF holds UE context established via N3IWF, W-AGF or TNGF, the old AMF includes the CM state via N3IWF, W-AGF or TNGF. If the UE is in CM-CONNECTED state via N3IWF, W-AGF or TNGF, the old AMF includes information about the NGAP UE-TNLA bindings.

If old AMF fails the integrity check of the Registration Request NAS message, the old AMF shall indicate the integrity check failure. If the new AMF is configured to allow emergency services for unauthenticated UE, the new AMF behaves as follows:
If the UE has only an emergency PDU Session, the AMF either skips the authentication and security procedure or accepts that the authentication may fail and continues the Mobility Registration Update procedure; or
If the UE has both emergency and non emergency PDU Sessions and authentication fails, the AMF continues the Mobility Registration Update procedure and deactivates all the non-emergency PDU Sessions as specified in clause 4.3.4.2.

NOTE 8: The new AMF can determine if a PDU Session is used for emergency service by checking whether the DNN matches the emergency DNN.

If old AMF holds information about AM Policy Association and the information about UE Policy Association (i.e. the Policy Control Request Trigger for updating UE Policy as defined in TS 23.503 [20]), the old AMF includes the information about the AM Policy Association, the UE Policy Association and PCF ID. In the roaming case, V-PCF ID and H-PCF ID are included.

If old AMF was a consumer of UE related NWDAF services, the old AMF includes s information about active analytics subscriptions, i.e. the Subscription Correlation ID, NWDAF identifier (i.e. Instance ID or Set ID), Analytics ID(s) and associated Analytics specific data in the Namf_Communication_UEContextTransfer response. Usage of the analytics information by the new AMF is specified in TS 23.288 [50].

During inter PLMN mobility, the handling of the UE Radio Capability ID in the new AMF is as defined in TS 23.501 [2].

NOTE 9: When new AMF uses UDSF for context retrieval, interactions between old AMF, new AMF and UDSF due to UE signalling on old AMF at the same time is implementation issue.

6. [Conditional] new AMF to UE: Identity Request ( ).

If the SUCI is not provided by the UE nor retrieved from the old AMF the Identity Request procedure is initiated by AMF sending an Identity Request message to the UE requesting the SUCI.

7. [Conditional] UE to new AMF: Identity Response ( ).

The UE responds with an Identity Response message including the SUCI. The UE derives the SUCI by using the provisioned public key of the HPLMN, as specified in TS 33.501 [15].

8. The AMF may decide to initiate UE authentication by invoking an AUSF. In that case, the AMF selects an AUSF based on SUPI or SUCI, as described in clause 6.3.4 of TS 23.501 [2].

If the AMF is configured to support Emergency Registration for unauthenticated SUPIs and the UE indicated Registration type Emergency Registration, the AMF skips the authentication or the AMF accepts that the authentication may fail and continues the Registration procedure.

9a. If authentication is required, the AMF requests it from the AUSF; if Tracing Requirements about the UE are available at the AMF, the AMF provides Tracing Requirements in its request to AUSF. Upon request from the AMF, the AUSF shall execute authentication of the UE. The authentication is performed as described in TS 33.501 [15]. The AUSF selects a UDM as described in clause 6.3.8 of TS 23.501 [2] and gets the authentication data from UDM.

Editor's note: It is FFS how the AUSF executes authentication of the UE, in the case of Disaster Roaming Registration.

Once the UE has been authenticated the AUSF provides relevant security related information to the AMF. If the AMF provided a SUCI to AUSF, the AUSF shall return the SUPI to AMF only after the authentication is successful.

After successful authentication in new AMF, which is triggered by the integrity check failure in old AMF at step 5, the new AMF invokes step 4 above again and indicates that the UE is validated (i.e. through the reason parameter as specified in clause 5.2.2.2.2).

9b If NAS security context does not exist, the NAS security initiation is performed as described in TS 33.501 [15]. If the UE had no NAS security context in step 1, the UE includes the full Registration Request message as defined in TS 24.501 [25].

The AMF decides if the Registration Request needs to be rerouted as described in clause 4.2.2.2.3, where the initial AMF refers to the AMF.

9c. The AMF initiates NGAP procedure to provide the 5G-AN with security context as specified in TS 38.413 if the 5G-AN had requested for UE Context. Also, if the AMF decides that EPS fallback is supported (e.g. based on UE capability to support Request Type flag “handover” for PDN connectivity request during the attach procedure as defined in clause 5.17.2.3.1 of TS 23.501 [2], subscription data and local policy), the AMF shall send an indication “Redirection for EPS fallback for voice is possible” towards 5G-AN as specified in TS 38.413 [10]. Otherwise, the AMF indicates “Redirection for EPS fallback for voice is not possible”. In addition, if Tracing Requirements about the UE are available at the AMF, the AMF provides the 5G-AN with Tracing Requirements in the NGAP procedure.

9d. The 5G-AN stores the security context and acknowledges to the AMF. The 5G-AN uses the security context to protect the messages exchanged with the UE as described in TS 33.501 [15].

10. [Conditional] new AMF to old AMF: Namf_Communication_RegistrationStatusUpdate (PDU Session ID(s) to be released e.g. due to slice not supported).

If the AMF has changed the new AMF informs the old AMF that the registration of the UE in the new AMF is completed by invoking the Namf_Communication_RegistrationStatusUpdate service operation.

If the authentication/security procedure fails, then the Registration shall be rejected, and the new AMF invokes the Namf_Communication_RegistrationStatusUpdate service operation with a reject indication towards the old AMF. The old AMF continues as if the UE context transfer service operation was never received.

If one or more of the S-NSSAIs used in the old Registration Area cannot be served in the target Registration Area, the new AMF determines which PDU Session cannot be supported in the new Registration Area. The new AMF invokes the Namf_Communication_RegistrationStatusUpdate service operation including the rejected PDU Session ID towards the old AMF. Then the new AMF modifies the PDU Session Status correspondingly. The old AMF informs the corresponding SMF(s) to locally release the UE's SM context by invoking the Nsmf_PDUSession_ReleaseSMContext service operation.

If new AMF received in the UE context transfer in step 5 the information about the AM Policy Association and the UE Policy Association and decides, based on local policies, not to use the PCF(s) identified by the PCF ID(s) for the AM Policy Association and the UE Policy Association, then it will inform the old AMF that the AM Policy Association and the UE Policy Association in the UE context is not used any longer and then the PCF selection is performed in step 15.

If the new AMF received in the UE context transfer in step 5 the information about UE related analytics subscription(s), the new AMF may take over the analytics subscription(s) from the old AMF. Otherwise, if the new AMF instead determines to create new analytics subscription(s), it informs the old AMF about the analytics subscriptions (identified by their Subscription Correlation ID) that are not needed any longer and the old AMF may now unsubscribe those NWDAF analytics subscriptions for the UE according to TS 23.288 [50].

11. [Conditional] new AMF to UE: Identity Request/Response (PEI).

If the PEI was not provided by the UE nor retrieved from the old AMF the Identity Request procedure is initiated by AMF sending an Identity Request message to the UE to retrieve the PEI. The PEI shall be transferred encrypted unless the UE performs Emergency Registration and cannot be authenticated.

For an Emergency Registration, the UE may have included the PEI in the Registration Request. If so, the PEI retrieval is skipped.

If the UE supports RACS as indicated in UE MM Core Network Capability, the AMF shall use the PEI of the UE to obtain the IMEI/TAC for the purpose of RACS operation.

12. Optionally the new AMF initiates ME identity check by invoking the N5g-eir_EquipmentIdentityCheck_Get service operation (see clause 5.2.4.2.2).

The PEI check is performed as described in clause 4.7.

For an Emergency Registration, if the PEI is blocked, operator policies determine whether the Emergency Registration procedure continues or is stopped.

13. If step 14 is to be performed, the new AMF, based on the SUPI, selects a UDM, then UDM may select a UDR instance. See clause 6.3.9 of TS 23.501 [2].

The AMF selects a UDM as described in clause 6.3.8 of TS 23.501 [2].

14a-c. If the AMF has changed since the last Registration procedure, or if the UE provides a SUPI which doesn't refer to a valid context in the AMF, or if the UE registers to the same AMF it has already registered to a non-3GPP access (i.e. the UE is registered over a non-3GPP access and initiates this Registration procedure to add a 3GPP access), the new AMF registers with the UDM using Nudm_UECM_Registration for the access to be registered (and subscribes to be notified when the UDM deregisters this AMF). In this case, if the AMF does not have event exposure subscription information for this UE, the AMF indicates it to UDM. Then, if the UDM has existing applicable event exposure subscriptions for events detected in AMF for this UE or for any of the groups this UE belongs to (possibly retrieved from UDR), UDM invokes the Namf_EventExposure_Subscribe service for recreating the event exposure subscriptions.

The AMF provides the “Homogenous Support of IMS Voice over PS Sessions” indication (see clause 5.16.3.3 of TS 23.501 [2]) to the UDM. The “Homogenous Support of IMS Voice over PS Sessions” indication shall not be included unless the AMF has completed its evaluation of the support of “IMS Voice over PS Session” as specified in clause 5.16.3.2 of TS 23.501 [2].

During initial Registration, if the AMF and UE supports SRVCC from NG-RAN to UTRAN the AMF provides UDM with the UE SRVCC capability.

If the AMF determines that only the UE SRVCC capability has changed, the AMF sends UE SRVCC capability to the UDM.

NOTE 10: At this step, it is possible that the AMF does not have all the information needed to determine the setting of the IMS Voice over PS Session Supported indication for this UE (see clause 5.16.3.2 of TS 23.501 [2]). Hence the AMF can send the “Homogenous Support of IMS Voice over PS Sessions” later on in this procedure.

If the AMF does not have subscription data for the UE, the AMF retrieves the Access and Mobility Subscription data, SMF Selection Subscription data, UE context in SMF data and LCS mobile origination using Nudm_SDM_Get. If the AMF already has subscription data for the UE but the SoR Update Indicator in the UE context requires the AMF to retrieve SoR information depending on the NAS Registration Type (“Initial Registration” or “Emergency Registration”) (see Annex C of TS 23.122 [22]), the AMF retrieves the Steering of Roaming information using Nudm_SDM_Get. This requires that UDM may retrieve this information from UDR by Nudr_DM_Query. After a successful response is received, the AMF subscribes to be notified using Nudm_SDM_Subscribe when the data requested is modified, UDM may subscribe to UDR by Nudr_DM_Subscribe. The GPSI is provided to the AMF in the Access and Mobility Subscription data from the UDM if the GPSI is available in the UE subscription data. The UDM may provide indication that the subscription data for network slicing is updated for the UE. If the UE is subscribed to MPS in the serving PLMN, “MPS priority” is included in the Access and Mobility Subscription data provided to the AMF. If the UE is subscribed to MCX in the serving PLMN, “MCX priority” is included in the Access and Mobility Subscription data provided to the AMF. The UDM also provides the IAB-Operation allowed indication to AMF as part of the Access and Mobility Subscription data. The AMF shall trigger the setup of the UE context in NG-RAN, or modification of the UE context in NG-RAN if the initial setup is at step 9c, including an indication that the IAB-node is authorized.

Editor's note: It is FFS how the UDM provides applicable subscription data for Disaster Roaming service to the AMF, in the case of Disaster Roaming Registration.

The new AMF provides the Access Type it serves for the UE to the UDM and the Access Type is set to “3GPP access”. The UDM stores the associated Access Type together with the serving AMF and does not remove the AMF identity associated to the other Access Type if any. The UDM may store in UDR information provided at the AMF registration by Nudr_DM_Update.

If the UE was registered in the old AMF for an access, and the old and the new AMFs are in the same PLMN, the new AMF sends a separate/independent Nudm_UECM_Registration to update UDM with Access Type set to access used in the old AMF, after the old AMF relocation is successfully completed.

The new AMF creates an UE context for the UE after getting the Access and Mobility Subscription data from the UDM. The Access and Mobility Subscription data includes whether the UE is allowed to include NSSAI in the 3GPP access RRC Connection Establishment in clear text. The Access and Mobility Subscription data may include Enhanced Coverage Restricted information. If received from the UDM and the UE included support for restriction of use of Enhanced Coverage in step 1, the AMF determines whether Enhanced Coverage is restricted or not for the UE as specified in clause 5.31.12 of TS 23.501 [2] and stores the updated Enhanced Coverage Restricted information in the UE context.

The Access and Mobility Subscription data may include the NB-IoT UE Priority.

The subscription data may contain Service Gap Time parameter. If received from the UDM, the AMF stores this Service Gap Time in the UE Context in AMF for the UE.

For an Emergency Registration in which the UE was not successfully authenticated, the AMF shall not register with the UDM.

The AMF enforces the Mobility Restrictions as specified in clause 5.3.4.1.1 of TS 23.501 [2]. For an Emergency Registration, the AMF shall not check for Mobility Restrictions, access restrictions, regional restrictions or subscription restrictions. For an Emergency Registration, the AMF shall ignore any unsuccessful registration response from UDM and continue with the Registration procedure.

NOTE 11: The AMF can, instead of the Nudm_SDM_Get service operation, use the Nudm_SDM_Subscribe service operation with an Immediate Report Indication that triggers the UDM to immediately return the subscribed data if the corresponding feature is supported by both the AMF and the UDM.

14d. When the UDM stores the associated Access Type (e.g. 3GPP) together with the serving AMF as indicated in step 14a, it will cause the UDM to initiate a Nudm_UECM_DeregistrationNotification (see clause 5.2.3.2.2) to the old AMF corresponding to the same (e.g. 3GPP) access, if one exists. If the timer started in step 5 is not running, the old AMF may remove the UE context for the same Access Type. Otherwise, the AMF may remove UE context for the same Access Type when the timer expires. If the serving NF removal reason indicated by the UDM is Initial Registration, then, as described in clause 4.2.2.3.2, the old AMF invokes the Nsmf_PDUSession_ReleaseSMContext (SM Context ID) service operation towards all the associated SMF(s) of the UE to notify that the UE is deregistered from old AMF for the same Access Type. The SMF(s) shall release the PDU Session on getting this notification.

If the old AMF has established an AM Policy Association and a UE Policy Association with the PCF(s), and the old AMF did not transfer the PCF ID(s) to the new AMF (e.g. new AMF is in different PLMN), the old AMF performs an AMF-initiated Policy Association Termination procedure, as defined in clause 4.16.3.2, and performs an AMF-initiated UE Policy Association Termination procedure, as defined in clause 4.16.13.1. In addition, if the old AMF transferred the PCF ID(s) in the UE context but the new AMF informed in step 10 that the AM Policy Association information and UE Policy Association information in the UE context will not be used then the old AMF performs an AMF-initiated Policy Association Termination procedure, as defined in clause 4.16.3.2, and performs an AMF-initiated UE Policy Association Termination procedure, as defined in clause 4.16.13.1.

If the old AMF has an N2 connection for that UE (e.g. because the UE was in RRC Inactive state but has now moved to E-UTRAN or moved to an area not served by the old AMF), the old AMF shall perform AN Release (see clause 4.2.6) with a cause value that indicates that the UE has already locally released the NG-RAN's RRC Connection.

If the UE context in the old AMF contains an Allowed NSSAI including one or more S-NSSAI(s) subject to NSAC, the old AMF upon receipt of the Nudm_UECM_DeregistrationNotification from the UDM, sends an update request message for each S-NSSAI subject to NSAC to the corresponding NSACF(s) with update flag parameter set to decrease (see clause 4.2.11.2).

At the end of registration procedure, the AMF may initiate synchronization of event exposure subscriptions with the UDM if the AMF does not indicate unavailability of event exposure subscription in step 14a.

NOTE 12: The AMF can initiate synchronization with UDM even if events are available in the UE context (e.g. as received from old AMF) at any given time and based on local policy. This can be done during subscription change related event.

14e. [Conditional] If old AMF does not have UE context for another access type (i.e. non-3GPP access), the Old AMF unsubscribes with the UDM for subscription data using Nudm_SDM_unsubscribe.

15. If the AMF decides to initiate PCF communication, the AMF acts as follows.

If the new AMF decides to use the (V-)PCF identified by the (V-)PCF ID included in UE context from the old AMF in step 5, the AMF contacts the (V-)PCF identified by the (V-)PCF ID to obtain policy. If the AMF decides to perform PCF discovery and selection and the AMF selects a (V)-PCF and may select an H-PCF (for roaming scenario) as described in clause 6.3.7.1 of TS 23.501 [2] and according to the V-NRF to H-NRF interaction described in clause 4.3.2.2.3.3.

16. [Optional] new AMF performs an AM Policy Association Establishment/Modification. For an Emergency Registration, this step is skipped.

If the new AMF selects a new (V-)PCF in step 15, the new AMF performs AM Policy Association Establishment with the selected (V-)PCF as defined in clause 4.16.1.2.

If the (V-)PCF identified by the (V-)PCF ID included in UE context from the old AMF is used, the new AMF performs AM Policy Association Modification with the (V-)PCF as defined in clause 4.16.2.1.2.

If the AMF notifies the Mobility Restrictions (e.g. UE location) to the PCF for adjustment, or if the PCF updates the Mobility Restrictions itself due to some conditions (e.g. application in use, time and date), the PCF shall provide the updated Mobility Restrictions to the AMF. If the subscription information includes Tracing Requirements, the AMF provides the PCF with Tracing Requirements.

If the AMF supports DNN replacement, the AMF provides the PCF with the Allowed NSSAI and, if available, the Mapping Of Allowed NSSAI.

If the PCF supports DNN replacement, the PCF provides the AMF with triggers for DNN replacement.

17. [Conditional] AMF to SMF: Nsmf_PDUSession_UpdateSMContext ( ).

For an Emergency Registered UE (see TS 23.501 [2]), this step is applied when the Registration Type is Mobility Registration Update.

The AMF invokes the Nsmf_PDUSession_UpdateSMContext (see clause 5.2.8.2.6) in the following scenario(s):
If the List Of PDU Sessions To Be Activated is included in the Registration Request in step 1, the AMF sends Nsmf_PDUSession_UpdateSMContext Request to SMF(s) associated with the PDU Session(s) in order to activate User Plane connections of these PDU Session(s). Steps from step 5 onwards described in clause 4.2.3.2 are executed to complete the User Plane connection activation without sending the RRC Inactive Assistance Information and without sending MM NAS Service Accept from the AMF to (R)AN described in step 12 of clause 4.2.3.2. When a User Plane connection for a PDU Session is activated, the AS layer in the UE indicates it to the NAS layer.
If the AMF has determined in step 3 that the UE is performing Inter-RAT mobility to or from NB-IoT, the AMF sends Nsmf_PDUSession_UpdateSMContext Request to SMF(s) associated with the UEs PDU Session(s), so the SMF(s) can update them according to the “PDU Session continuity at inter RAT mobility” subscription data. Steps from step 5 onwards described in clause 4.2.3.2 are executed without sending MM NAS Service Accept from the AMF to (R)AN described in step 12 of clause 4.2.3.2.

When the serving AMF has changed, the new serving AMF notifies the SMF for each PDU Session that it has taken over the responsibility of the signalling path towards the UE: the new serving AMF invokes the Nsmf_PDUSession_UpdateSMContext service operation using SMF information received from the old AMF at step 5. It also indicates whether the PDU Session is to be re-activated.

NOTE 13: If the UE moves into a different PLMN, the AMF in the serving PLMN can insert or change the V-SMF(s) in the serving PLMN for Home Routed PDU session(s). In this case, the same procedures described in clause 4.23.3 are applied for the V-SMF change as for the I-SMF change (i.e. by replacing the I-SMF with V-SMF). During inter-PLMN change, if the same SMF is used, session continuity can be supported depending on operator policies.

Steps from step 5 onwards described in clause 4.2.3.2 are executed. In the case that the intermediate UPF insertion, removal, or change is performed for the PDU Session(s) not included in “PDU Session(s) to be re-activated”, the procedure is performed without N11 and N2 interactions to update the N3 user plane between (R)AN and 5GC.

The AMF invokes the Nsmf_PDUSession_ReleaseSMContext service operation towards the SMF in the following scenario:
If any PDU Session status indicates that it is released at the UE, the AMF invokes the Nsmf_PDUSession_ReleaseSMContext service operation towards the SMF in order to release any network resources related to the PDU Session.

If the serving AMF is changed, the new AMF shall wait until step 18 is finished with all the SMFs associated with the UE. Otherwise, steps 19 to 22 can continue in parallel to this step.

18. [Conditional] If the new AMF and the old AMF are in the same PLMN, the new AMF sends a UE Context Modification Request to N3IWF/TNGF/W-AGF as specified in TS 29.413 [64].

If the AMF has changed and the old AMF has indicated that the UE is in CM-CONNECTED state via N3IWF, W-AGF or TNGF and if the new AMF and the old AMF are in the same PLMN, the new AMF creates an NGAP UE association towards the N3IWF/TNGF/W-AGF to which the UE is connected. This automatically releases the existing NGAP UE association between the old AMF and the N3IWF/TNGF/W-AGF.

19. N3IWF/TNGF/W-AGF sends a UE Context Modification Response to the new AMF.

19a. [Conditional] After the new AMF receives the response message from the N3IWF, W-AGF or TNGF in step 19, the new AMF registers with the UDM using Nudm_UECM_Registration as step 14a, but with the Access Type set to “non-3GPP access”. The UDM stores the associated Access Type together with the serving AMF and does not remove the AMF identity associated to the other Access Type if any. The UDM may store in UDR information provided at the AMF registration by Nudr_DM_Update.

19b. [Conditional] When the UDM stores the associated Access Type (i.e. non-3GPP) together with the serving AMF as indicated in step 19a, it will cause the UDM to initiate a Nudm_UECM_DeregistrationNotification (see clause 5.2.3.2.2) to the old AMF corresponding to the same (i.e. non-3GPP) access. The old AMF removes the UE context for non-3GPP access.

19c. The Old AMF unsubscribes with the UDM for subscription data using Nudm_SDM_unsubscribe.

20a. Void.

21. New AMF to UE: Registration Accept (5G-GUTI, Registration Area, [Mobility restrictions], [PDU Session status], [Allowed NSSAI], [Mapping Of Allowed NSSAI], [Configured NSSAI for the Serving PLMN], [Mapping Of Configured NSSAI], [NSSRG Information], [rejected S-NSSAIs], [Pending NSSAI], [Mapping Of Pending NSSAI], [Periodic Registration Update timer], [Active Time], [Strictly Periodic Registration Timer Indication], [LADN Information], [accepted MICO mode], [IMS Voice over PS session supported Indication], [Emergency Service Support indicator], [Accepted DRX parameters for E-UTRA and NR], [Accepted DRX parameters for NB-IoT], [extended idle mode DRX parameters], [Paging Time Window], [Network support of Interworking without N26], [Access Stratum Connection Establishment NSSAI Inclusion Model], [Network Slicing Subscription Change Indication], [Operator-defined access category definitions], [List of equivalent PLMNs], [Enhanced Coverage Restricted information], [Supported Network Behaviour], [Service Gap Time], [PLMN-assigned UE Radio Capability ID], [PLMN-assigned UE Radio Capability ID deletion], [WUS Assistance Information], [Truncated 5G-S-TMSI Configuration], [Connection Release Supported], [Paging Cause Indication for Voice Service Supported], [Paging Restriction Supported], [Reject Paging Request Supported]).

If the UE indicates support of the limited slice support indicator, then the AMF includes in the configured NSSAI for each S-NSSAI an optional field validity time or deployment zone or both. The validity time indicates the time period when the service is available for the S-NSSAI i.e. the time period within which the UE can register for the S-NSSAI to get the service related to the S-NSSAI. The deployment zone is the location area where the UE can get service for the S-NSSAI.

If the Requested NSSAI does not include S-NSSAIs which map to S-NSSAIs of the HPLMN subject to Network Slice-Specific Authentication and Authorization and the AMF determines that no S-NSSAI can be provided in the Allowed NSSAI for the UE in the current UE's Tracking Area and if no default S-NSSAI(s) not yet involved in the current UE Registration procedure could be further considered, the AMF shall reject the UE Registration and shall include in the rejection message the list of Rejected S-NSSAIs, each of them with the appropriate rejection cause value.

The Allowed NSSAI for the Access Type for the UE is included in the N2 message carrying the Registration Accept message. The Allowed NSSAI contains only S-NSSAIs that do not require, based on subscription information, Network Slice-Specific Authentication and Authorization and, based on the UE Context in the AMF, those S-NSSAIs for which Network Slice-Specific Authentication and Authorization previously succeeded, regardless of the Access Type. The Mapping Of Pending NSSAI is the mapping of each S-NSSAI of the Pending NSSAI for the Serving PLMN to the HPLMN S-NSSAIS.

If the UE has indicated its support of the Network Slice-Specific Authentication and Authorization procedure in the UE MM Core Network Capability in the Registration Request, AMF includes in the Pending NSSAI the S-NSSAIs that map to an S-NSSAI of the HPLMN which in the subscription information has indication that it is subject to Network Slice-Specific Authentication and Authorization, as described in clause 4.6.2.4 of TS 24.501 [25]. In such case, the AMF then shall trigger at step 25 the Network Slice-Specific Authentication and Authorization procedure, specified in clause 4.2.9.2, except, based on Network policies, for those S-NSSAIs for which Network Slice-Specific Authentication and Authorization have already been initiated on another Access Type for the same S-NSSAI(s). The UE shall not attempt re-registration with the S-NSSAIs included in the list of Pending NSSAIs until the Network Slice-Specific Authentication and Authorization procedure has been completed, regardless of the Access Type.

If the UE has not indicated its support of the Network Slice-Specific Authentication and Authorization procedure in the UE 5GMM Core Network Capability in the Registration Request, and the Requested NSSAI includes S-NSSAIs which map to HPLMN S-NSSAIs subject to Network Slice-Specific Authentication and Authorization, the AMF includes those S-NSSAIs in the Requested NSSAI in the Rejected S-NSSAIs.

If no S-NSSAI can be provided in the Allowed NSSAI because:
all the S-NSSAI(s) in the Requested NSSAI are to be subject to Network Slice-Specific Authentication and Authorization;
or

no Requested NSSAI was provided or none of the S-NSSAIs in the Requested NSSAI matches any of the Subscribed S-NSSAIs, and all the S-NSSAI(s) marked as default in the Subscribed S-NSSAIS are to be subject to Network Slice-Specific Authentication and Authorization.

The AMF shall provide an empty Allowed NSSAI. Upon receiving an empty Allowed NSSAI and a Pending NSSAI, the UE is registered in the PLMN but shall wait for the completion of the Network Slice-Specific Authentication and Authorization procedure without attempting to use any service provided by the PLMN on any access, except e.g. emergency services (see TS 24.501 [25]), until the UE receives an Allowed NSSAI.

The AMF stores the NB-IoT Priority retrieved in Step 14 and associates it to the 5G-S-TMSI allocated to the UE.

If the Registration Request message received over 3GPP access does not include any Paging Restriction Information, the AMF shall delete any stored Paging Restriction Information for this UE and stop restricting paging accordingly.

If the Registration Request message received over 3GPP access includes a Release Request indication, then:
the AMF updates the UE context with any received Paging Restriction Information, then enforces it in the network triggered Service Request procedure as described in clause 4.2.3.3;
the AMF does not establish User Plane resources and triggers the AN release procedure as described in clause 4.2.6 after the completion of Registration procedure.

The AMF sends a Registration Accept message to the UE indicating that the Registration Request has been accepted. 5G-GUTI is included if the AMF allocates a new 5G-GUTI. Upon receiving a Registration Request message of type “Initial Registration”, “mobility registration update”, or “Disaster Roaming Registration” from the UE, the AMF shall include a new 5G-GUTI in the Registration Accept message. Upon receiving a Registration Request message of type “periodic registration update” from the UE, the AMF should include a new 5G-GUTI in the Registration Accept message. If the UE is already in RM-REGISTERED state via another access in the same PLMN, the UE shall use the 5G-GUTI received in the Registration Accept for both registrations. If no 5G-GUTI is included in the Registration Accept, then the UE uses the 5G-GUTI assigned for the existing registration also for the new registration. If the AMF allocates a new Registration area, it shall send the Registration area to the UE via Registration Accept message. For a Disaster Roaming Registration, the AMF allocates the Registration Area limited to the area with Disaster Condition as specified in clause 5.40 of TS 23.501 [2]. If there is no Registration area included in the Registration Accept message, the UE shall consider the old Registration Area as valid. Mobility Restrictions is included if mobility restrictions applies for the UE and Registration Type is not Emergency Registration. The AMF indicates the established PDU Sessions to the UE in the PDU Session status. The UE removes locally any internal resources related to PDU Sessions that are not marked as established in the received PDU Session status. If the AMF invokes the Nsmf_PDUSession_UpdateSMContext procedure for UP activation of PDU Session(s) in step 18 and receives rejection from the SMF, then the AMF indicates to the UE the PDU Session ID and the cause why the User Plane resources were not activated. When the UE is connected to the two AMFs belonging to different PLMN via 3GPP access and non-3GPP access then the UE removes locally any internal resources related to the PDU Session of the current PLMN that are not marked as established in received PDU Session status. If the PDU Session status information was in the Registration Request, the AMF shall indicate the PDU Session status to the UE.

If the RAT Type is NB-IoT and the network is configured to use the Control Plane Relocation Indication procedure then the AMF shall include in the Registration Accept message the Truncated 5G-S-TMSI Configuration that the UE using Control Plane CIOT 5GS Optimisation uses to create the Truncated 5G-S-TMSI, see clause 5.31.4.3 of TS 23.501 [2].

The Allowed NSSAI provided in the Registration Accept is valid in the Registration Area and it applies for all the PLMNs which have their Tracking Areas included in the Registration Area. The Mapping Of Allowed NSSAI is the mapping of each S-NSSAI of the Allowed NSSAI to the HPLMN S-NSSAIs. The Mapping Of Configured NSSAI is the mapping of each S-NSSAI of the Configured NSSAI for the Serving PLMN to the HPLMN S-NSSAIS.

If the UE has indicated its support of the subscription-based restrictions to simultaneous registration of network slices feature, the AMF includes, if available, the NSSRG Information, defined in clause 5.15.12 of TS 23.501 [2].

If the UE has not indicated its support of the subscription-based restrictions to simultaneous registration of network slices feature, and the subscription information for the UE includes SRG information, and the AMF is providing the Configured NSSAI to the UE, the Configured NSSAI shall include the S-NSSAIs according to clause 5.15.12 of TS 23.501 [2].

The AMF shall include in the Registration Accept message the LADN Information for the list of LADNs, described in clause 5.6.5 of TS 23.501 [2], that are available within the Registration area determined by the AMF for the UE. The AMF may include Operator-defined access category definitions to let the UE determinine the applicable Operator-specific access category definitions as described in TS 24.501 [25].

If the UE included MICO mode in the Registration Request, then AMF responds in the Registration Accept message whether MICO mode should be used. When MICO mode is allowed for the UE, the AMF may include an Active Time value and/or Strictly Periodic Registration Timer Indication in the Registration Accept message. The AMF determines the Periodic Registration Update timer value, Active Time value and the Strictly Periodic Registration Timer Indication based on local configuration, Expected UE Behaviour if available, UE indicated preferences, UE capability, UE subscription information and network policies, or any combination of them so as to enable UE power saving, as described in clause 5.31.7 of TS 23.501 [2]. The AMF determines to apply the Strictly Periodic Registration Timer Indication to the UE if the UE indicates its capability of the Strictly Periodic Registration Timer Indication in the registration request message, as described in step 1. If the AMF provides the Periodic Registration Update timer value with the Strictly Periodic Registration Timer Indication to the UE, the UE and the AMF start the Periodic Registration Update timer after this step, as described in clause 5.31.7.5 of TS 23.501 [2].

In the case of registration over 3GPP access, the AMF Sets the IMS Voice over PS session supported Indication as described in clause 5.16.3.2 of TS 23.501 [2]. In order to set the IMS Voice over PS session supported Indication the AMF may need to perform the UE Capability Match Request procedure in clause 4.2.8a to check the compatibility of the UE and NG-RAN radio capabilities related to IMS Voice over PS. If the AMF hasn't received Voice Support Match Indicator from the NG-RAN on time then, based on implementation, AMF may set IMS Voice over PS session supported Indication and update it at a later stage.

In the case of registration over 3GPP access and the AMF has retrieved or determined according to local configuration a Target NSSAI and a corresponding RFSP Index for the purpose of allowing the NG-RAN to redirect the UE to a cell supporting network slices not available in the current TA as described in clause 5.3.4.3.3 of TS 23.501 [2], the AMF provides the Target NSSAI and the corresponding RFSP Index to the NG-RAN.

In the case of registration over non-3GPP access, the AMF Sets the IMS Voice over PS session supported Indication as described in clause 5.16.3.2a of TS 23.501 [2].

The Emergency Service Support indicator informs the UE that emergency services are supported, i.e. the UE is allowed to request PDU Session for emergency services. If the AMF received “MPS priority” from the UDM as part of Access and Mobility Subscription data, based on operator policy, “MPS priority” is included in the Registration Accept message to the UE to inform the UE whether configuration of Access Identity 1 is valid within the selected PLMN, as specified in TS 24.501 [25]. If the AMF received “MCX priority” from the UDM as part of Access and Mobility Subscription data, based on operator policy and UE subscription to MCX Services, “MCX priority” is included in the Registration Accept message to the UE to inform the UE whether configuration of Access Identity 2 is valid within the selected PLMN, as specified in TS 24.501 [25]. The Accepted DRX parameters are defined in clause 5.4.5 of TS 23.501 [2]. The AMF includes Accepted DRX parameters for NB-IoT, if the UE included Requested DRX parameters for NB-IoT in the Registration Request message. The AMF Sets the Network support of Interworking without N26 parameter as described in clause 5.17.2.3.1 of TS 23.501 [2]. If the AMF accepts the use of extended idle mode DRX, the AMF includes the extended idle mode DRX parameters and Paging Time Window as described in 5.31.7.2 of TS 23.501 [2].

If the UDM intends to indicate the UE that subscription has changed, the Network Slicing Subscription Change Indication is included. If the AMF includes Network Slicing Subscription Change Indication, then the UE shall locally erase all the network slicing configuration for all PLMNs and, if applicable, update the configuration for the current PLMN based on any received information.

The Access Stratum Connection Establishment NSSAI Inclusion Mode, as specified in clause 5.15.9 of TS 23.501 [2], is included to instruct the UE on what NSSAI, if any, to include in the Access Stratum connection establishment. The AMF can set the value to modes of operation a,b,c defined in clause 5.15.9 of TS 23.501 [2] in the 3GPP Access only if the Inclusion of NSSAI in RRC Connection Establishment Allowed indicates that it is allowed to do so.

For a UE registered in a PLMN, the AMF may provide a List of equivalent PLMNs which is handled as specified in TS 24.501 [25]. For a UE registered in an SNPN, the AMF shall not provide a list of equivalent PLMNs to the UE.

If the UE included support for restriction of use of Enhanced Coverage in step 1, the AMF sends the Enhanced Coverage Restricted information to the NG-RAN in N2 message. The AMF also sends Enhanced Coverage Restricted information to the UE in the Registration Accept message.

If the UE receives Enhanced Coverage Restricted information in the Registration Accept message, the UE shall store this information and shall use the value of Enhanced Coverage Restricted information to determine if Enhanced Coverage feature should be used or not.

If the UE and the AMF have negotiated to enable MICO mode and the AMF uses the Extended connected timer, then the AMF provides the Extended Connected time value to NG-RAN (see clause 5.31.7.3 of TS 23.501 [2]) in this step. The Extended Connected Time value indicates the minimum time the RAN should keep the UE in RRC-CONNECTED state regardless of inactivity.

The AMF indicates the CIOT 5GS Optimisations it supports and accepts in the Supported Network Behaviour information (see clause 5.31.2 of TS 23.501 [2]) if the UE included Preferred Network Behaviour in its Registration Request.

The AMF may steer the UE from 5GC by rejecting the Registration Request. The AMF should take into account the Preferred and Supported Network Behaviour (see clause 5.31.2 of TS 23.501 [2]) and availability of EPC to the UE before steering the UE from 5GC.

If the AMF accepts MICO mode and knows there may be mobile terminated data or signalling pending, the AMF maintains the N2 connection for at least the Extended Connected Time as described in clause 5.31.7.3 of TS 23.501 [2], and provides the Extended Connected Time value to the RAN.

The AMF includes Service Gap Time if Service Gap Time is present in the subscription information (steps 14a-c) or the Service Gap Time has been updated by the Subscriber Data Update Notification to AMF procedure (see clause 4.5.1) and the UE has indicated UE Service Gap Control Capability.

If the UE receives a Service Gap Time in the Registration Accept message, the UE shall store this parameter and apply Service Gap Control (see clause 5.31.16 of TS 23.501 [2]).

If the network supports WUS grouping (see TS 23.501 [2]), the AMF shall send the WUS Assistance Information to the UE. If the UE provided the UE paging probability information in Step 1, the AMF takes it into account to determine the WUS Assistance Information.

When the UE and the AMF supports RACS as defined in clause 5.4.4.1a of TS 23.501 [2], and the AMF needs to configure the UE with a UE Radio Capability ID, and the AMF already has the UE radio capabilities other than NB-IoT radio capabilities for the UE, the AMF may provide the UE with the UE Radio Capability ID for the UE radio capabilities the UCMF returns to the AMF in a Nucmf_assign service operation for this UE. Alternatively, when the UE and the AMF support RACS, the AMF may provide the UE with an indication to delete any PLMN-assigned UE Radio Capability ID in this PLMN (see clause 5.4.4.1a of TS 23.501 [2]).

If the UE is “CAG supported”, and the AMF needs to update the CAG information of the UE, the AMF may include the CAG information as part of the Mobility Restrictions in the Registration Accept message.

If the UE indicates support for the Paging Cause Indication for Voice Service feature in the Registration Request message and if the network supports and intends to apply the Paging Cause Indication for Voice Service feature for the UE, the AMF includes an indication that the UE supports the Paging Cause Indication for Voice Service feature in the N2 message carrying the Registration Accept message.

If the Multi-USIM UE has indicated support for one or more Multi-USIM Specific Capabilities in the UE 5GMM Core Network Capability in step 1, the AMF shall indicate to the Multi-USIM UE whether the corresponding one or more Multi-USIM specific features described in clause 5.38 of TS 23.501 [2] are supported, based on network capability and preference by the network (i.e. based on local network policy), by providing one or more of the Connection Release Supported, Paging Cause Indication for Voice Service Supported, Paging Restriction Supported and Reject Paging Request Supported indications. If the Multi-USIM UE has indicated support for the Paging Cause Indication for Voice Service feature, the AMF supporting the Paging Cause Indication for Voice Service shall include an indication in the N2 message that the UE supports the Paging Cause Indication for Voice Service feature. The AMF shall only indicate Paging Restriction Supported together with either Connection Release Supported or Reject Paging Request Supported. The UE shall only use Multi-USIM specific features that the AMF indicated as being supported.

21b. [Optional] The new AMF performs a UE Policy Association Establishment as defined in clause 4.16.11. For an Emergency Registration, this step is skipped.

The new AMF sends a Npcf_UEPolicyControl Create Request to PCF. PCF sends a Npcf_UEPolicyControl Create Response to the new AMF.

PCF triggers UE Configuration Update Procedure as defined in clause 4.2.4.3.

22. [Conditional] UE to new AMF: Registration Complete ( ).

The UE sends a Registration Complete message to the AMF when it has successfully updated itself after receiving any of the [Configured NSSAI for the Serving PLMN], [Mapping Of Configured NSSAI], [NSSRG Information] and a Network Slicing Subscription Change Indication, or CAG information in step 21.

The UE sends a Registration Complete message to the AMF to acknowledge if a new 5G-GUTI was assigned.

If new 5G-GUTI was assigned, then the UE passes the new 5G-GUTI to its 3GPP access' lower layer when a lower layer (either 3GPP access or non-3GPP access) indicates to the UE's RM layer that the Registration Complete message has been successfully transferred across the radio interface.

NOTE 14: The above is needed because the NG-RAN may use the RRC Inactive state and a part of the 5G-GUTI is used to calculate the Paging Frame (see TS 38.304 and TS 36.304 [43]). It is assumed that the Registration Complete is reliably delivered to the AMF after the 5G-AN has acknowledged its receipt to the UE.

When the List Of PDU Sessions To Be Activated is not included in the Registration Request and the Registration procedure was not initiated in CM-CONNECTED state, the AMF releases the signalling connection with UE, according to clause 4.2.6.

When the Follow-on request is included in the Registration Request, the AMF should not release the signalling connection after the completion of the Registration procedure.

If the AMF is aware that some signalling is pending in the AMF or between the UE and the 5GC, the AMF should not release the signalling connection immediately after the completion of the Registration procedure.

If PLMN-assigned UE Radio Capability ID is included in step 21, the AMF stores the PLMN-assigned UE Radio Capability ID in UE context if receiving Registration Complete message.

If the UE receives PLMN-assigned UE Radio Capability ID deletion indication in step 21, the UE shall delete the PLMN-assigned UE Radio Capability ID(s) for this PLMN.

23. [Conditional] AMF to UDM: If the Access and Mobility Subscription data provided by UDM to AMF in 14b includes Steering of Roaming information with an indication that the UDM requests an acknowledgement of the reception of this information from the UE, the AMF provides the UE acknowledgement to UDM using Nudm_SDM_Info. For more details regarding the handling of Steering of Roaming information refer to TS 23.122 [22].

23a. For Registration over 3GPP Access, if the AMF does not release the signalling connection, the AMF sends the RRC Inactive Assistance Information to the NG-RAN.

For Registration over non-3GPP Access, if the UE is also in CM-CONNECTED state on 3GPP access, the AMF sends the RRC Inactive Assistance Information to the NG-RAN.

The AMF also uses the Nudm_SDM_Info service operation to provide an acknowledgment to UDM that the UE received CAG information, or the Network Slicing Subscription Change Indication (see step 21 and step 22) and acted upon it.

24. [Conditional] AMF to UDM: After step 14a, and in parallel to any of the preceding steps, the AMF shall send a “Homogeneous Support of IMS Voice over PS Sessions” indication to the UDM using Nudm_UECM_Update:
If the AMF has evaluated the support of IMS Voice over PS Sessions, see clause 5.16.3.2 of TS 23.501 [2], and
If the AMF determines that it needs to update the Homogeneous Support of IMS Voice over PS Sessions, see clause 5.16.3.3 of TS 23.501 [2].

25. [Conditional] If the UE indicates its support for Network Slice-Specific Authentication and Authorization procedure in the UE MM Core Network Capability in Registration Request, and any S-NSSAI of the HPLMN is subject to Network Slice-Specific Authentication and Authorization, the related procedure is executed at this step (see clause 4.2.9.1). Once the Network Slice-Specific Authentication and Authorization procedure is completed for all S-NSSAIs, the AMF shall trigger a UE Configuration Update procedure to deliver an Allowed NSSAI containing also the S-NSSAIs for which the Network Slice-Specific Authentication and Authorization was successful, and include any rejected NSSAIs with an appropriate rejection cause value.

The AMF shall remove the mobility restriction if the Tracking Areas of the Registration Area were previously assigned as a Non-Allowed Area due to pending Network Slice-Specific Authentication and Authorization.

The AMF stores an indication in the UE context for any S-NSSAI of the HPLMN subject to Network Slice-Specific Authentication and Authorization for which the Network Slice-Specific Authentication and Authorization succeeds.

Once completed the Network Slice-Specific Authentication and Authorization procedure, if the AMF determines that no S-NSSAI can be provided in the Allowed NSSAI for the UE, which is already authenticated and authorized successfully by a PLMN, and if no default S-NSSAI(s) could be further considered, the AMF shall execute the Network-initiated Deregistration procedure described in clause 4.2.2.3.3, and shall include in the explicit De-Registration Request message the list of Rejected S-NSSAIs, each of them with the appropriate rejection cause value.

The mobility related event notifications towards the NF consumers are triggered at the end of this procedure for cases as described in clause 4.15.4.

### <5.15.4.1.1 UE Network Slice Configuration>

The Network Slice configuration information contains one or more Configured NSSAI(s). A Configured NSSAI may either be configured by a Serving PLMN and apply to the Serving PLMN, or may be a Default Configured NSSAI configured by the HPLMN and that applies to any PLMNs for which no specific Configured NSSAI has been provided to the UE. There is at most one Configured NSSAI per PLMN.

NOTE 1: The value(s) used in the Default Configured NSSAI are expected to be commonly decided by all roaming partners, e.g. by the use of values standardized by 3GPP or other bodies.

The Default Configured NSSAI, if it is configured in the UE, is used by the UE in a Serving PLMN only if the UE has no Configured NSSAI for the Serving PLMN.

The Configured NSSAI of a PLMN may include S-NSSAIs that have standard values or PLMN-specific values.

The Configured NSSAI for the Serving PLMN includes the S-NSSAI values which can be used in the Serving PLMN and may be associated with mapping of each S-NSSAI of the Configured NSSAI to one or more corresponding HPLMN S-NSSAI values.

If the UE indicates support of the limited slice support indicator, then the AMF includes in the configured NSSAI for each S-NSSAI an optional field validity time or deployment zone or both. The validity time indicates the time period when the service is available for the S-NSSAI i.e. the time period within which the UE can register for the S-NSSAI to get the service related to the S-NSSAI. The deployment zone is the location area where the UE can get service for the S-NSSAI. Upon reception of the configured S-NSSAI the UE starts the validity time for the S-NSSAI for which it has received the validity time with the time period equal to the received validity time.

A UE subscription may contain Network Slice Simultaneous Registration Group (NSSRG) information. If so, the UE configuration is performed as described in clause 5.15.12.2.

The UE may be pre-configured with the Default Configured NSSAI. The UE may be provisioned/updated with the Default Configured NSSAI, determined by the UDM in the HPLMN, using the UE Parameters Update via UDM Control Plane procedure defined in clause 4.20 of TS 23.502 [3]. Each S-NSSAI in the Default Configured NSSAI may have a corresponding S-NSSAI as part of the Subscribed S-NSSAI(s). Consequently, if the Subscribed S-NSSAI(s) which are also present in the Default Configured NSSAI are updated the UDM should update the Default Configured NSSAI in the UE.

In the HPLMN, the S-NSSAIs in the Configured NSSAI provided as described in clause 5.15.4.2, at the time when they are provided to the UE, shall match the Subscribed S-NSSAIs for the UE. When the Subscribed S-NSSAI(s) are updated (i.e. some existing S-NSSAIs are removed and/or some new S-NSSAIs are added) and one or more are applicable to the Serving PLMN the UE is registered in, as described in clause 5.15.3, or when the associated mapping is updated the AMF shall update the UE with the Configured NSSAI for the Serving PLMN and/or Allowed NSSAI and/or the associated mapping to HPLMN S-NSSAIS (see clause 5.15.4.2). When there is the need to update the Allowed NSSAI, the AMF shall provide the UE with the new Allowed NSSAI and the associated mapping to HPLMN S-NSSAIs, unless the AMF cannot determine the new Allowed NSSAI (e.g. all S-NSSAIs in the old Allowed NSSAI have been removed from the Subscribed S-NSSAIs), in which case the AMF shall not send any Allowed NSSAI to the UE but indicate to the UE to perform a Registration procedure. If the UE is in a CM-IDLE state, the AMF may trigger Network Triggered Service Request or wait until the UE is in a CM-CONNECTED state as described in clause 4.2.4.2, TS 23.502 [3].

When providing a Requested NSSAI to the network upon registration, the UE in a given PLMN only includes and uses S-NSSAIs applying to this PLMN. The mapping of S-NSSAIs of the Requested NSSAI to HPLMN S-NSSAIs may also be provided (see clause 5.15.4.1.2 for when this is needed). The S-NSSAIs in the Requested NSSAI are part of the Configured and/or Allowed NSSAIs applicable for this PLMN, when they are available. If the UE has received NSSRG information together with the Configured NSSAI, it only includes in the Requested NSSAI S-NSSAIs that all share a common NSSRG. If no Configured NSSAI and Allowed NSSAI for the PLMN are available, the S-NSSAIs in the Requested NSSAI correspond to the Default Configured NSSAI, if configured in the UE. Upon successful completion of a UE's Registration procedure over an Access Type, the UE obtains from the AMF an Allowed NSSAI for this Access Type, which includes one or more S-NSSAIs and, if needed (see clause 5.15.4.1.2 for when this is needed), their mapping to the HPLMN S-NSSAIs. These S-NSSAIs are valid for the current Registration Area and Access Type provided by the AMF the UE has registered with and can be used simultaneously by the UE (up to the maximum number of simultaneous Network Slice instances or PDU Sessions).

The UE might also obtain one or more rejected S-NSSAIs with cause and validity of rejection from the AMF. An S-NSSAI may be rejected:
for the entire PLMN; or
for the current Registration Area.

While it remains RM-REGISTERED in the PLMN and regardless of the Access Type, the UE shall not re-attempt to register to an S-NSSAI rejected for the entire PLMN until this rejected S-NSSAI is deleted as specified below.

While it remains RM-REGISTERED in the PLMN, the UE shall not re-attempt to register to an S-NSSAI rejected in the current Registration Area until it moves out of the current Registration Area.

NOTE 2: The details and more cases of S-NSSAI rejection are described in TS 24.501 [47].

S-NSSAIs that the UE provides in the Requested NSSAI which are neither in the Allowed NSSAI nor provided as a rejected S-NSSAI, shall, by the UE, not be regarded as rejected, i.e. the UE may request to register these S-NSSAIs again next time the UE sends a Requested NSSAI.

The UE stores (S-)NSSAIs as follows:
When provisioned with a Configured NSSAI for a PLMN and/or a mapping of Configured NSSAI to HPLMN S-NSSAIS and possibly NSSRG information for each S-NSSAI in the Configured NSSAI (if applicable and supported by the UE), or when requested to remove the configuration due to network slicing subscription change, the UE shall:
replace any stored (old) Configured NSSAI for this PLMN with the new Configured NSSAI for this PLMN (if applicable); and
delete any stored associated mapping of this old Configured NSSAI for this PLMN to HPLMN S-NSSAIs and, if present and applicable, store the mapping of Configured NSSAI to HPLMN S-NSSAIs; and
delete any stored associated NSSRG information for each S-NSSAI of the Configured NSSAI and, if present, store the associated NSSRG information for each S-NSSAI of the Configured NSSAI; and
delete any stored rejected S-NSSAI for this PLMN;
keep the received Configured NSSAI for a PLMN (if applicable) and associated mapping to HPLMN S-NSSAIs (if applicable) and associated NSSRG information for each S-NSSAI of the Configured NSSAI (if applicable and supported by the UE) stored in the UE, even when registering in another PLMN, until a new Configured NSSAI for this PLMN and/or associated mapping are provisioned in the UE, or until the network slicing subscription changes, as described in clause 5.15.4.2. The number of Configured NSSAIs and associated mapping to be kept stored in the UE for PLMNs other than the HPLMN is up to UE implementation. A UE shall at least be capable of storing a Configured NSSAI for the serving PLMN including any necessary mapping of the Configured NSSAI for the Serving PLMN to HPLMN S-NSSAIs and the Default Configured NSSAI.
The Allowed NSSAI received in a Registration Accept message or a UE Configuration Update Command applies to a PLMN when at least a TAI of this PLMN is included in the RA/TAI list included in this Registration Accept message or UE Configuration Update Command. If the UE Configuration Update Command contains an Allowed NSSAI but not a TAI List, then the last received RA/TAI list applies for the decision on which PLMN(s) the Allowed NSSAI is applicable. If received, the Allowed NSSAI for a PLMN and Access Type and any associated mapping of this Allowed NSSAI to HPLMN S-NSSAIs shall be stored in the UE. The UE should store this Allowed NSSAI and any associated mapping of this Allowed NSSAI to HPLMN S-NSSAIs also when the UE is turned off, or until the network slicing subscription changes, as described in clause 5.15.4.2:

NOTE 3: Whether the UE stores the Allowed NSSAI and any associated mapping of the Allowed NSSAI to HPLMN S-NSSAIS also when the UE is turned off is left to UE implementation.
When a new Allowed NSSAI for a PLMN and any associated mapping of the Allowed NSSAI to HPLMN S-NSSAIs are received over an Access Type, the UE shall:
replace any stored (old) Allowed NSSAI and any associated mapping for these PLMN and Access Type with this new Allowed NSSAI; and
delete any stored associated mapping of this old Allowed NSSAI for this PLMN to HPLMN S-NSSAIs and, if present, store the associated mapping of this new Allowed NSSAI to HPLMN S-NSSAIs;
If received, an S-NSSAI rejected for the entire PLMN shall be stored in the UE while RM-REGISTERED in this PLMN regardless of the Access Type or until it is deleted.
If received, an S-NSSAI rejected for the current Registration Area shall be stored in the UE while RM-REGISTERED until the UE moves out of the current Registration Area or until the S-NSSAI is deleted.

NOTE 4: The storage aspects of rejected S-NSSAIs are described in TS 24.501 [47].
If received, the Pending NSSAI shall be stored in the UE as described in TS 24.501 [47].

### <5.15.5.2.1 Registration to a Set of Network Slices>

When a UE registers over an Access Type with a PLMN, if the UE has either or both of:
a Configured NSSAI for this PLMN;
an Allowed NSSAI for this PLMN and Access Type;
the UE shall provide to the network, in AS layer under the conditions described in clause 5.15.9 and in NAS layer, a Requested NSSAI containing the S-NSSAI(s) corresponding to the Network Slice(s) to which the UE wishes to register, unless they are stored in the UE in the Pending NSSAI.

The Requested NSSAI shall be one of:
the Default Configured NSSAI, i.e. if the UE has no Configured NSSAI nor an Allowed NSSAI for the serving PLMN;
the Configured-NSSAI, or a subset thereof as described below, e.g. if the UE has no Allowed NSSAI for the Access Type for the serving PLMN;
the Allowed-NSSAI for the Access Type over which the Requested NSSAI is sent, or a subset thereof; or the Allowed-NSSAI for the Access Type over which the Requested NSSAI is sent, or a subset thereof, plus one or more S-NSSAIs from the Configured-NSSAI not yet in the Allowed NSSAI for the Access Type as described below.

NOTE 1: If the UE wishes to register only a subset of the S-NSSAIs from the Configured NSSAI or the Allowed NSSAI, to be able to register with some Network Slices e.g. to establish PDU Sessions for some application(s), and the UE uses the URSP rules (which includes the NSSP) or the UE Local Configuration as defined in clause 6.1.2.2.1 of TS 23.503 [45], then the UE uses applicable the URSP rules or the UE Local Configuration to ensure that the S-NSSAIs included in the Requested NSSAI are not in conflict with the URSP rules or with the UE Local Configuration.

If a S-NSSAI in the configured NSSAI consists of the field validity timer or deployment zone, then the UE sends the S-NSSAI in the Requested NSSAI if the validity time is running or if the UE is present in the deployment area of the S-NSSAI.

The subset of S-NSSAIs in the Configured-NSSAI provided in the Requested NSSAI consists of one or more S-NSSAI(s) in the Configured NSSAI applicable to this PLMN, if one is present, and for which no corresponding S-NSSAI is already present in the Allowed NSSAI for the access type for this PLMN. The UE shall not include in the Requested NSSAI any S-NSSAI that is currently rejected by the network (i.e. rejected in the current registration area or rejected in the PLMN). For the registration to a PLMN for which neither a Configured NSSAI applicable to this PLMN or an Allowed NSSAI are present, the S-NSSAIs provided in the Requested NSSAI correspond to the S-NSSAI(s) in the Default Configured NSSAI unless the UE has HPLMN S-NSSAI for established PDU Session(s) in which case the HPLMN S-NSSAI(s) shall be provided in the mapping of Requested NSSAI in the NAS Registration Request message, with no corresponding VPLMN S-NSSAI in the Requested NSSAI. If the UE has been provided with NSSRG information together with the Configured NSSAI, the UE only includes in the Requested NSSAIS-NSSAIs that share a common NSSRG, see clause 5.15.12.2.

When a UE registers over an Access Type with a PLMN, the UE shall also indicate in the Registration Request message when the Requested NSSAI is based on the Default Configured NSSAI.

The UE shall include the Requested NSSAI in the RRC Connection Establishment and in the establishment of the connection to the N3IWF/TNGF (as applicable) and in the NAS Registration procedure messages subject to conditions set out in clause 5.15.9. However, the UE shall not indicate any NSSAI in RRC Connection Establishment or Initial NAS message unless it has either a Configured NSSAI for the corresponding PLMN, an Allowed NSSAI for the corresponding PLMN and Access Type, or the Default Configured NSSAI. If the UE has HPLMN S-NSSAI(s) for established PDU Session(s), the HPLMN S-NSSAI(s) shall be provided in the mapping of Requested NSSAI in the NAS Registration Request message, independent of whether the UE has the corresponding VPLMN S-NSSAI. The (R)AN shall route the NAS signalling between this UE and an AMF selected using the Requested NSSAI obtained during RRC Connection Establishment or connection to N3IWF/TNGF respectively. If the (R)AN is unable to select an AMF based on the Requested NSSAI, it routes the NAS signalling to an AMF from a set of default AMFs. In the NAS signalling, if available, the UE provides the mapping of each S-NSSAI of the Requested NSSAI to a corresponding HPLMN S-NSSAI.

When a UE registers with a PLMN, if for this PLMN the UE has not included a Requested NSSAI nor a GUAMI while establishing the connection to the (R)AN, the (R)AN shall route all NAS signalling from/to this UE to/from a default AMF. When receiving from the UE a Requested NSSAI and a 5G-S-TMSI or a GUAMI in RRC Connection Establishment or in the establishment of connection to N3IWF/TNGF, if the 5G-AN can reach an AMF corresponding to the 5G-S-TMSI or GUAMI, then 5G-AN forwards the request to this AMF. Otherwise, the 5G-AN selects a suitable AMF based on the Requested NSSAI provided by the UE and forwards the request to the selected AMF. If the 5G-AN is not able to select an AMF based on the Requested NSSAI, then the request is sent to a default AMF.

When the AMF selected by the AN during Registration Procedure receives the UE Registration request, or after an AMF selection by MME (i.e. during EPS to 5GS handover) the AMF receives S-NSSAI(s) from SMF+PGW-C in 5GC:
As part of the Registration procedure described in clause 4.2.2.2.2 of TS 23.502 [3], or as part of the EPS to 5GS handover using N26 interface procedure described in clause 4.11.1.2.2 of TS 23.502 [3], the AMF may query the UDM to retrieve UE subscription information including the Subscribed S-NSSAIs.
The AMF verifies whether the S-NSSAI(s) in the Requested NSSAI or the S-NSSAI(s) received from SMF+PGW-C are permitted based on the Subscribed S-NSSAIs (to identify the Subscribed S-NSSAIs the AMF may use the mapping to HPLMN S-NSSAIs provided by the UE, in the NAS message, for each S-NSSAI of the Requested NSSAI).
When the UE context in the AMF does not yet include an Allowed NSSAI for the corresponding Access Type, the AMF queries the NSSF (see (B) below for subsequent handling), except in the case when, based on configuration in this AMF, the AMF is allowed to determine whether it can serve the UE (see (A) below for subsequent handling). The IP address or FQDN of the NSSF is locally configured in the AMF.

NOTE 2: The configuration in the AMF depends on operator's policy.
When the UE context in the AMF already includes an Allowed NSSAI for the corresponding Access Type, based on the configuration for this AMF, the AMF may be allowed to determine whether it can serve the UE (see (A) below for subsequent handling).
AMF or NSSF may have previously subscribed to slice load level and/or Observed Service Experience and/or Dispersion Analytics related network data analytics for a Network Slice from NWDAF, optionally for an Area of Interest composed of one or several TAIs. If AMF subscribes to analytics, AMF may determine that it cannot serve the UE based on received analytics (see (A) below). If AMF subscribes to notifications on changes on the Network Slice or Network Slice instance availability information from NSSF optionally indicating a list of supported TAIs, it may determine that it cannot serve the UE after the restriction notification is received (see (A) below). If AMF does not subscribe to notifications on changes on the availability information from NSSF, NSSF may take the analytics information into account when AMF queries NSSF (see (B) below).

NOTE 3: The configuration in the AMF depends on the operator's policy.

(A) Depending on fulfilling the configuration as described above, the AMF may be allowed to determine whether it can serve the UE, and the following is performed:
For the mobility from EPS to 5GS, the AMF first derives the serving PLMN value(s) of S-NSSAI(s) based on the HPLMN S-NSSAI(s) in the mapping of Requested NSSAI (in CM-IDLE state) or the HPLMN S-NSSAI(s) received from SMF+PGW-C (in CM-CONNECTED state). After that the AMF regards the derived value(s) as the Requested NSSAI.
For the inter PLMN within 5GC mobility, the new AMF derives the serving PLMN value(s) of S-NSSAI(s) based on the HPLMN S-NSSAI(s) in the mapping of Requested NSSAI. After that the AMF regards the derived value(s) as the Requested NSSAI.
AMF checks whether it can serve all the S-NSSAI(s) from the Requested NSSAI present in the Subscribed S-NSSAIs (potentially using configuration for mapping S-NSSAI values between HPLMN and Serving PLMN), or all the S-NSSAI(s) marked as default in the Subscribed S-NSSAIs in the case that no Requested NSSAI was provided or none of the S-NSSAIs in the Requested NSSAI are permitted, i.e. do not match any of the Subscribed S-NSSAIs or not available at the current UE's Tracking Area (see clause 5.15.3).
If AMF has subscribed to slice load level and/or Observed Service Experience and/or Dispersion Analytics related network data analytics for a Network Slice from NWDAF, or if AMF had received a Network Slice restriction from NSSF that applies to the list of TAIs supported by the AMF, it may use that information to determine whether the AMF can serve the UE on the S-NSSAI(s) in the Requested NSSAI.
If the AMF can serve the S-NSSAIs in the Requested NSSAI, the AMF remains the serving AMF for the UE. The Allowed NSSAI is then composed of the list of S-NSSAI(s) in the Requested NSSAI permitted based on the Subscribed S-NSSAIs and/or the list of S-NSSAI(s) for the Serving PLMN which are mapped to the HPLMN S-NSSAI(s) provided in the mapping of Requested NSSAI permitted based on the Subscribed S-NSSAIs, or, if neither Requested NSSAI nor the mapping of Requested NSSAI was provided or none of the S-NSSAIs in the Requested NSSAI are permitted, all the S-NSSAI(s) marked as default in the Subscribed S-NSSAIs and taking also into account the availability of the Network Slice instances as described in clause 5.15.8 that are able to serve the S-NSSAI(s) in the Allowed NSSAI in the current UE's Tracking Areas in addition to any Network Slice instance restriction for the S-NSSAI(s) in the Allowed NSSAI provided by the NSSF. If the AMF has received NSSRG Information for the Subscribed S-NSSAIs as part of the UE subscription information, it shall only include in the Allowed NSSAI S-NSSAIs that all share a common NSSRG (see clause 5.15.12). If at least one S-NSSAI in the Requested NSSAI is not available in the current UE's Tracking Area, then either the AMF may determine a Target NSSAI or step (B) is executed. The AMF also determines the mapping if the S-NSSAI(s) included in the Allowed NSSAI needs to be mapped to Subscribed S-NSSAI(s) values. If no Requested NSSAI is provided, or the mapping of the S-NSSAIs in Requested NSSAI to HPLMN S-NSSAIS is incorrect, or the Requested NSSAI includes an S-NSSAI that is not valid in the Serving PLMN, or the UE indicated that the Requested NSSAI is based on the Default Configured NSSAI, the AMF, based on the Subscribed S-NSSAI(s) and operator's configuration, may also determine the Configured NSSAI for the Serving PLMN and, if applicable, the associated mapping of the Configured NSSAI to HPLMN S-NSSAIs, so these can be configured in the UE. Then Step (C) is executed.
Else, the AMF queries the NSSF (see (B) below).

(B) When required as described above, the AMF needs to query the NSSF, and the following is performed:
The AMF queries the NSSF, with Requested NSSAI (excluding S-NSSAIs subject to NSSAA which are in “Pending” state and are not yet in the Allowed NSSAI, if any), Default Configured NSSAI Indication, mapping of Requested NSSAI to HPLMN S-NSSAIs, the Subscribed S-NSSAIs (with an indication if marked as default S-NSSAI), NSSRG Information (if provided by the UDM, see clause 5.15.12), any Allowed NSSAI it might have for the other Access Type (including its mapping to HPLMN S-NSSAIS), PLMN ID of the SUPI and UE's current Tracking Area.
Based on this information, local configuration, and other locally available information including RAN capabilities in the current Tracking Area for the UE or load level information for a Network Slice instance provided by the NWDAF, the NSSF does the following:
It verifies which S-NSSAI(s) in the Requested NSSAI are permitted based on comparing the Subscribed S-NSSAIs with the S-NSSAIs in the mapping of Requested NSSAI to HPLMN S-NSSAIS. It considers the S-NSSAI(s) marked as default in the Subscribed S-NSSAIs in the case that no Requested NSSAI was provided or no S-NSSAI from the Requested NSSAI are permitted i.e. are not present in the Subscribed S-NSSAIs or not available e.g. at the current UE's Tracking Area. If NSSRG information is provided, the NSSF only selects S-NSSAIs that share a common NSSRG (see clause 5.15.12).
If AMF has not subscribed to Network Slice instance restriction service from NSSF and NSSF has subscribed to slice load level and/or Observed Service Experience and/or Dispersion Analytics related network data analytics for a Network Slice from NWDAF, NSSF may use the analytics information for the determination of the (Network Slice instance(s) and the) list of S-NSSAI(s) in the Allowed NSSAI(s) to serve the UE.
It selects the Network Slice instance(s) to serve the UE. When multiple Network Slice instances in the UE's Tracking Area are able to serve a given S-NSSAI, based on operator's configuration, the NSSF may select one of them to serve the UE, or the NSSF may defer the selection of the Network Slice instance until a NF/service within the Network Slice instance needs to be selected.
It determines the target AMF Set to be used to serve the UE, or, based on configuration, the list of candidate AMF(s), possibly after querying the NRF.

NOTE 4: If the target AMF(s) returned from the NSSF is the list of candidate AMF(s), the Registration Request message can only be redirected via the direct signalling between the initial AMF and the selected target AMF as described in clause 5.15.5.2.3.
It determines the Allowed NSSAI(s) for the applicable Access Type, composed of the list of S-NSSAI(s) in the Requested NSSAI permitted based on the Subscribed S-NSSAIs and/or the list of S-NSSAI(s) for the Serving PLMN which are mapped to the HPLMN S-NSSAIs provided in the mapping of Requested NSSAI permitted based on the Subscribed S-NSSAIs, or, if neither Requested NSSAI nor the mapping of Requested NSSAI was provided or none of the S-NSSAIs in the Requested NSSAI are permitted, all the S-NSSAI(s) marked as default in the Subscribed S-NSSAIs, and taking also into account the availability of the Network Slice instances as described in clause 5.15.8 that are able to serve the S-NSSAI(s) in the Allowed NSSAI in the current UE's Tracking Areas. If NSSRG information applies, the NSSF only selects S-NSSAIs that share a common NSSRG (see clause 5.15.12).
It also determines the mapping of each S-NSSAI of the Allowed NSSAI(s) to the Subscribed S-NSSAIs if necessary.
Based on operator configuration, the NSSF may determine the NRF(s) to be used to select NFs/services within the selected Network Slice instance(s).
Additional processing to determine the Allowed NSSAI(s) in roaming scenarios and the mapping to the Subscribed S-NSSAIs, as described in clause 5.15.6.
If no Requested NSSAI is provided or the Requested NSSAI includes an S-NSSAI that is not valid in the Serving PLMN, or the mapping of the S-NSSAIs in Requested NSSAI to HPLMN S-NSSAIs is incorrect, or the Default Configured NSSAI Indication is received from AMF, the NSSF based on the Subscribed S-NSSAI(s) and operator configuration may also determine the Configured NSSAI for the Serving PLMN and, if applicable, the associated mapping of the Configured NSSAI to HPLMN S-NSSAIs, so these can be configured in the UE.
If at least one S-NSSAI in the Requested NSSAI is not available in the current UE's Tracking Area, the NSSF may provide a Target NSSAI for the purpose of allowing the NG-RAN to redirect the UE to a cell of a TA in another frequency band supporting network slices not available in the current TA as described in clause 5.3.4.3.3.
The NSSF returns to the current AMF the Allowed NSSAI for the applicable Access Type, the mapping of each S-NSSAI of the Allowed NSSAI to the Subscribed S-NSSAIs if determined and the target AMF Set, or, based on configuration, the list of candidate AMF(s). The NSSF may return the NRF(s) to be used to select NFs/services within the selected Network Slice instance(s), and the NRF to be used to determine the list of candidate AMF(s) from the AMF Set. The NSSF may return NSI ID(s) to be associated to the Network Slice instance(s) corresponding to certain S-NSSAIs. NSSF may return the rejected S-NSSAI(s) as described in clause 5.15.4.1. The NSSF may return the Configured NSSAI for the Serving PLMN and the associated mapping of the Configured NSSAI to HPLMN S-NSSAIs. The NSSF may return Target NSSAI as described in clause 5.3.4.3.3.
Depending on the available information and based on configuration, the AMF may query the appropriate NRF (e.g. locally pre-configured or provided by the NSSF) with the target AMF Set. The NRF returns a list of candidate AMFs.
If AMF Re-allocation is necessary, the current AMF reroutes the Registration Request or forwards the UE context to a target serving AMF as described in clause 5.15.5.2.3.
Step (C) is executed.

(C) The serving AMF shall determine a Registration Area such that all S-NSSAIs of the Allowed NSSAI for this Registration Area are available in all Tracking Areas of the Registration Area (and also considering other aspects as described in clause 5.3.2.3) and then return to the UE this Allowed NSSAI and the mapping of the Allowed NSSAI to the Subscribed S-NSSAIs if provided. The AMF may return the rejected S-NSSAI(s) as described in clause 5.15.4.1.

NOTE 5: The S-NSSAIs in the Allowed NSSAI for Non-3GPP access are available homogeneously in the PLMN for the N3IWF case. For other types of Non 3GPP access the S-NSSAIs in the Allowed NSSAI for Non-3GPP access can be not available homogeneously all over the PLMN, for example different W-AGFs can support different TAIs that support different network slices.

When either no Requested NSSAI was included, or the mapping of the S-NSSAIs in Requested NSSAI to HPLMN S-NSSAIS is incorrect, or a Requested NSSAI is not considered valid in the PLMN and as such at least one S-NSSAI in the Requested NSSAI was rejected as not usable by the UE in the PLMN, or the UE indicated that the Requested NSSAI is based on the Default Configured NSSAI, the AMF may update the UE slice configuration information for the PLMN as described in clause 5.15.4.2.

If the Requested NSSAI does not include S-NSSAIs which map to S-NSSAIs of the HPLMN subject to Network Slice-Specific Authentication and Authorization and the AMF determines that no S-NSSAI can be provided in the Allowed NSSAI for the UE in the current UE's Tracking Area and if no default S-NSSAI(s) could be added as described in step (A), the AMF shall reject the UE Registration and shall include in the rejection message the list of Rejected S-NSSAIs, each of them with the appropriate rejection cause value.

If the Requested NSSAI includes S-NSSAIs which map to S-NSSAIs of the HPLMN subject to Network Slice-Specific Authentication and Authorization, the AMF shall include in the Registration Accept message an Allowed NSSAI containing only those S-NSSAIs that are not to be subject to Network Slice-Specific Authentication and Authorization and, based on the UE Context in AMF, those S-NSSAIs for which Network Slice-Specific Authentication and Authorization for at least one of the corresponding HPLMN S-NSSAIs succeeded previously regardless the Access Type, if any.

The AMF shall also provide the list of Rejected S-NSSAIs, each of them with the appropriate rejection cause value.

If the AMF determined the Target NSSAI or received a Target NSSAI from the NSSF, the AMF should provide the Target NSSAI to the PCF for retrieving a corresponding RFSP as described in clause 5.3.4.3.1 or, if the PCF is not deployed, the AMF should determine a corresponding RFSP based on local configuration. Then the AMF provides the Target NSSAI and the corresponding RFSP to the NG-RAN as described in clause 5.3.4.3.3. The S-NSSAIs which map to S-NSSAIs of the HPLMN subject to Network Slice-Specific Authentication and Authorization is ongoing are in “pending” state in the AMF and shall be included in the Pending NSSAI. The Pending NSSAI may contain a mapping of the S-NSSAI(s) for the Serving PLMN to the HPLMN S-NSSAIs, if applicable. The UE shall not include in the Requested NSSAI any of the S-NSSAIs from the Pending NSSAI the UE stores, regardless of the Access Type.

If:
all the S-NSSAI(s) in the Requested NSSAI are still to be subject to Network Slice-Specific Authentication and Authorization: or
no Requested NSSAI was provided or none of the S-NSSAIs in the Requested NSSAI matches any of the Subscribed S-NSSAIs, and all the S-NSSAI(s) marked as default in the Subscribed S-NSSAIs are to be subject to Network Slice-Specific Authentication and Authorization;
the AMF shall provide a “NSSAA to be performed” indicator and no Allowed NSSAI to the UE in the Registration Accept message. Upon receiving the Registration Accept message, the UE is registered in the PLMN but shall wait for the completion of the Network Slice-Specific Authentication and Authorization without attempting to use any service provided by the PLMN on any access, except e.g. emergency services (see TS 24.501 [47]), until the UE receives an allowed NSSAI.

Then, the AMF shall initiate the Network Slice-Specific Authentication and Authorization procedure as described in clause 5.15.10 for each S-NSSAI that requires it, except, based on Network policies, for those S-NSSAIs for which Network Slice-Specific Authentication and Authorization have been already initiated on another Access Type for the same S-NSSAI(s). At the end of the Network Slice-Specific Authentication and Authorization steps, the AMF by means of the UE Configuration Update procedure shall provide a new Allowed NSSAI to the UE which also contains the S-NSSAIs subject to Network Slice-Specific Authentication and Authorization for which the authentication and authorization is successful. The AMF may perform AMF selection when NSSAA completes for the S-NSSAIs subject to S-NSSAI in “pending” status. If an AMF change is required, this shall be triggered by the AMF using the UE Configuration Update procedure indicating a UE re-registration is required. The S-NSSAIs which were not successfully authenticated and authorized are not included in the Allowed NSSAI and are included in the list of Rejected S-NSSAIs with a rejection cause value indicating Network Slice-Specific Authentication and Authorization failure.

Once completed the Network Slice-Specific (re-)Authentication and (re-)Authorization procedure, if the AMF determines that no S-NSSAI can be provided in the Allowed NSSAI for the UE, which is already authenticated and authorized successfully by a PLMN, and if no default S-NSSAI(s) could be added as described in step (A), the AMF shall execute the Network-initiated Deregistration procedure described in clause 4.2.2.3.3 of TS 23.502 [3] and shall include in the explicit De-Registration Request message the list of Rejected S-NSSAIs, each of them with the appropriate rejection cause value.

If an S-NSSAI is rejected with a rejection cause value indicating Network Slice-Specific Authentication and Authorization failure or revocation, the UE can re-attempt to request the S-NSSAI based on policy, local in the UE.

### <Modifications and Alternatives>

Detailed aspects have been described above. As those skilled in the art will appreciate, a number of modifications and alternatives can be made to the above aspects whilst still benefiting from the disclosures embodied therein. By way of illustration only a number of these alternatives and modifications will now be described.

In the above description, the UE 3 and the network apparatus are described for ease of understanding as having a number of discrete modules (such as the communication control modules). Whilst these modules may be provided in this way for certain applications, for example where an existing system has been modified to implement the disclosure, in other applications, for example in systems designed with the inventive features in mind from the outset, these modules may be built into the overall operating system or code and so these modules may not be discernible as discrete entities. These modules may also be implemented in software, hardware, firmware or a mix of these.

Each controller may comprise any suitable form of processing circuitry including (but not limited to), for example: one or more hardware implemented computer processors: microprocessors: central processing units (CPUs): arithmetic logic units (ALUs); input/output (IO) circuits: internal memories/caches (program and/or data): processing registers: communication buses (e.g. control, data and/or address buses): direct memory access (DMA) functions: hardware or software implemented counters, pointers and/or timers; and/or the like.

In the above aspects, a number of software modules were described. As those skilled in the art will appreciate, the software modules may be provided in compiled or un-compiled form and may be supplied to the UE 3 and the network apparatus as a signal over a computer network, or on a recording medium. Further, the functionality performed by part or all of this software may be performed using one or more dedicated hardware circuits. However, the use of software modules is preferred as it facilitates the updating of the UE 3 and the network apparatus in order to update their functionalities.

In the above aspects, a 3GPP radio communications (radio access) technology is used. However, any other radio communications technology (e.g. WLAN, Wi-Fi, WiMAX, Bluetooth, etc.) and other fix line communications technology (e.g. BBF Access, Cable Access, optical access, etc.) may also be used in accordance with the above aspects.

Items of user equipment might include, for example, communication devices such as mobile telephones, smartphones, user equipment, personal digital assistants, laptop/tablet computers, web browsers, e-book readers and/or the like. Such mobile (or even generally stationary) devices are typically operated by a user, although it is also possible to connect so-called ‘Internet of Things’ (IoT) devices and similar machine-type communication (MTC) devices to the network. For simplicity, the present application refers to mobile devices (or UEs) in the description but it will be appreciated that the technology described can be implemented on any communication devices (mobile and/or generally stationary) that can connect to a communications network for sending/receiving data, regardless of whether such communication devices are controlled by human input or software instructions stored in memory.

Various other modifications will be apparent to those skilled in the art and will not be described in further detail here.

As will be appreciated by one of skill in the art, the present disclosure may be embodied as a method, and system. Accordingly, the present disclosure may take the form of an entirely hardware embodiment, a software embodiment or an embodiment combining software and hardware aspects.

It will be understood that each block of the block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. A general-purpose processor may be a microprocessor, but in the alternative, the processor may be any conventional processor, controller, microcontroller, or state machine. A processor may also be implemented as a combination of computing devices, e.g., a plurality of microprocessors, one or more microprocessors, or any other such configuration.

The methods or algorithms described in connection with the examples disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor. The processor and the storage medium may reside in an ASIC.

The previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

While the disclosure has been particularly shown and described with reference to exemplary Aspects thereof, the disclosure is not limited to these Aspects. It will be understood by those of ordinary skill in the art that various changes in form and details may be made therein without departing from the spirit and scope of the present disclosure as defined by this document. For example, the Aspects above are not limited to 5GS, and the Aspects are also applicable to communication system other than 5GS (e.g., 6G system, 5G beyond system).

### <Supplementary Notes>

The whole or part of the example Aspects disclosed above can be described as, but not limited to, the following supplementary notes.

supplementary note 1. A method of a communication apparatus, the method comprising:
receiving Single Network Slice Selection Assistance Information (S-NSSAI), first information indicating where the S-NSSAI is valid and second information indicating when the S-NSSAI is valid; and
sending the S-NSSAI, the first information and the second information.

supplementary note 2. The method according to supplementary note 1, further comprising:
receiving a first message,
wherein the first message includes the S-NSSAI and location information of a User Equipment (UE);
determining whether the S-NSSAI is valid based on the first information and the second information; and
sending a second message including an allowed NSSAI in a case where the S-NSSAI is valid,
wherein the allowed NSSAI includes the S-NSSAI.

supplementary note 3. The method according to supplementary note 2, further comprising:
performing a process to remove the S-NSSAI from the allowed NSSAI in a case where the S-NSSAI is not valid.
supplementary note 4. A method of a User Equipment (UE), the method comprising:
receiving a first message,
wherein the first message includes Single Network Slice Selection Assistance Information (S-NSSAI), first information indicating where the S-NSSAI is valid and second information indicating when the S-NSSAI is valid;
determining whether the S-NSSAI is valid based on the first information and the second information; and
sending a second message in a case where the S-NSSAI is valid,
wherein the second message includes the S-NSSAI.

supplementary note 5. The method according to supplementary note 4, further comprising:
receiving a third message after sending the second message,
wherein the third message includes an allowed NSSAI, and
wherein the allowed NSSAI includes the S-NSSAI.

supplementary note 6. The method according to supplementary note 5, further comprising:
performing a process to remove the S-NSSAI from the allowed NSSAI in a case where the S-NSSAI is not valid.

supplementary note 7. The method according to any one of supplementary note 4 to 6, further comprising:
performing a Protocol Data Unit (PDU) session establishment procedure by using the S-NSSAI in a case where the S-NSSAI is valid.

supplementary note 8. A method of a communication apparatus, the method comprising:
receiving Single Network Slice Selection Assistance Information (S-NSSAI), first information indicating where the S-NSSAI is valid and second information indicating when the S-NSSAI is valid;
determining whether the S-NSSAI is valid based on the first information and the second information; and
sending first system information in a case where the S-NSSAI is valid,
wherein the first system information includes information indicating the S-NSSAI is valid.

supplementary note 9. The method according to supplementary note 8, further comprising:
sending second system information in a case where the S-NSSAI is not valid,
wherein the second system information includes information indicating the S-NSSAI is not valid.

supplementary note 10. A communication apparatus comprising:
means for receiving Single Network Slice Selection Assistance Information (S-NSSAI), first information indicating where the S-NSSAI is valid and second information indicating when the S-NSSAI is valid; and
means for sending the S-NSSAI, the first information and the second information.

supplementary note 11. The communication apparatus according to supplementary note 10, further comprising:
means for receiving a first message,
wherein the first message includes the S-NSSAI and location information of a User Equipment (UE);
means for determining whether the S-NSSAI is valid based on the first information and the second information; and
means for sending a second message including an allowed NSSAI in a case where the S-NSSAI is valid,
wherein the allowed NSSAI includes the S-NSSAI.

supplementary note 12. The communication apparatus according to supplementary note 11, further comprising:
means for performing a process to remove the S-NSSAI from the allowed NSSAI in a case where the S-NSSAI is not valid.

supplementary note 13. A User Equipment (UE) comprising:
means for receiving a first message,
wherein the first message includes Single Network Slice Selection Assistance Information (S-NSSAI), first information indicating where the S-NSSAI is valid and second information indicating when the S-NSSAI is valid;
means for determining whether the S-NSSAI is valid based on the first information and the second information; and
means for sending a second message in a case where the S-NSSAI is valid,
wherein the second message includes the S-NSSAI.

supplementary note 14. The UE according to supplementary note 13, further comprising:
means for receiving a third message after sending the second message,
wherein the third message includes an allowed NSSAI, and
wherein the allowed NSSAI includes the S-NSSAI.

supplementary note 15. The UE according to supplementary note 14, further comprising:
means for performing a process to remove the S-NSSAI from the allowed NSSAI in a case where the S-NSSAI is not valid.

supplementary note 16. The UE according to any one of supplementary note 13 to 15, further comprising:
means for performing a Protocol Data Unit (PDU) session establishment procedure by using the S-NSSAI in a case where the S-NSSAI is valid.

supplementary note 17. A communication apparatus comprising:
means for receiving Single Network Slice Selection Assistance Information (S-NSSAI), first information indicating where the S-NSSAI is valid and second information indicating when the S-NSSAI is valid;
means for determining whether the S-NSSAI is valid based on the first information and the second information; and
means for sending first system information in a case where the S-NSSAI is valid,
wherein the first system information includes information indicating the S-NSSAI is valid.

supplementary note 18. The communication apparatus according to supplementary note 17, further comprising:
means for sending second system information in a case where the S-NSSAI is not valid,
wherein the second system information includes information indicating the S-NSSAI is not valid.

supplementary note 19. A method for a first communication apparatus comprising:
receiving, from a second communication apparatus, information related to Single Network Slice Selection Assistance Information (S-NSSAI);
receiving, from the second communication apparatus, at least one of information related to validity time for the S-NSSAI and information related to validity area for the S-NSSAI; and
sending, to a communication terminal, at least one of information indicating registration to a network slice related to the S-NSSAI is permitted and information indicating registration to the network slice is not permitted based on at least one of the information related to validity time for the S-NSSAI and information related to validity area for the S-NSSAI.

supplementary note 20. A method for a communication terminal comprising:
sending, to a first communication apparatus, a request message for a network slice; and
receiving, from the first communication apparatus, at least one of information related to validity time for the network slice and validity area for the network slice.

supplementary note 21. A method for a first communication apparatus comprising:
receiving, from a second communication apparatus, information related to Single Network Slice Selection Assistance Information (S-NSSAI);
receiving, from the second communication apparatus, at least one of information related to validity time for the S-NSSAI and information related to validity area for the S-NSSAI; and
sending, to a communication terminal, at least one of information indicating registration to a network slice related to the S-NSSAI is permitted based on at least one of the information related to validity time for the S-NSSAI and information related to validity area for the S-NSSAI.

supplementary note 22. A method for a communication terminal comprising:
sending, to a first communication apparatus, a request message for a network slice; and
receiving, from the first communication apparatus, information indicating registration to the network is permitted including at least one of information related to validity time for the network slice and validity area for the network slice.

supplementary note 23. A method for a first communication apparatus comprising:
receiving, from a second communication apparatus, at least one of at least one of information related to validity time for the network slice and validity area for the network slice;
sending, to a first base station, a first message related to at least one of the information related to validity time for the network slice and validity area for the network slice; and
receiving, from the first base station, a second message to confirm the first radio station receive the first message.

supplementary note 24 A method for a first communication apparatus comprising:
receiving, from a second communication apparatus, at least one of at least one of information related to validity time for the network slice and validity area for the network slice;
receiving, from a first base station, a first message indicating the first base station manages a network slice in at least one of validity area and validity time; and
sending, to the first base station, a second message related to at least one of the validity time for the network slice and the validity area for the network slice.

supplementary note: 25 The method according to supplementary 23 or supplementary 24 comprising:
sending, to a communication terminal, at least one of information related to the validity area and information invalid time.

supplementary note 26 The method according to supplementary 23 or supplementary 24 comprising:
sending, to a communication terminal, information related to the validity area and the validity time.

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Indian provisional patent application No. 202111060027, filed on Dec. 22, 2021, the disclosure of which is incorporated herein in its entirety by reference.

### REFERENCE SIGNS LIST

1 telecommunication system
3 UE
5 (R)AN node
7 core network
20 data network
31 transceiver circuit
32 antenna
33 controller
34 user interface
35 USIM
36 memory
51 transceiver circuit
52 antenna
53 network interface
54 controller
55 memory
60 RU
61 DU
62 CU
70 AMF
71 SMF
72 UPF
73 PCF
74 AUSF
75 UDM
76 NWDAF
77 NF
361 operating system
362 communications control module
551 operating system
552 communications control module
601 transceiver circuit
602 antenna
603 network interface
604 controller
605 memory
611 transceiver circuit
612 network interface
613 controller
614 memory
621 transceiver circuit
622 network interface
623 controller
624 memory
701 transceiver circuit
702 network interface
703 controller
704 memory
751 transceiver circuit
752 network interface
753 controller
754 memory
771 transceiver circuit
772 network interface
773 controller
774 memory
3621 transceiver control module
5521 transceiver control module
6051 operating system
6052 communications control module
6141 operating system
6142 communications control module
6241 operating system
6242 communications control module
7041 operating system
7042 communications control module
7541 operating system
7542 communications control module
7741 operating system
7742 communications control module
60521 transceiver control module
61421 transceiver control module
62421 transceiver control module
70421 transceiver control module
75421 transceiver control module
77421 transceiver control module

What is claimed is:

1. A method for a User Equipment (UE) comprising:
receiving, from an Access and Mobility Management Function (AMF), a Registration Accept message which includes a validity time; and
removing network slice information from an Allowed Network Slice Selection Assistance Information (NSSAI) based on the validity time indicating the network slice information is not available.

2. The method according to claim 1, comprising:
establishing a Protocol Data Unit (PDU) session associated with the network slice information based on the validity time indicating the network slice information is available.

3. The method according to claim 2, wherein
the network slice information is Single Network Slice Selection Assistance Information (S-NSSAI).

4. A User Equipment (UE) comprising:
a memory; and
at least one processor configured to access the memory and configured to:
receive, from an Access and Mobility Management Function (AMF), a Registration Accept message which includes a validity time; and
remove a network slice information from an Allowed Network Slice Selection Assistance Information (NSSAI) based on the validity time indicating the network slice information is not available.

5. The UE according to claim 4, wherein
the processor is configured to establish a Protocol Data Unit (PDU) session associated with the network slice information based on the validity time indicating the network slice information is available.

6. The UE according to claim 5, wherein
the network slice information is Single Network Slice Selection Assistance Information (S-NSSAI).

7. A method for an Access and Mobility Management Function (AMF) comprising:
receiving, from a User Equipment (UE), a registration request message including information for temporarily support for a network slice;
receiving, from a Unified Data Management (UDM), information; and
sending, to the UE, based on the information, a Registration Accept message which includes a validity time.

8. The method according to claim 7, wherein
the validity time is related to a configured Network Slice Selection Assistance Information (NSSAI).

9. The method according to claim 7, wherein
the validity time is related to the temporary support for the network slice.

10. An Access and Mobility Management Function (AMF) comprising:
a memory; and
at least one processor configured to access the memory and configured to:
receive, from a User Equipment (UE), a registration request message including information for temporarily support for a network slice;
receive, from a Unified Data Management (UDM), information; and
send, to the UE, based on the information, a Registration Accept message which includes a validity time.

11. The AMF according to claim 10, wherein
the validity time is related to a configured Network Slice Selection Assistance Information (NSSAI).

12. The AMF according to claim 10, wherein
the validity time is related to the temporary support for the network slice.

13. The method according to claim 1, wherein
the network slice information is Single Network Slice Selection Assistance Information (S-NSSAI).

14. The UE according to claim 4, wherein
the network slice information is Single Network Slice Selection Assistance Information (S-NSSAI).

15-26. (canceled)
